(19) United States
(12) Patent Application Publication
(10) Pub. No.: US 2026/0077590 A1
(43) Pub. Date: Mar. 19, 2026

(54) LIQUID EJECTING APPARATUS, HEAD UNIT CONTROL CIRCUIT, AND LIQUID EJECTION INSPECTION METHOD

(71) Applicant: SEIKO EPSON CORPORATION, Tokyo (JP)

(72) Inventor: Osamu SHINKAWA, Chino (JP)

(21) Appl. No.: 19/329,618

(22) Filed: Sep. 16, 2025

(30) Foreign Application Priority Data
Sep. 18, 2024 (JP) 2024-160786

(51) Int. Cl. B41J 2/045; G01H 11/08

(52) U.S. Cl. CPC B41J 2/04588; B41J 2/0451; B41J 2/04541; B41J 2/04573; B41J 2/04581; B41J 2/04596; G01H 11/08

(57) ABSTRACT

An ink jet printer includes a signal generator that generates a comparison signals, and a determining section. A signal path for a residual vibration signal from the ejection section to the signal generator is blocked at a blocking timing. The determining section determines a state of the ejection section based on a plurality of pieces of time information generated by using the plurality of comparison signals as signals reset at a reset timing based on reset information. In a case where the blocking timing is earlier than the reset timing, each of the plurality of pieces of time information is generated by using a corresponding one of the plurality of comparison signals as a signal whose electrical potential at the blocking timing is held until the reset timing.

The present application is based on, and claims priority from JP Application Serial Number 2024-160786, filed Sep. 18, 2024, the disclosure of which is hereby incorporated by reference herein in its entirety.

### BACKGROUND

### 1. Technical Field

The present disclosure relates to a liquid ejecting apparatus, a head unit control circuit that controls a head unit of the liquid ejecting apparatus, and a liquid ejection inspection method.

### 2. Related Art

A liquid ejecting apparatus such as an ink jet printer drives an ejection section included in a liquid ejecting head in each of a plurality of unit periods defined by a latch signal, thereby ejecting liquid such as ink filling the ejection section to form an image on a medium. However, in this type of liquid ejecting apparatus, an ejection abnormality in which liquid cannot be normally ejected from an ejection section may occur. Therefore, in the related art, a technique for inspecting an ejection state in an ejection section has been proposed. For example, JP-A-2015-174267 discloses a technique for inspecting an ejection state in an ejection section based on a detection signal indicating vibration remaining in the ejection section after the ejection section is driven by a drive signal.

However, according to the related art, when the ejection state in the ejection section is inspected, since noise is superimposed on a signal immediately after the start of the inspection, a mask circuit is used in consideration of the effect of the noise. The use of the mask circuit is sufficiently effective from the viewpoint of improving the accuracy of the inspection, but increases an inspection period. In the inspection of the ejection state, for example, period index data indicating a period of a detection signal indicating residual vibration is generated after the mask is released, and information for at least one period of the detection signal is required. The fact that information for one period of the detection signal is required after the mask is released has also been a major constraint on shortening the inspection period.

### SUMMARY

In order to solve the above-described problems, according to an aspect of the present disclosure, a liquid ejecting apparatus includes: an ejection section capable of ejecting liquid in accordance with an input drive signal; a signal generator to which a residual vibration signal corresponding to residual vibration generated in the ejection section in response to input of the drive signal is input, and that generates a plurality of inspection signals based on the residual vibration signal; and a determining section that determines a state of the ejection section, wherein a signal path for the residual vibration signal from the ejection section to the signal generator is blocked at a blocking timing based on a blocking signal, the determining section determines the state of the ejection section based on a plurality of pieces of inspection signal information generated by using the plurality of inspection signals as signals reset at a reset timing based on a reset signal, and in a case where the blocking timing is earlier than the reset timing, each of the plurality of pieces of inspection signal information is generated by using a corresponding one of the plurality of inspection signals as a signal whose electrical potential at the blocking timing is held until the reset timing.

According to another aspect of the present disclosure, a head unit control circuit that controls a head unit including an ejection section capable of ejecting liquid in accordance with an input drive signal includes: a signal generator to which a residual vibration signal corresponding to residual vibration generated in the ejection section in response to input of the drive signal is input, and that generates a plurality of inspection signals based on the residual vibration signal; and a determining section that determines a state of the ejection section, wherein a signal path for the residual vibration signal from the ejection section to the signal generator is blocked at a blocking timing based on a blocking signal, the determining section determines the state of the ejection section based on a plurality of pieces of inspection signal information generated by using the plurality of inspection signals as signals reset at a reset timing based on a reset signal, and in a case where the blocking timing is earlier than the reset timing, each of the plurality of pieces of inspection signal information is generated by using a corresponding one of the plurality of inspection signals as a signal whose electrical potential at the blocking timing is held until the reset timing.

According to another aspect of the present disclosure, a liquid ejection inspection method for a liquid ejecting apparatus including an ejection section capable of ejecting liquid in accordance with an input drive signal includes: inputting a residual vibration signal corresponding to residual vibration generated in the ejection section in response to input of the drive signal and generating a plurality of inspection signals based on the residual vibration signal; and determining a state of the ejection section based on a plurality of pieces of inspection signal information generated by using the plurality of inspection signals as signals reset at a reset timing based on a reset signal, wherein a signal path for the residual vibration signal output from the ejection section is blocked at a blocking timing based on a blocking signal, and in a case where the blocking timing is earlier than the reset timing, each of the plurality of pieces of inspection signal information is generated by using a corresponding one of the plurality of inspection signals as a signal whose electrical potential at the blocking timing is held until the reset timing.

### BRIEF DESCRIPTION OF THE DRAWINGS

FIG. 1 is a block diagram illustrating an example of a configuration of an ink jet printer according to a first embodiment of the present disclosure.

FIG. 2 is a perspective view illustrating an example of a schematic internal structure of the ink jet printer.

FIG. 3 is a cross-sectional view for explaining an example of a structure of an ejection section.

FIG. 4 is a diagram for explaining an ink ejection operation in the ejection section.

FIG. 5 is a plan view illustrating an example of the arrangement of nozzles in head units.

FIG. 6 is a block diagram illustrating an example of a configuration of each of the head units.

FIG. 7 is a block diagram illustrating an example of a configuration of an inspection unit.

FIG. 8 is a timing chart illustrating an example of an operation of the ink jet printer in a unit period.

FIG. 9 is a timing chart illustrating an example of an operation of a signal generator.

FIG. 10 is a diagram for explaining a relationship between residual vibration signals, a reset timing, and comparison signals.

FIG. 11 is a diagram for explaining a relationship between the reset timing and an amplitude calculated based on time lengths.

FIG. 12 is a diagram for explaining a relationship between the reset timing, the amplitude, and the rate of change in the amplitude.

FIG. 13 is a flowchart illustrating an example of an operation of the ink jet printer to execute an ejection state determination process.

FIG. 14 is a block diagram illustrating an example of a configuration of an inspection unit according to a second embodiment.

FIG. 15 is a diagram for explaining an outline of the adjustment of a reset timing.

FIG. 16 is a diagram for explaining a relationship between the reset timing, an amplitude, and the rate of change in the amplitude.

FIG. 17 is a flowchart illustrating an example of an operation of an ink jet printer to execute an ejection state determination process.

FIG. 18 is a block diagram illustrating an example of a configuration of an inspection unit according to a third embodiment.

FIG. 19 is a diagram for explaining a relationship between a residual vibration signal, a reset timing, and comparison signals.

FIG. 20 is a diagram for explaining an outline of the adjustment of sensitivity for determination of a state of an ejection section.

FIG. 21 is a diagram for explaining a relationship between the reset timing and an amplitude calculated based on time lengths.

FIG. 22 is a diagram for explaining a relationship between a time ratio of the two time lengths, the amplitude, and the rate of change in the amplitude.

FIG. 23 is a diagram for explaining an example of a variation in amplitudes calculated for nozzles based on the time lengths.

FIG. 24 is a diagram for explaining an example of the amplitudes calculated based on the time lengths when the time ratio of the two time lengths is changed.

FIG. 25 is a flowchart illustrating an example of an operation of an ink jet printer to execute an ejection state determination process.

FIG. 26 is a block diagram illustrating an example of a configuration of an inspection unit according to a first modification.

### DESCRIPTION OF EMBODIMENTS

Hereinafter, embodiments of the present disclosure will be described with reference to the drawings. However, in each drawing, the dimensions and scales of each section are appropriately different from the actual ones. Since the embodiments described below are suitable specific examples of the present disclosure, various technically preferable limitations are added, and the scope of the present disclosure is not limited to these embodiments unless otherwise stated in the following description to particularly limit the present disclosure.

### 1. EMBODIMENTS

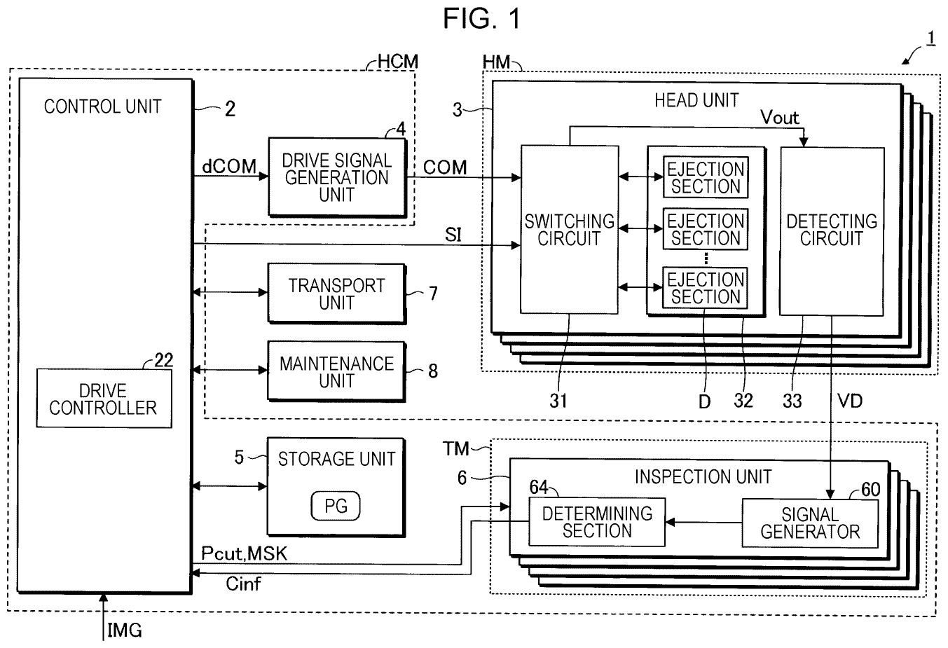

In the present embodiment, a liquid ejecting apparatus will be described by using an ink jet printer that forms an image on a recording sheet by ejecting ink as an example. In the present embodiment, the ink is an example of “liquid”. First, a configuration of the ink jet printer 1 according to the present embodiment will be described with reference to FIG. 1.

### First Embodiment

FIG. 1 is a block diagram illustrating an example of a configuration of the ink jet printer 1 according to the first embodiment of the present disclosure.

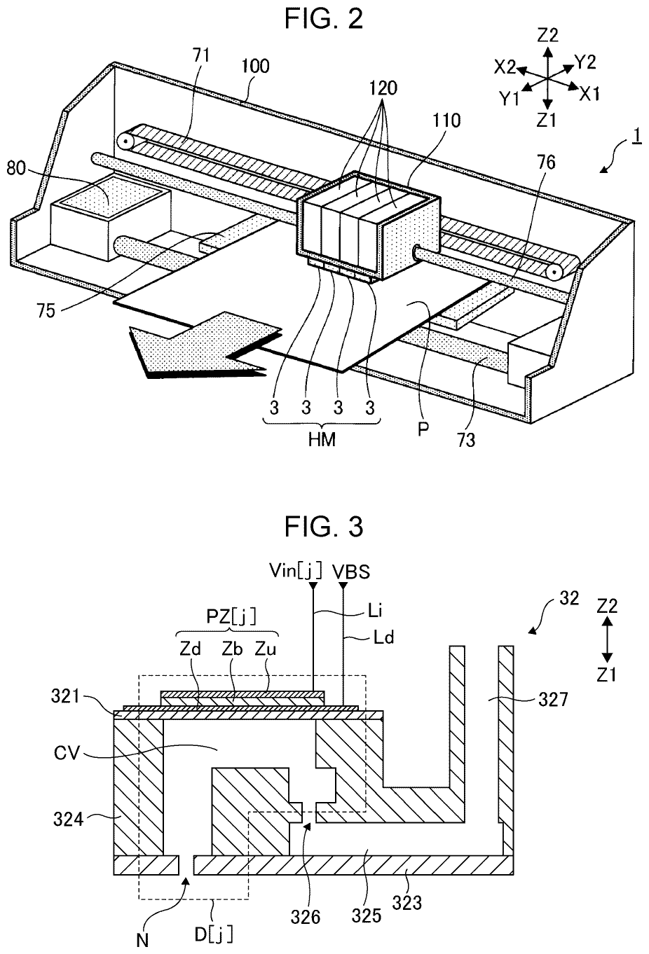

For example, print data IMG indicating an image to be formed by the ink jet printer 1 is supplied to the ink jet printer 1 from a host computer such as a personal computer or a digital camera. The ink jet printer 1 executes a printing process of forming, on a medium, the image indicated by the print data IMG supplied from the host computer. In the present embodiment, as the medium, a recording sheet P illustrated in FIG. 2 to be described later is assumed.

The ink jet printer 1 includes a head module HM including a head unit 3 including an ejection section D that ejects ink, and includes a head unit control module HCM that controls the head unit 3. The ink jet printer 1 includes a transport unit 7 that changes a relative position of the recording sheet P with respect to the head unit 3, and a maintenance unit 8 that executes a maintenance process of maintaining the ejection section D included in the head unit 3. The head unit control module HCM is an example of a “head unit control circuit”.

The head unit control module HCM includes a control unit 2 that controls each section of the ink jet printer 1, and a drive signal generation unit 4 that generates a drive signal COM for driving the ejection section D. The head unit control module HCM includes a storage unit 5 that stores various types of information such as the print data IMG and a control program PG for the ink jet printer 1. The head unit control module HCM includes an inspection module TM including an inspection unit 6 that determines a state of the ejection section D.

In the present embodiment, it is assumed that the head unit 3 and the inspection unit 6 correspond to each other. For example, the ink jet printer 1 may include a plurality of head units 3 and a plurality of inspection units 6 corresponding to the plurality of head units 3 on a one-to-one basis. Alternatively, the ink jet printer 1 may include one head unit 3 and one inspection unit 6 corresponding to the one head unit 3. In the present embodiment, it is assumed that the ink jet printer 1 includes four head units 3 and four inspection units 6 corresponding to the four head units 3 on a one-to-one basis. However, hereinafter, for convenience of description, a description will be made, focusing on one head unit 3 among the four head units 3 and one inspection unit 6 corresponding to the one head unit 3 among the four inspection units 6.

The control unit 2 includes one or a plurality of central processing units (CPUs). The control unit 2 may include a programmable logic device such as a field-programmable gate array (FPGA), instead of the one or plurality of CPUs or in addition to the one or plurality of CPUs. The control unit 2 functions as a drive controller 22 by executing the control program PG stored in the storage unit 5.

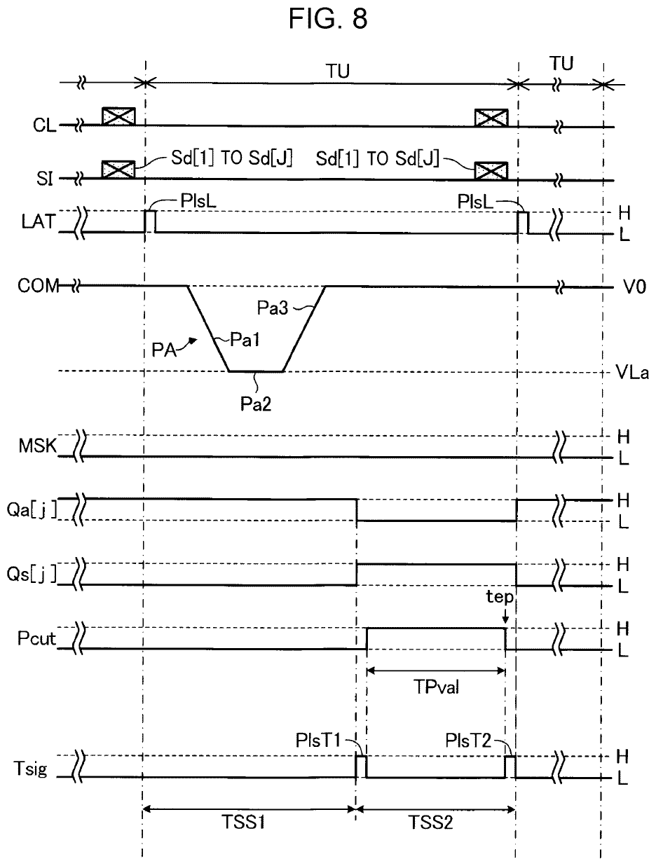

The drive controller 22 generates signals for controlling an operation of each section of the ink jet printer 1, such as a print signal SI, a waveform specifying signal dCOM, a pulse detection period signal Pcut, and a mask signal MSK. The waveform specifying signal dCOM is a digital signal that defines a waveform of the drive signal COM. The drive signal COM is an analog signal for driving the ejection section D. The print signal SI is a digital signal for specifying a type of operation of the ejection section D. Specifically, the print signal SI is a signal for specifying a type of operation of the ejection section D by specifying whether the drive signal COM is supplied to the ejection section D. The pulse detection period signal Pcut and the mask signal MSK will be described later with reference to FIGS. 7 and 8.

For example, the drive controller 22 controls the head unit 3 and the transport unit 7 to execute the printing process of printing the image indicated by the print data IMG on the recording sheet P. Specifically, when the printing process is to be executed, the drive controller 22 generates, based on the print data IMG, a signal for controlling the head unit 3, such as the print signal SI. When the printing process is to be executed, the drive controller 22 generates a signal for controlling the drive signal generation unit 4, such as the waveform specifying signal dCOM. When the printing process is to be executed, the drive controller 22 generates a signal for controlling the transport unit 7. Accordingly, in the printing process, the drive controller 22 adjusts whether to eject ink from the ejection section D, the amount of the ink to be ejected, the timing of ejecting the ink, and the like while controlling the transport unit 7 so as to change the relative position of the recording sheet P with respect to the head unit 3. In this manner, the drive controller 22 controls each section of the ink jet printer 1 such that the image corresponding to the print data IMG is formed on the recording sheet P.

The drive signal generation unit 4 includes, for example, a digital analog converter (DAC), and generates the drive signal COM based on the waveform specifying signal dCOM supplied from the drive controller 22. For example, the drive signal generation unit 4 generates the drive signal COM including the waveform defined by the waveform specifying signal dCOM. The drive signal generation unit 4 outputs the drive signal COM generated based on the waveform specifying signal dCOM to a switching circuit 31 included in the head unit 3. In the present embodiment, it is assumed that the head unit 3 and the drive signal generation unit 4 correspond to each other. For example, the ink jet printer 1 may include four drive signal generation units 4 corresponding to the four head units 3 in a one-to-one manner.

The storage unit 5 includes one or both of a volatile memory, such as a random-access memory (RAM), and a nonvolatile memory, such as a read-only memory (ROM), an electrically erasable programmable read-only memory (EEPROM), or a programmable ROM (PROM). The storage unit 5 may be included in the control unit 2. The storage unit 5 is an example of a “storage section”.

The head unit 3 includes the switching circuit 31, a recording head 32, and a detecting circuit 33.

The recording head 32 includes J ejection sections D. The value J is a natural number greater than or equal to 1. Hereinafter, the j-th ejection section D among the J ejection sections D included in the recording head 32 may be referred to as an ejection section D[j]. The variable j is a positive integer satisfying “1≤j≤J”. Hereinafter, in a case where a constituent element, a signal, or the like of the ink jet printer 1 corresponds to the ejection section D[j] among the J ejection sections D, a suffix [j] may be added to a reference sign for representing the constituent element, the signal, or the like.

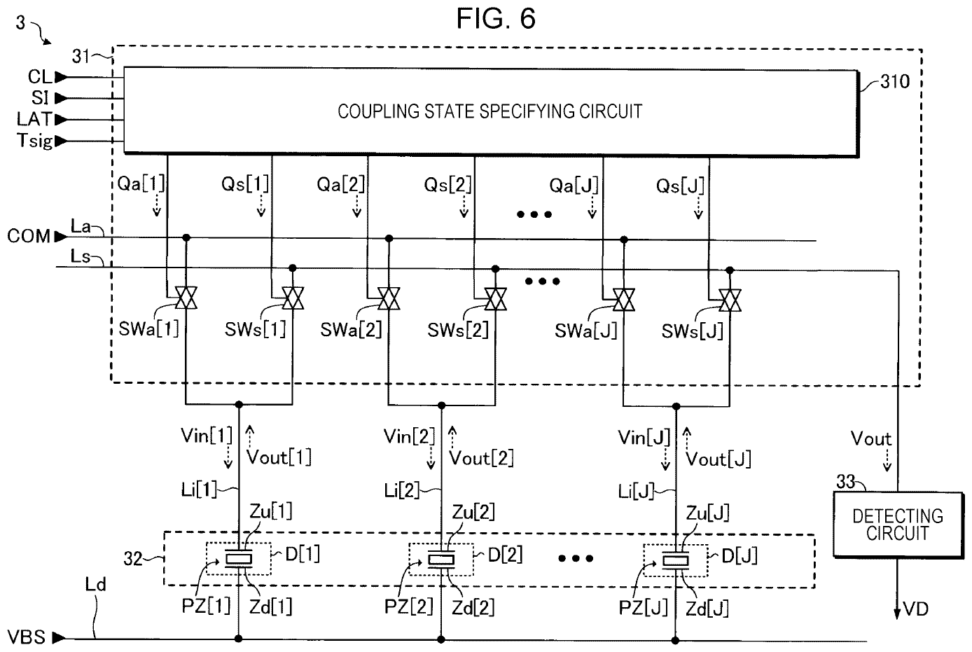

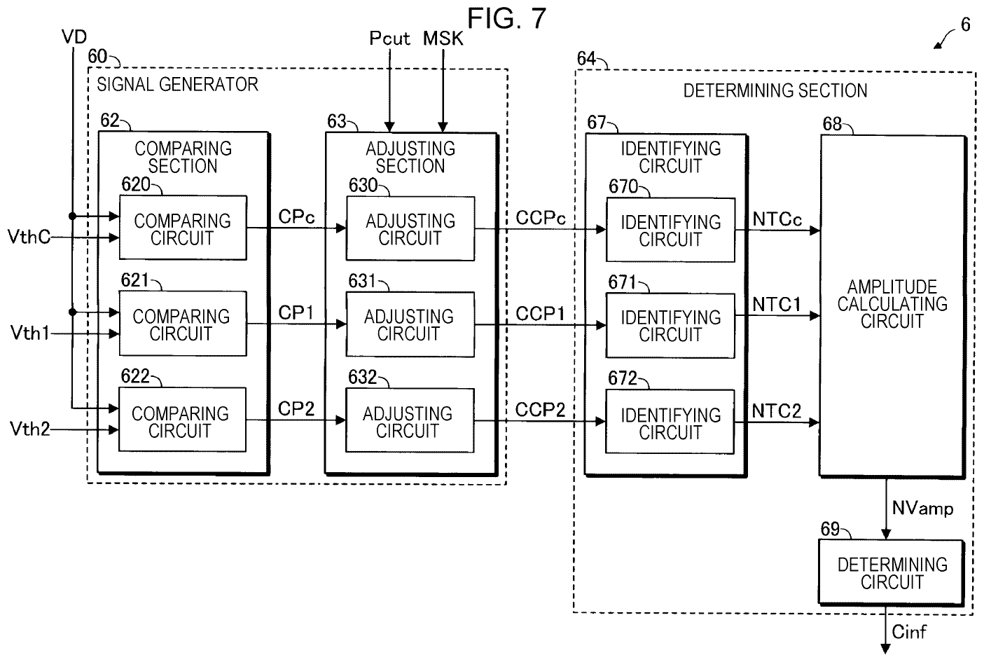

The switching circuit 31 switches, based on the print signal SI, whether to supply the drive signal COM to the ejection section D[j]. Hereinafter, the drive signal COM that is supplied to the ejection section D[j] may be referred to as an individual drive signal Vin[j], as illustrated in FIG. 6 and the like which will be described later. The drive signal COM and the individual drive signal Vin are examples of a “drive signal”.

The switching circuit 31 switches, based on the print signal SI, whether to electrically couple the ejection section D[j] to the detecting circuit 33. When the ejection section D[j] and the detecting circuit 33 are electrically coupled to each other, for example, a detection signal Vout[j] detected from the ejection section D[j] is supplied to the detecting circuit 33 through the switching circuit 31. The detection signal Vout[j] is, for example, an analog signal indicating a change in an electrical potential of an upper electrode Zu[j] included in a piezoelectric element PZ[j] included in the ejection section D[j]. For example, the detection signal Vout[j] is a residual vibration signal generated due to vibration remaining in the ejection section D[j] after the piezoelectric element PZ[j] is driven by the individual drive signal Vin[j]. In this case, for example, a waveform of the detection signal Vout[j] indicates a waveform of residual vibration which is the vibration remaining in the ejection section D[j] after the piezoelectric element PZ[j] is driven. The residual vibration of the ejection section D[j] after the piezoelectric element PZ[j] is driven corresponds to residual vibration of a vibration plate 321 after the piezoelectric element PZ[j] is driven. The piezoelectric element PZ[j], the upper electrode Zu[j], and the vibration plate 321 will be described later with reference to FIG. 3.

The detecting circuit 33 generates, as a signal for determining a state of the ejection section D[j], a residual vibration signal VD[j] corresponding to the detection signal Vout[j]. For example, the detecting circuit 33 shapes the detection signal Vout[j] into a waveform suitable for processing in the inspection unit 6 by amplifying the amplitude of the detection signal Vout[j] or removing a noise component from the detection signal Vout[j]. By performing the shaping, the residual vibration signal VD[j] is generated. For example, the detecting circuit 33 may include a negative feedback amplifier for amplifying the detection signal Vout[j], a low-pass filter for attenuating a high-frequency component of the detection signal Vout[j], and a voltage follower that converts impedance and outputs a low-impedance residual vibration signal VD[j].

For example, the residual vibration signal VD[j] generated based on the detection signal Vout[j] is an analog signal indicating the waveform of the residual vibration of the vibration plate 321 after the piezoelectric element PZ[j] is driven by the individual drive signal Vin[j]. The detecting circuit 33 outputs, to the inspection unit 6, the residual vibration signal VD[j] generated based on the detection signal Vout[j]. In this manner, the detecting circuit 33 detects, based on the detection signal Vout[j], the residual vibration of the vibration plate 321 caused by driving the piezoelectric element PZ[j].

For example, the inspection unit 6 determines the state of the ejection section D[j] based on the residual vibration signal VD[j]. An outline of the inspection unit 6 will be briefly described with reference to FIG. 1, and details of the inspection unit 6 will be described later with reference to FIG. 7. In the present embodiment, it is assumed that the inspection unit 6 has a first inspection mode and a second inspection mode as inspection modes for determining the state of the ejection section D. For example, the first inspection mode is an inspection mode for determining the state of the ejection section D[j] in a shorter inspection period than in the second inspection mode. Therefore, in the present embodiment, the inspection period can be shortened by selecting the first inspection mode as an inspection mode. In the present embodiment, by selecting the second inspection mode as the inspection mode, it is possible to determine a plurality of state abnormalities including a thickened state of the ink in the ejection section D.

The inspection unit 6 includes, for example, a signal generator 60 that generates a state inspection signal based on the residual vibration signal VD, and a determining section 64 that determines the state of the ejection section D based on the state inspection signal. For example, the determining section 64 determines the state of the ejection section D based on the state inspection signal generated by the signal generator 60, and generates state information Cinf including information indicating the result of the determination. Examples of the state of the ejection section D include the thickened state of the ink in the ejection section D. For example, the determining section 64 determines the thickened state of the ink in the ejection section D[j] using the state inspection signal generated based on the residual vibration signal VD[j]. In this case, in a state where an abnormality caused by thickening of the ink in the ejection section D[j] has occurred, it is possible to suppress the execution of the printing process. Hereinafter, the process of determining the state of the ejection section D[j] is also referred to as an ejection state determination process. Hereinafter, the ejection section D of which the state is to be determined is also referred to as an ejection section D to be determined.

When the ejection state determination process is to be executed, the drive controller 22 generates a signal for controlling the head unit 3, such as the print signal SI. When the ejection state determination process is to be executed, the drive controller 22 generates a signal for controlling the drive signal generation unit 4, such as the waveform specifying signal dCOM. Accordingly, the drive controller 22 drives the ejection section D[j] as the ejection section D to be determined.

When the ejection state determination process is to be executed, the drive controller 22 generates the print signal SI to control the head unit 3 so as to supply, to the detecting circuit 33, the detection signal Vout D[j] corresponding to the ejection section D[j] driven as the ejection section D to be determined. Accordingly, the detecting circuit 33 generates the residual vibration signal VD[j] corresponding to the detection signal Vout[j] detected from the ejection section D[j] driven as the ejection section D to be determined. Then, the inspection unit 6 determines, based on the residual vibration signal VD[j] supplied from the detecting circuit 33, the state of the ejection section D[j] driven as the ejection section D to be determined. The inspection unit 6 outputs, to the control unit 2, state information Cinf including information indicating the result of determining the state of the ejection section D[j].

The inspection unit 6 may be included in the control unit 2. For example, the control unit 2 may function as the inspection unit 6 by operating in accordance with the control program PG stored in the storage unit 5.

As described above, in the present embodiment, the ink jet printer 1 executes the maintenance process. For example, the maintenance process includes flushing processing of discharging ink from the ejection section D, wiping processing of wiping off foreign matter, such as ink adhering to a portion in the vicinity of a nozzle N of the ejection section D, with a wiper, and pumping processing of sucking ink in the ejection section D by a tube pump or the like. The nozzle N will be described below with reference to FIG. 3.

For example, thickened ink having increased viscosity is discharged from the ejection section D by the flushing processing. Accordingly, it is possible to set the viscosity of the ink in the nozzle N at the start of the printing process to be lower than or equal to predetermined viscosity. In this case, since the thickened ink is discharged from the ejection section D, it is possible to suppress a reduction in the quality of the image printed by the printing process.

The maintenance unit 8 includes a discharged ink receiving section 80 for receiving discharged ink when the ink in the ejection section D is discharged in the flushing processing, the wiper for wiping off foreign matter such as ink adhering to a portion in the vicinity of the nozzle N of the ejection section D, and the tube pump for sucking the ink, air bubbles, and the like in the ejection section D. The discharged ink receiving portion 80 will be described later with reference to FIG. 2. The wiper and the tube pump are not illustrated. Next, a schematic internal structure of the ink jet printer 1 will be described with reference to FIG. 2.

FIG. 2 is a perspective view illustrating an example of the schematic internal structure of the ink jet printer 1.

As illustrated in FIG. 2, in the present embodiment, it is assumed that the ink jet printer 1 is a serial printer. Specifically, in the printing process, the ink jet printer 1 forms a dot corresponding to the print data IMG on the recording sheet P by ejecting the ink from the ejection section D[j] while transporting the recording sheet P in a sub-scanning direction and causing the head module HM to reciprocate in a main scanning direction intersecting the sub-scanning direction.

Hereinafter, for convenience of description, a three-axis orthogonal coordinate system having an X axis, a Y axis, and a Z axis orthogonal to each other is appropriately introduced. For example, in the present embodiment, a Y1 direction along the Y axis is defined as the sub-scanning direction, and an X1 direction and an X2 direction that are along the X axis are defined as the main scanning direction. The X2 direction is opposite to the X1 direction. In the present embodiment, as illustrated in FIG. 2, a Z1 direction along the Z axis is set as an ejection direction in which ink is ejected from the ejection section D[j]. Hereinafter, the X1 direction and the X2 direction are collectively referred to as an X-axis direction, the Y1 direction and a Y2 direction opposite to the Y1 direction are collectively referred to as a Y-axis direction, and the Z1 direction and a Z2 direction opposite to the Z1 direction are collectively referred to as a Z-axis direction. In the present embodiment, as described above, it is assumed that the X axis, the Y axis, and the Z axis are orthogonal to each other, but the present disclosure is not limited to such an aspect. For example, it suffices for the X axis, the Y axis, and the Z axis to intersect each other.

The ink jet printer 1 according to the present embodiment includes a housing 100 and a carriage 110 capable of reciprocating in the X axis direction in the housing 100. The head module HM including the four head units 3 is mounted on the carriage 110.

In the present embodiment, it is assumed that the carriage 110 stores four ink cartridges 120 corresponding to four color inks of cyan, magenta, yellow, and black on a one-to-one basis. In the present embodiment, it is assumed that the four head units 3 correspond to the four ink cartridges 120 in a one-to-one manner. Each ejection section D receives ink supplied from the ink cartridge 120 corresponding to the head unit 3 in which the ejection section D is disposed. Accordingly, each ejection section D can fill the inside of the ejection section D with the supplied ink and eject the filled ink from a nozzle N. The ink cartridge 120 may be disposed outside the carriage 110.

As described with reference to FIG. 1, the ink jet printer 1 according to the present embodiment includes the transport unit 7. The transport unit 7 includes a carriage transport mechanism 71 for causing the carriage 110 to reciprocate in the X-axis direction, and a carriage guide shaft 76 that supports the carriage 110 so as to enable the carriage 110 to reciprocate in the X-axis direction. The transport unit 7 includes a medium transport mechanism 73 for transporting the recording sheet P, and a platen 75 disposed in the Z1 direction relative to the carriage 110. For example, in the printing process, the carriage transport mechanism 71 causes the head module HM to reciprocate along the carriage guide shaft 76 in the X-axis direction together with the carriage 110, and the media transport mechanism 73 transports the recording sheet P on the platen 75 in the Y1 direction. Therefore, in the printing process, the transport unit 7 causes the carriage transport mechanism 71 and the medium transport mechanism 73 to execute the above-described operations, thereby changing a relative position of the recording sheet P with respect to the head module HM and enabling the ink to land on the entire recording sheet P.

Next, a schematic structure of the recording head 32 will be described with reference to FIG. 3.

FIG. 3 is a cross-sectional view for explaining an example of a structure of the ejection section D. FIG. 3 schematically illustrates a cross section of a portion of the recording head 32 when the recording head 32 is cut such that the portion of the recording head 32 includes the ejection section D[j].

The ejection section D[j] includes a cavity CV in which ink is filled, the nozzle N communicating with the cavity CV, the piezoelectric element PZ[j] that causes a change in pressure applied to the ink in the cavity CV when the individual drive signal Vin[j] is supplied to the piezoelectric element PZ[j], and the vibration plate 321. The ejection section D[j] ejects the ink in the cavity CV from the nozzle N when the piezoelectric element PZ[j] is driven by the individual drive signal Vin[j].

The cavity CV corresponds to a pressure chamber communicating with the nozzle N. For example, the cavity CV is a space partitioned by a cavity plate 324, a nozzle plate 323 in which the nozzle N is formed, and the vibration plate 321. The cavity CV communicates with a reservoir 325 via an ink supply port 326. The reservoir 325 communicates with the ink cartridge 120 corresponding to the ejection section D[j] via an ink intake port 327. The piezoelectric element PZ[j] includes the upper electrode Zu[j], a lower electrode Zd[j], and a piezoelectric body Zb[j] disposed between the upper electrode Zu[j] and the lower electrode Zd[j]. The piezoelectric body Zb[j] is formed of, for example, a ferroelectric piezoelectric material.

The upper electrode Zu[j] is electrically coupled to wiring Li through which the individual drive signal Vin[j] is supplied to the upper electrode Zu[j]. The lower electrode Zd[j] is electrically coupled to wiring Ld through which a base electrical potential signal VBS is supplied to the lower electrode Zd[j]. When the individual drive signal Vin[j] is supplied to the upper electrode Zu[j], a voltage is applied between the upper electrode Zu[j] and the lower electrode Zd[j]. The piezoelectric element PZ[j] is deformed in the Z1 direction or the Z2 direction in accordance with the voltage applied between the upper electrodes Zu[j] and the lower electrodes Zd[j].

In this way, the piezoelectric element PZ[j] vibrates in accordance with the voltage applied between the upper electrode Zu[j] and the lower electrode Zd[j]. The lower electrode Zd[j] is bonded to the vibration plate 321. Therefore, when the piezoelectric element PZ[j] is driven by the individual drive signal Vin[j] and vibrates, the vibration plate 321 also vibrates. Then, the volume of the cavity CV and the pressure in the cavity CV are changed by the vibration of the vibration plate 321, and the ink filled in the cavity CV is ejected from the nozzle N.

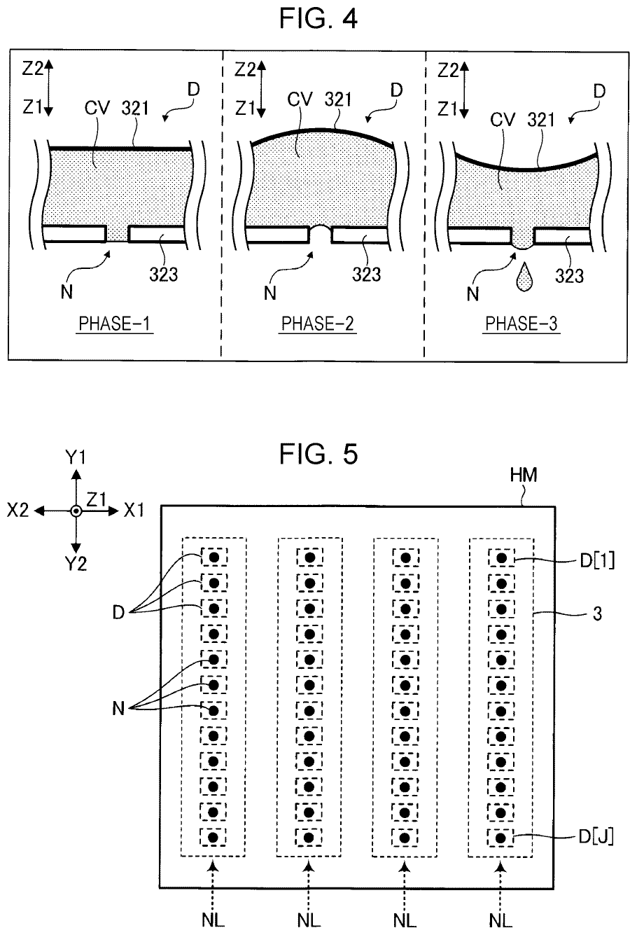

In the present embodiment, as an example, it is assumed that the piezoelectric element PZ[j] is deformed in the Z1 direction when the electrical potential of the individual drive signal Vin[j] supplied to the ejection section D[j] is changed from a low electrical potential to a high electrical potential. That is, in the present embodiment, it is assumed that the volume of the cavity CV included in the ejection section D[j] when the electrical potential of the individual drive signal Vin D[j] supplied to the ejection section D[j] is the high electrical potential is smaller than that when the electrical potential of the individual drive signal Vin D[j] supplied to the ejection section D[j] is the low electrical potential. Next, an ink ejection operation in the ejection section D will be described with reference to FIG. 4.

FIG. 4 is a diagram for explaining the ink ejection operation in the ejection section D.

For example, in a state of Phase-1 illustrated in FIG. 4, the drive controller 22 changes the electrical potential of the drive signal COM supplied to the piezoelectric element PZ included in the ejection section D so as to generate a strain that deforms the piezoelectric element PZ in the Z2 direction. Therefore, the vibration plate 321 of the ejection section D becomes bent in the Z2 direction. As a result, as in a state of Phase-2 illustrated in FIG. 4, the volume of the cavity CV of the ejection section D increases compared with that in the state of Phase-1. Next, for example, in the state of Phase-2, the drive controller 22 changes the electrical potential of the drive signal COM so as to generate a strain that deforms the piezoelectric element PZ in the Z1 direction. Therefore, the vibration plate 321 of the ejection section D becomes bent in the Z1 direction. As a result, as in a state of Phase-3 illustrated in FIG. 4, the volume of the cavity CV rapidly decreases, and a portion of the ink filling the cavity CV is ejected as an ink droplet from the nozzle N communicating with the cavity CV.

As described above, the piezoelectric element PZ and the vibration plate 321 included in the ejection section D are deformed in the Z-axis direction when the piezoelectric element PZ included in the ejection section D is driven by the drive signal COM. Therefore, residual vibration occurs in the ejection section D including the vibration plate 321 after the piezoelectric element PZ is driven by the drive signal COM.

Next, an example of the arrangement of nozzles N will be described with reference to FIG. 5.

FIG. 5 is a plan view illustrating an example of the arrangement of the nozzles N in the head units 3. FIG. 5 illustrates an example of the arrangement of the four head units 3 included in the head module HM and a total of the 4J nozzles N disposed in the four head units 3 when the ink jet printer 1 is viewed in plan view from the Z1 direction.

A nozzle row NL is disposed in each of the head units 3 included in the head module HM mounted on the carriage 110. Each of the nozzle rows NL is a plurality of nozzles N arranged in a row shape in a predetermined direction. In the present embodiment, as an example, it is assumed that each of the nozzle rows NL is constituted by J nozzles N arranged in the Y-axis direction.

Next, an outline of each of the head units 3 will be described with reference to FIG. 6.

FIG. 6 is a block diagram illustrating an example of a configuration of each of the head units 3.

As described with reference to FIG. 1, the head unit 3 includes the switching circuit 31, the recording head 32, and the detecting circuit 33. The head unit 3 includes wiring La through which the drive signal COM is supplied from the drive signal generation unit 4, and wiring Ls through which the detection signal Vout is supplied to the detecting circuit 33. The head unit 3 includes wiring Li[j] through which the individual drive signal Vin[j] is supplied to the ejection section D[j] and wiring Ld through which the base electrical potential signal VBS is supplied.

The switching circuit 31 includes J switches SWa[1] to SWa[J] corresponding to the J ejection sections D[1] to D[J] on a one-to-one basis, J switches SWs[1] to SWs[J] corresponding to the J ejection sections D[1] to D[J] on a one-to-one basis, and a coupling state specifying circuit 310.

The coupling state specifying circuit 310 specifies a coupling state of each of the J switches SWa and the J switches SWs. For example, the coupling state specifying circuit 310 generates coupling state specifying signals Qa[j] and Qs[j] based on at least one of the print signal SI, a latch signal LAT, and a period defining signal Tsig supplied from the drive controller 22. The coupling state specifying signal Qa[j] specifies whether to turn on or off the switch SWa[j], and the coupling state specifying signal Qs[j] specifies whether to turn on or off the switch SWs[j].

In the present embodiment, it is assumed that each of the J switches SWa and the J switches SWs is constituted by a transfer gate including a P-channel transistor and an N-channel transistor that are coupled in parallel. However, each of the J switches SWa and the J switches SWs may be constituted by one of a P-channel transistor and an N-channel transistor.

The switch SWa[j] switches between conduction and non-conduction between the wiring La and the upper electrode Zu[j] of the piezoelectric element PZ[j] disposed in the ejection section D[j] based on the coupling state specifying signal Qa[j]. That is, the switch SWa[j] switches between conduction and non-conduction between the wiring La and the wiring Li[j] coupled to the upper electrode Zu[j] based on the coupling state specifying signal Qa[j]. In the present embodiment, the switch SWa[j] is on when the coupling state specifying signal Qa[j] is at a high level, and is off when the coupling state specifying signal Qa[j] is at a low level. When the switch SWa[j] is turned on, the drive signal COM supplied to the wiring La is supplied as the individual drive signal Vin[j] to the upper electrode Zu[j] of the ejection section D[j] through the wiring Li[j]. That is, the individual drive signal Vin[j] is the drive signal COM supplied to the piezoelectric element PZ[j] included in the ejection section D[j] through the switch SWa[j].

The switch SWs[j] switches between conduction and non-conduction between the wiring Ls and the upper electrode Zu[j] of the piezoelectric element PZ[j] disposed in the ejection section D[j] based on the coupling state specifying signal Qs[j]. That is, the switch SWs[j] switches between conduction and non-conduction between the wiring Ls and the wiring Li[j] coupled to the upper electrode Zu[j] based on the coupling state specifying signal Qs[j]. In the present embodiment, the switch SWs[j] is on when the coupling state specifying signal Qs[j] is at a high level, and is off when the coupling state specifying signal Qs[j] is at a low level.

For example, the coupling state specifying signal Qs[j] becomes a high level when the residual vibration of the ejection section D[j] is detected. As a result, the residual vibration of the ejection section D to be determined is detected. When the switch SWs[j] is turned on, the detection signal Vout[j] indicating the electrical potential of the upper electrode Zu[j] of the piezoelectric element PZ[j] included in the ejection section D[j] to be determined is supplied to the detecting circuit 33 through the wiring Li[j] and the wiring Ls. Then, the detecting circuit 33 generates the residual vibration signal VD[j] based on the detection signal Vout[j]. The residual vibration signal VD[j] is supplied to the signal generator 60 of the inspection unit 6.

The supply of the residual vibration signal VD[j] to the signal generator 60 is ended when the switch SWs[j] is turned off. For example, when the switch SWs[j] is turned off, the wiring Ls and the wiring Li[j] are electrically decoupled from each other, and thus a signal path for the residual vibration signal VD from the ejection section D to the signal generator 60 is blocked. That is, the signal generator 60 becomes electrically decoupled from the ejection section D[j] by the coupling state specifying signal Qs[j]. For example, a timing at which the coupling state specifying signal Qs[j] transitions from a high level to a low level corresponds to a blocking timing at which the signal path for the residual vibration signal VD from the ejection section D to the signal generator 60 is blocked. The coupling state specifying signal Qs is an example of a “blocking signal”. In the signal path for the residual vibration signal VD from the ejection section D[j] to the signal generator 60, one of the wiring Ls and the wiring Li[j] corresponds to a “first signal path”, and the other of the wiring Ls and the wiring Li[j] corresponds to a “second signal path”.

Next, the inspection unit 6 will be described with reference to FIG. 7.

FIG. 7 is a block diagram illustrating an example of a configuration of the inspection unit 6. As described with reference to FIG. 1, the inspection unit 6 includes the signal generator 60 and the determining section 64.

The signal generator 60 includes, for example, a comparing section 62 including comparing circuits 620, 621, and 622, and an adjusting section 63 including adjusting circuits 630, 631, and 632.

Each of the comparing circuits 620, 621, and 622 included in the comparing section 62 binarizes the residual vibration signal VD by comparing the residual vibration signal VD with a threshold.

For example, the comparing circuit 620 compares the electrical potential of the residual vibration signal VD with a threshold electrical potential VthC, and generates a comparison signal CPc indicating a result of the comparison. Specifically, the comparing circuit 620 generates the comparison signal CPc that is at a high level when the electrical potential of the residual vibration signal VD is higher than or equal to the threshold electrical potential VthC, and is at a low level when the electrical potential of the residual vibration signal VD is lower than the threshold electrical potential VthC.

For example, the comparing circuit 621 compares the electrical potential of the residual vibration signal VD with a threshold electrical potential Vth1, and generates a comparison signal CP1 indicating a result of the comparison. Specifically, the comparing circuit 621 generates the comparison signal CP1 that is at a high level when the electrical potential of the residual vibration signal VD is higher than or equal to the threshold electrical potential Vth1, and is at a low level when the electrical potential of the residual vibration signal VD is lower than the threshold electrical potential Vth1.

For example, the comparing circuit 622 compares the electrical potential of the residual vibration signal VD with a threshold electrical potential Vth2, and generates a comparison signal CP2 indicating a result of the comparison. Specifically, the comparing circuit 622 generates the comparison signal CP2 that is at a high level when the electrical potential of the residual vibration signal VD is higher than or equal to the threshold electrical potential Vth2, and is at a low level when the electrical potential of the residual vibration signal VD is lower than the threshold electrical potential Vth2.

In the present embodiment, the threshold electrical potential VthC is an electrical potential of an amplitude center level of the residual vibration signal VD, and the threshold electrical potentials VthC, Vth1, and Vth2 satisfy “VthC<Vth2<Vth1”. In the present embodiment, the threshold electrical potentials VthC, Vth1, and Vth2 satisfy “|Vth2−VthC|<|Vth1−VthC|”. The threshold electrical potential VthC is an example of a “first electrical potential”, and the threshold electrical potentials Vth1 and Vth2 are examples of a “second electrical potential”.

The comparison signals CPC, CP1, and CP2 are supplied to the adjusting circuits 630, 631, and 632 included in the adjusting section 63, respectively. Hereinafter, the comparison signals CPc, CP1, and CP2 may be collectively referred to as comparison signals CP. The comparison signals CP are examples of an “inspection signal”. The comparison signal CPC among the comparison signals CP corresponds to a “reference signal”.

The adjusting section 63 generates comparison signals CCPc, CCP1, and CCP2 based on the pulse detection period signal Pcut and the mask signal MSK supplied from the control unit 2, and the comparison signals CPc, CP1, and CP2 supplied from the comparing section 62. Hereinafter, the comparison signals CCPc, CCP1, and CCP2 may be collectively referred to as comparison signals CCP. The comparison signals CCP are examples of a “state inspection signal”.

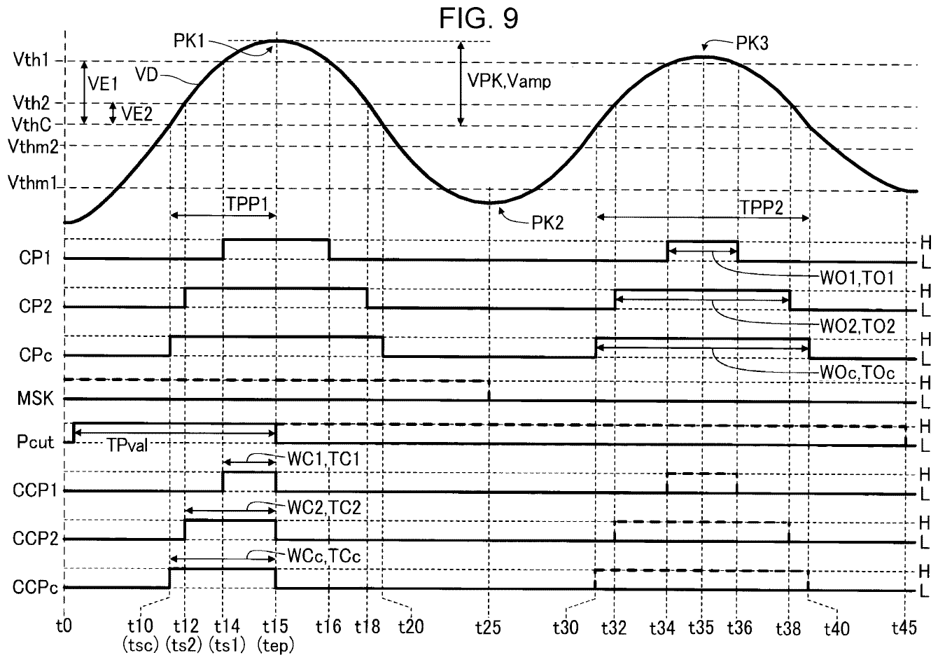

The pulse detection period signal Pcut is a signal for defining a reset timing tep of resetting the comparison signals CCP, as illustrated in FIG. 9 described later. For example, the pulse detection period signal Pcut is maintained at a high level in a period of time when the comparison signals CP are enabled as signals to be used to generate the comparison signals CCP. The pulse detection period signal Pcut is an example of a “reset signal”. In the second inspection mode, the mask signal MSK

defines a mask period for which the comparison signals CP are disabled as signals to be used to generate comparison signals CCP. Therefore, the residual vibration signal VD in the mask period is not used to determine the state of the ejection section D. In the present embodiment, it is assumed that the mask signal MSK is maintained at a high level in the mask period. For example, in the second inspection mode, the mask signal MSK is maintained at a high level until a predetermined time elapses after the switch SWs[j] is turned on, and changes to a low level after the predetermined time elapses. In the first inspection mode, the mask signal MSK is maintained at a low level.

For example, the adjusting circuit 630 included in the adjusting section 63 generates a comparison signal CCPC indicating a logical product of a signal obtained by inverting the mask signal MSK, the pulse detection period signal Pcut, and the comparison signal CPC. Thus, the electrical potential of the comparison signal CCPc after the reset timing tep defined by the pulse detection period signal Pcut is maintained at a low level regardless of the level of the comparison signal CPC. For example, the signal obtained by inverting the mask signal MSK is at a high level when the mask signal MSK is at a low level, and is at a low level when the mask signal MSK is at a high level.

For example, the adjusting circuit 631 included in the adjusting section 63 generates a comparison signal CCP1 indicating a logical product of the signal obtained by inverting the mask signal MSK, the pulse detection period signal Pcut, and the comparison signal CP1. Thus, the electrical potential of the comparison signal CCP1 after the reset timing tep defined by the pulse detection period signal Pcut is maintained at a low level regardless of the level of the comparison signal CP1.

For example, the adjusting circuit 632 included in the adjusting section 63 generates a comparison signal CCP2 indicating a logical product of the signal obtained by inverting the mask signal MSK, the pulse detection period signal Pcut, and the comparison signal CP2. Thus, the electrical potential of the comparison signal CCP2 after the reset timing tep defined by the pulse detection period signal Pcut is maintained at a low level regardless of the level of the comparison signal CP2.

The comparison signals CCPc, CCP1, and CCP2 generated by the adjusting circuits 630, 631, and 632, respectively, are supplied to the determining section 64. For example, in a case where the blocking timing is earlier than the reset timing tep, the comparison signal CCPC corresponds to a signal in which the electrical potential of the comparison signal CPc at the blocking timing is held until the reset timing tep. Similarly, the comparison signal CCP1 corresponds to a signal in which the electrical potential of the comparison signal CP1 at the blocking timing is held until the reset timing tep, and the comparison signal CCP2 corresponds to a signal in which the electrical potential of the comparison signal CP2 at the blocking timing is held until the reset timing tep.

Since the electrical potentials of the comparison signals CCP after the reset timing tep are maintained at a low level regardless of the levels of the comparison signals CP, the reset timing tep can also be treated as an end timing of pulses of the comparison signals CCP.

The determining section 64 includes an identifying section 67, an amplitude calculating circuit 68, and a determining circuit 69. The identifying section 67 includes identifying circuits 670, 671, and 672.

For example, the identifying section 67 identifies a time length of a period of time when each of the comparison signals CCPc, CCP1, and CCP2 is maintained at a high level. For example, the comparison signals CCPc, CCP1, and CCP2 are supplied to the identifying circuits 670, 671, and 672 included in the identifying section 67, respectively. For example, the identifying circuit 670 identifies a time length TCc of a period WCc of time when the comparison signal CCPc is at a high level, and outputs time information NTCc indicating the time length TCc to the amplitude calculating circuit 68. In the present embodiment, as illustrated in FIG. 9 described later, the period WCc having the identified time length TCc is a period of time when the comparison signal CCPc is first maintained at a high level in a period of time after time to when the supply of the residual vibration signal VD to the signal generator 60 is started.

The identifying circuit 671 identifies a time length TC1 of a period WC1 of time when the comparison signal CCP1 is at a high level, and outputs time information NTC1 indicating the time length TC1 to the amplitude calculating circuit 68. As illustrated in FIG. 9, the period WC1 having the identified time length TC1 is a period of time when the comparison signal CCP1 is first maintained at a high level in a period of time after time to.

The identifying circuit 672 identifies a time length TC2 of a period WC2 of time when the comparison signal CCP2 is at a high level, and outputs time information NTC2 indicating the time length TC2 to the amplitude calculating circuit 68. As illustrated in FIG. 9, the period WC2 having the identified time length TC2 is a period of time when the comparison signal CCP2 is first maintained at a high level in a period of time after time to. Hereinafter, the time lengths TCc, TC1, and TC2 may be collectively referred to as time lengths TC, and the time information NTCc, NTC1, and NTC2 may be collectively referred to as time information NTC. The time information NTC is examples of “inspection signal information”.

The amplitude calculating circuit 68 calculates, for example, an amplitude Vamp corresponding to an amplitude VPK of the residual vibration signal VD illustrated in FIG. 9. The amplitude Vamp corresponding to the amplitude VPK of the residual vibration signal VD corresponds to an amplitude equal to the amplitude VPK of the residual vibration signal VD, an amplitude obtained by amplifying the amplitude VPK of the residual vibration signal VD, an amplitude obtained by attenuating the amplitude VPK of the residual vibration signal VD, or the like. Hereinafter, the amplitude Vamp corresponding to the amplitude VPK of the residual vibration signal VD may be simply referred to as the amplitude Vamp of the residual vibration signal VD.

In the present embodiment, the amplitude calculating circuit 68 has a first calculation mode and a second calculation mode as calculation modes for calculating the amplitude Vamp of the residual vibration signal VD. For example, in the first calculation mode, the amplitude calculating circuit 68 calculates the amplitude Vamp based on the time lengths TCc and TC1 and the threshold electrical potentials VthC and Vth1. In the second calculation mode, the amplitude calculating circuit 68 calculates the amplitude Vamp based on the time lengths TCc and TC2 and the threshold electrical potentials VthC and Vth2.

The amplitude Vamp is expressed by Equation (1) in the first calculation mode and is expressed by Equation (2) in the second calculation mode. Each of the following Equations (1) and (2) is for calculating the amplitude Vamp by approximating the waveform of the residual vibration signal VD to a sine wave.

$$Vamp = \frac{Vth 1 - VthC}{sin \{ \frac{π}{2} ( 1 - \frac{TC 1}{TCc} ) \}} \qquad ( 1 )$$

$$Vamp = \frac{Vth 2 - VthC}{sin \{ \frac{π}{2} ( 1 - \frac{TC 2}{TCc} ) \}} \qquad ( 2 )$$

Which one of the first calculation mode and the second calculation mode is used to calculate the amplitude Vamp may be determined in advance for each nozzle N, for example. Alternatively, the amplitude calculating circuit 68 may determine, based on the time length TC1, which of the first calculation mode and the second calculation mode is used to calculate the amplitude Vamp. For example, the amplitude calculating circuit 68 may calculate the amplitude Vamp in the first calculation mode when the time length TC1 is longer than a first reference time, and may calculate the amplitude Vamp in the second calculation mode when the time length TC1 is shorter than a second reference time that is shorter than or equal to the first reference time. When the time length TC1 is longer than or equal to the second reference time and shorter than or equal to the first reference time, the amplitude Vamp may be calculated in the previous calculation mode. The initial calculation mode is, for example, the first calculation mode. In the above-described example, the switching between the calculation modes has a hysteresis characteristic, but the switching between the calculation modes may not have the hysteresis characteristic.

The amplitude calculating circuit 68 outputs amplitude information NVamp indicating the amplitude Vamp to the determining circuit 69 as waveform information indicating the characteristics of the waveform of the residual vibration signal VD. The characteristics of the waveform of the residual vibration signal VD are, for example, information regarding the shape of the waveform of the residual vibration signal VD, such as the amplitude VPK and the period of the residual vibration signal VD. In the present embodiment, as described above, it is assumed that the amplitude information NVamp indicating the amplitude Vamp corresponding to the amplitude VPK of the residual vibration signal VD is supplied to the determining circuit 69 as the waveform information.

The determining circuit 69 determines an ejection state of the ink in the ejection section D based on the amplitude Vamp of the residual vibration signal VD, and generates state information Cinf including information indicating the result of the determination. For example, when the inspection mode is the second inspection mode, the determining circuit 69 may acquire the time information NTCc indicating the time length TCc of the period WCc of time when the comparison signal CCPc is at a high level as the waveform information in addition to the amplitude information NVamp. In this case, the determining circuit 69 may determine the ejection state of the ink in the ejection section D based on the amplitude Vamp of the residual vibration signal VD and the time length TCc. As a method of determining the state of the ejection section D based on the amplitude Vamp of the residual vibration signal VD and the like, it is possible to adopt a known method of determining the state of the ejection section D based on the amplitude VPK of the residual vibration signal VD or the like.

Next, an operation of the ink jet printer 1 will be described with reference to FIG. 8.

FIG. 8 is a timing chart illustrating an example of the operation of the ink jet printer 1 in a unit period TU. In the present embodiment, for the execution of the printing process or the ejection state determination process by the ink jet printer 1, one or a plurality of unit periods TU are set as an operation period of the ink jet printer 1. The ink jet printer 1 according to the present embodiment can drive each ejection section D for the printing process or the ejection state determination process in each unit period TU. For example, for the execution of the ejection state determination process by the ink jet printer 1, the ink jet printer 1 can drive the ejection section D to be determined, and detect the detection signal Vout[j] from the ejection section D to be determined in each unit period TU.

The control unit 2 outputs the latch signal LAT having pulses PlsL. Therefore, the control unit 2 defines the unit period TU as a period of time from a rising edge of the pulse PlsL to a rising edge of the next pulse PlsL.

The print signal SI includes, for example, J individual specifying signals Sd[1] to Sd[J] corresponding to the J ejection sections D[1] to D[J] on a one-to-one basis. The individual specifying signal Sd[j] specifies the drive mode of the ejection section D[j] in each unit period TU for the execution of the printing process or the ejection state determination process by the ink jet printer 1. For example, the control unit 2 supplies the print signal SI including the individual specifying signals Sd[1] to Sd[J] to the coupling state specifying circuit 310 in synchronization with the clock signal CL prior to each unit period TU. Then, the coupling state specifying circuit 310 generates the coupling state specifying signals Qa[j] and Qs[j] based on the individual specifying signal Sd[j] in the unit period TU.

For example, the ejection section D[j] is specified by the individual specifying signal Sd[j] as any one of the ejection section D that forms a dot and the ejection section D that does not form a dot in a unit period TU in which the printing process is executed. For example, in the unit period TU in which the ejection state determination process is executed, whether the ejection section D[j] is driven as the ejection section D to be determined is specified by the individual specifying signal Sd[j]. FIG. 8 illustrates the coupling state specifying signals Qa[j] and Qs[j] and the like when the ejection section D[j] is specified by the individual specifying signal Sd[j] as the ejection section D to be determined in the unit period TU in which the ejection state determination process is executed. An operation of the ink jet printer 1 to execute the ejection state determination process will be mainly described with reference to FIG. 8. In FIG. 8, it is assumed that the inspection mode is the first inspection mode. In this case, the mask signal MSK is maintained at a low level in the unit period TU.

When the ejection state determination process is to be executed, for example, the control unit 2 outputs a period defining signal Tsig having a pulse PlsT1 and a pulse PlsT2. Accordingly, the control unit 2 divides the unit period TU into a control period TSS1 from the start of the pulse PlsL to the start of the pulse PlsT1 and a control period TSS2 from the start of the pulse PlsT1 to the start of the next pulse PlsL.

The control unit 2 controls the pulse detection period signal Pcut to define an enabling period TPval of time when the comparison signals CP are enabled. For example, the drive controller 22 of the control unit 2 sets the pulse detection period signal Pcut to a high level at the end of the pulse PlsT1, and sets the pulse detection period signal Pcut to a low level at the start of the pulse PlsT2. In this case, a period of time when a result of a logical product of the signal obtained by inverting the mask signal MSK and the pulse detection period signal Pcut is at a high level corresponds to the enabling period TPval. In the first inspection mode, as illustrated in FIG. 8, since the mask signal MSK is maintained at a low level in the unit period TU, a period of time when the pulse detection period signal Pcut is at a high level corresponds to the enabling period TPval.

The drive signal COM used in the ejection state determination process has, for example, a pulse PA that is supplied to the wiring La in the control period TSS1. The pulse PA used in the ejection state determination process may be a pulse that does not cause ink to be ejected from the nozzle N, or may be a pulse that causes ink to be ejected from the nozzle N, as long as the pulse PA causes the vibration plate 321 to vibrate. In the present embodiment, it is assumed that the pulse PA is a pulse that does not cause ink to be ejected from the nozzle N. In the printing process, instead of the pulse PA, a pulse for ejecting ink from the nozzle N is supplied to the wiring La in the unit period TU.

The pulse PA is a waveform in which the electrical potential of the drive signal COM returns to an electrical potential V0 from the electrical potential V0 through an electrical potential VLa lower than the electrical potential V0. The electrical potential V0 is an electrical potential at the start and end of the pulse PA, and is a reference electrical potential of the drive signal COM.

For example, the pulse PA has a waveform element Pa1 in which the electrical potential changes from the electrical potential V0 to the electrical potential VLa, a waveform element PA2 in which the electrical potential is maintained at the electrical potential VLa at the end of the waveform element Pa1, and a waveform element Pa3 in which the electrical potential changes from the electrical potential VLa to the electrical potential V0. Hereinafter, the waveform elements Pa1, Pa2, and Pa3 may be collectively referred to as waveform elements Pa.

The waveform element Pa1 is an expansion element for deforming the piezoelectric body Zb in the Z2 direction. In the expansion element, the electrical potential of the drive signal COM changes in order to drive the piezoelectric element PZ so as to increase the volume of the cavity CV. Therefore, in the waveform element Pa1, the electrical potential of the drive signal COM changes so as to increase the volume of the cavity CV. When the volume of the cavity CV is increased, as in the state of Phase-2 illustrated in FIG. 4, the surface of the ink in the nozzle N is drawn in the Z2 direction opposite to the ejection direction. Hereinafter, the drawing of the surface of the ink in the nozzle N in the direction opposite to the ejection direction may be referred to as pull.

The waveform element Pa2 is a maintaining element for maintaining the position of the piezoelectric body Zb in the Z-axis direction. For example, in the waveform element Pa2, the electrical potential of the drive signal COM is maintained in order to drive the piezoelectric element PZ so as to maintain the volume of the cavity CV expanded by the waveform element Pa1.

The waveform element Pa3 is a contraction element for deforming the piezoelectric body Zb in the Z1 direction. In the contraction element, the electrical potential of the drive signal COM changes in order to drive the piezoelectric element PZ so as to decrease the volume of the cavity CV. Therefore, in the waveform element Pa3, the electrical potential of the drive signal COM changes so as to decrease the volume of the cavity CV. When the volume of the cavity CV is decreased, the surface of the ink in the nozzle N is pushed out in the Z1 direction which is the ejection direction. In the present embodiment, the surface of the ink in the nozzle N is pushed out in the Z1 direction by the waveform element Pa3 to such an extent that the ink is not ejected from the nozzle N. Hereinafter, the pushing out of the surface of the ink in the nozzle N in the ejection direction may be referred to as push.

As described above, the pulse PA is a so-called pull-push waveform. However, the waveform of the drive signal COM that does not cause the ink to be ejected from the nozzle N is not limited to the pull-push waveform.

For example, when the ejection section D[j] is specified by the individual specifying signal Sd[j] as the ejection section D to be determined, the coupling state specifying circuit 310 sets the coupling state specifying signal Qa[j] to a high level and the coupling state specifying signal Qs[j] to a low level in the control period TSS1. In the control period TSS2, the coupling state specifying circuit 310 sets the coupling state specifying signal Qa[j] to a low level and the coupling state specifying signal Qs[j] to a high level. The timing at which the coupling state specifying signal Qs[j] transitions from a low level to a high level corresponds to the timing at which the input of the drive signal COM to the ejection section D[j] is ended and the timing at which the residual vibration signal VD[j] is input to the signal generator 60.

It is preferable that, when the control period TSS1 is switched to the control period TSS2, each of the switches SWa[j] and SWs[j] be switched between an on state and an off state after a state where both of the switches SWa[j] and SWs[j] are on. That is, it is preferable that the timing at which the coupling state specifying signal Qs[j] transitions from a low level to a high level be earlier than the timing at which the coupling state specifying signal Qa[j] transitions from a high level to a low level. It is preferable that the timing at which the coupling state specifying signal Qs[j] transitions from a high level to a low level be later than the timing at which the coupling state specifying signal Qa[j] transitions from a low level to a high level. In this case, since a state where both the switches SWa[j] and SWs[j] are turned off when the control period TSS1 is switched to the control period TSS2 does not occur, it is possible to suppress a change in the electrical potential of the wiring Ls illustrated in FIG. 6 due to switching noise or the like.

It is preferable that the timing at which the pulse detection period signal Pcut transitions from a high level to a low level be earlier than the timing at which the coupling state specifying signal Qa[j] transitions from a low level to a high level and the timing at which the coupling state specifying signal Qs[j] transitions from a high level to a low level. Therefore, in the present embodiment, as described above, the drive controller 22 of the control unit 2 sets the pulse detection period signal Pcut to a low level at the start of the pulse PlsT2. In a case where the above-described transition timings are satisfied, the drive controller 22 of the control unit 2 may set the pulse detection period signal Pcut to a high level at the start of the pulse PlsT1, and may set the pulse detection period signal Pcut to a low level at the start of the next pulse PlsL.

The timing at which the pulse detection period signal Pcut transitions from a high level to a low level corresponds to the reset timing tep at which the comparison signals CCP are reset. Hereinafter, the timing at which the pulse detection period signal Pcut transitions from a high level to a low level may be referred to as the reset timing tep.

The piezoelectric element PZ[j] included in the ejection section D[j] to be determined is driven by the pulse PA of the drive signal COM in the control period TSS1. Specifically, the piezoelectric element PZ[j] included in the ejection section D[j] to be determined is deformed by the pulse PA of the drive signal COM in the control period TSS1. As a result, vibration occurs in the ejection section D[j] to be determined. The vibration generated in the control period TSS1 also remains in the control period TSS2. In the control period TSS2, the electrical potential of the upper electrode Zu[j] of the piezoelectric element PZ[j] included in the ejection section D[j] to be determined changes in accordance with the residual vibration generated in the ejection section D[j] to be determined. That is, in the control period TSS2, the electrical potential of the upper electrode Zu of the piezoelectric element PZ included in the ejection section D to be determined is an electrical potential corresponding to an electromotive force of the piezoelectric element PZ caused by the residual vibration generated in the ejection section D to be determined. The electrical potential of the upper electrode Zu is detected as a detection signal Vout in the control period TSS2. Thus, a change in the electrical potential of the upper electrode Zu is detected as the detection signal Vout in the control period TSS2. As a result, the detection signal Vout is input to the detecting circuit 33 as a residual vibration signal generated due to the vibration remaining in the ejection section D.

The detection signal Vout input to the detecting circuit 33 is supplied to the signal generator 60 as the residual vibration signal VD in the control period TSS2. Accordingly, in the control period TSS2, the comparison signals CP are generated by the signal generator 60. In the enabling period TPval, the comparison signals CCP are generated by the signal generator 60.

Next, an operation of the ink jet printer 1 to execute the printing process will be briefly described. In the printing process, the unit period TU may not be divided into the control period TSS1 and the control period TSS2. In this case, in the unit period TU, the period defining signal Tsig may be maintained at a low level, and the pulse detection period signal Pcut may be maintained at a low level.

For example, the coupling state specifying signal Qs[j] is maintained at a low level in the unit period TU regardless of whether the ejection section D[j] is specified as the ejection section D that forms a dot. The coupling state specifying signal Qa[j] is set to a high level or a low level based on whether the ejection section D[j] is specified as the ejection section D that forms a dot.

For example, when the ejection section D[j] is specified by the individual specifying signal Sd[j] as the ejection section D that forms a dot, the coupling state specifying circuit 310 sets the coupling state specifying signal Qa[j] to a high level in the unit period TU. A coupling state specifying signal Qa corresponding to an ejection section D that does not form a dot is set to a low level in the unit period TU.

When the coupling state specifying signal Qa[j] is set to a high level, a drive signal COM including a pulse for ejecting ink from the nozzle N is supplied from the drive signal generation unit 4 to the ejection section D that forms a dot. For example, the pulse for ejecting ink from the nozzle N is supplied to the wiring La in the unit period TU. The pulse for ejecting ink from the nozzle N may have a pull-push waveform, similarly to the pulse PA. In this case, the pulse for ejecting ink from the nozzle N is determined such that the difference between the electrical potential of the contraction element, which is a waveform element for ejecting ink, at the start time of the contraction element and the electrical potential of the contraction element at the end time of the contraction element is greater than the difference between the electrical potential of the waveform element PA3 of the pulse PA at the start time of the waveform element PA3 and the electrical potential of the waveform element PA3 of the pulse PA at the end time of the waveform element PA3. The pulse for ejecting ink from the nozzle N is not limited to the pull-push waveform. For example, the pulse for ejecting ink from the nozzle N may have a pull-push-pull waveform.

Each waveform element of the pulse for ejecting ink from the nozzle N is determined such that a predetermined amount of ink is ejected from the ejection section D[j] when the individual drive signal Vin[j] having the pulse is supplied to the ejection section D[j]. In the present embodiment, it is assumed that the volume of the cavity CV included in the ejection section D[j] when the electrical potential of the individual drive signal Vin[j] is a high electrical potential is smaller than that when the electrical potential of the individual drive signal Vin[j] is a low electrical potential. Therefore, when the ejection section D[j] is driven by the individual drive signal Vin[j] having the pulse for ejecting ink, the ink in the ejection section D[j] is ejected from the nozzle N by the waveform element in which the electrical potential of the individual drive signal Vin[j] changes from the low electrical potential to the high electrical potential.

For example, each waveform element of the pulse for ejecting ink from the nozzle N is determined based on the characteristics of the ejection of ink from the ejection section D. The characteristics of the ejection of ink are, for example, an amount of ink to be ejected as an ink droplet, the speed at which the ink droplet is ejected, and the like. The speed at which the ink droplet is ejected varies depending on, for example, the viscosity of the ink. For example, the speed at which an ink droplet thickened and having viscosity higher than predetermined viscosity is ejected is lower than the speed at which an ink droplet having viscosity lower than or equal to the predetermined viscosity is ejected. In the present embodiment, it is possible to determine the thickened state of the ink in the ejection section D based on the amplitude Vamp indicated by the amplitude information NVamp.

In the present embodiment, since it is assumed that the pulse PA does not cause the ink to be ejected from the nozzle N, it is possible to execute the ejection state determination process even in a state where the head unit 3 is not positioned above the discharged ink receiving portion 80. For example, in printing executed for each pass while the head unit 3 is moved along the X-axis direction, the ejection state determination process may be executed between passes. The ejection state determination process may be executed between a print job based on certain print data IMG and a print job based on other print data IMG. Alternatively, the ejection state determination process may be executed when the maintenance process is to be executed.

The operation of the ink jet printer 1 is not limited to the example illustrated in FIG. 8. For example, the pulse PA may be a pulse for ejecting ink from the nozzle N. In this case, the drive signal COM including the pulse PA may be used in both the printing process and the ejection state determination process. However, in a case where the pulse PA used in the ejection state determination process causes ink to be ejected from the nozzle N, it is preferable that the ejection state determination process be executed, for example, in a state where the head unit 3 is positioned above the discharged ink receiving portion 80.

For example, when the ejection state determination process is to be executed, the control unit 2 may output a period defining signal Tsig having only the pulse PlsT1 out of the pulse PlsT2 and the pulse PlsT1. In this case, for example, the drive controller 22 of the control unit 2 may set the pulse detection period signal Pcut to a high level at the start or end of the pulse PlsT1 and set the pulse detection period signal Pcut to a low level at the start of the next pulse PlsL so as to satisfy the above-described transition timings.

For example, although the case where the one drive signal COM is used is described with reference to FIG. 8, but the present disclosure is not limited to such an aspect. For example, a plurality of drive signals COM including a drive signal COM that does not cause ink to be ejected from the nozzle N and a drive signal COM that causes ink to be ejected from the nozzle N may be used. In this case, in the printing process, the pulse PA that does not cause ink to be ejected may be used in order to prevent the thickening of the ink. The drive signal COM that causes the ink to be ejected from the nozzle N may have a plurality of pulses that cause ink for forming dots having different sizes to be ejected from the nozzle N.

Next, the signals supplied to the signal generator 60 and the signals generated by the signal generator 60 will be described with reference to FIG. 9.

FIG. 9 is a timing chart illustrating an example of an operation of the signal generator 60. In FIG. 9, the comparison signals CCP in the first inspection mode are indicated by solid lines, and the comparison signals CCP in the second inspection mode are indicated by broken lines. With reference to FIG. 9, the comparison signals CCP and the like will be described focusing on a case where the inspection mode is the first inspection mode.

Time t0 in FIG. 9 indicates a timing at which the supply of the residual vibration signal VD to the signal generator 60 is started. The timing at which the supply of the residual vibration signal VD to the signal generator 60 is started is, for example, the timing at which the coupling state specifying signal Qs[j] illustrated in FIG. 8 transitions from a low level to a high level. In the first inspection mode, the coupling state specifying signal Qs[j] transitions from a high level to a low level at a timing between time t15 and time t16, for example. However, in FIG. 9, in order to make the description easy to understand, the comparison signals CCP and the like will be described assuming that the coupling state specifying signal Qs[j] is maintained at a high level from time t0 to time t45 regardless of the inspection mode.

In FIG. 9, it is assumed that the electrical potential of the residual vibration signal VD at time to is lower than the threshold electrical potential VthC corresponding to the electrical potential of the amplitude center level of the residual vibration signal VD, and that the first peak PK1 of the residual vibration signal VD is a peak at which the electrical potential of the residual vibration signal VD is a local maximum value. Therefore, in the example illustrated in FIG. 9, the second peak PK2 of the residual vibration signal VD is a peak at which the electrical potential of the residual vibration signal VD is a local minimum value, and the third peak PK3 of the residual vibration signal VD is a peak at which the electrical potential of the residual vibration signal VD is a local maximum value. Hereinafter, the peaks PK1, PK2, and PK3 of the residual vibration signal VD and a peak of the residual vibration signal VD other than the peaks PK1, PK2, and PK3 may be collectively referred to as peaks PK.

For example, the electrical potential of the residual vibration signal VD increases over time in a period of time from time t0 to time t15, and decreases over time in a period from time t15 to time t25. Then, the electrical potential of the residual vibration signal VD increases over time in a period of time from time t25 to time t35, and decreases over time in a period of time from time t35 to time t45.

First, the comparison signals CPc, CP1, and CP2 will be described assuming that the coupling state specifying signal Qs[j] is maintained at a high level from time t0 to time t45.

For example, at time t10 after time to, the electrical potential of the residual vibration signal VD reaches the threshold electrical potential VthC. Therefore, the comparing circuit 620 changes the comparison signal CPC from a low level to a high level at time t10. Hereinafter, a timing at which the comparison signal CPc transitions from a low level to a high level may be referred to as a timing tsc. For example, in FIG. 9, time t10 corresponds to the timing tsc.

At time t12 after time t10, the electrical potential of the residual vibration signal VD reaches the threshold electrical potential Vth2 higher than the threshold electrical potential VthC. Therefore, the comparing circuit 622 changes the comparison signal CP2 from a low level to a high level at time t12. Hereinafter, a timing at which the comparison signal CP2 transitions from a low level to a high level may be referred to as a timing ts2. For example, in FIG. 9, time t12 corresponds to the timing ts2. Hereinafter, the timings tsc and ts2 and a timing ts1 described below may be collectively referred to as timings ts.

At time t14 after time t12, the electrical potential of the residual vibration signal VD reaches the threshold electrical potential Vth1 higher than the threshold electrical potential Vth2. Therefore, the comparing circuit 621 changes the comparison signal CP1 from a low level to a high level at time t14. Hereinafter, a timing at which the comparison signal CP1 transitions from a low level to a high level may be referred to as the timing ts1. For example, in FIG. 9, time t14 corresponds to the timing ts1.

At time t15 after time t14, the electrical potential of the residual vibration signal VD reaches the peak from the threshold electrical potential Vth1. Therefore, the electrical potential of the residual vibration signal VD starts to decrease from time t15.

Then, at time t16 after time t15, the electrical potential of the residual vibration signal VD reaches the threshold electrical potential Vth1. Therefore, the comparing circuit 621 changes the comparison signal CP1 from a high level to a low level at time t16.

At time t18 after time t16, the electrical potential of the residual vibration signal VD reaches the threshold electrical potential Vth2. Therefore, the comparing circuit 622 changes the comparison signal CP2 from a high level to a low level at time t18.

At time t20 after time t18, the electrical potential of the residual vibration signal VD reaches the threshold electrical potential VthC. Therefore, the comparing circuit 620 changes the comparison signal CPC from a high level to a low level at time t20.

As described above, the comparison signal CPc indicating whether the residual vibration signal VD is at an electrical potential higher than or equal to the threshold electrical potential VthC is generated by the comparing circuit 620, the comparison signal CP1 indicating whether the residual vibration signal VD is at an electrical potential higher than or equal to the threshold electrical potential Vth1 is generated by the comparing circuit 621, and the comparison signal CP2 indicating whether the residual vibration signal VD is at an electrical potential higher than or equal to the threshold electrical potential Vth2 is generated by the comparing circuit 622.

Next, the comparison signals CCPc, CCP1, and CCP2 will be described.

The comparison signals CCP are obtained by resetting the comparison signals CP to a low level at the reset timing tep defined by the pulse detection period signal Pcut. In the first inspection mode, the reset timing tep at which the pulse detection period signal Pcut transitions from a high level to a low level is preferably earlier than the timing at which the comparison signal CCP1 transitions from a high level to a low level. In the example illustrated in FIG. 9, the pulse detection period signal Pcut transitions from a high level to a low level at time t15 corresponding to the timing of the first peak PK1 of the residual vibration signal VD. Therefore, in the example illustrated in FIG. 9, time t15 corresponds to the reset timing tep.

For example, the comparison signal CCPc transitions from a low level to a high level at the timing tsc at which the comparison signal CPC transitions from a low level to a high level, and transitions from a high level to a low level at the reset timing tep at which the pulse detection period signal Pcut transitions from a high level to a low level. Therefore, the period WCc of time when the comparison signal CCPc is at a high level is from the timing tsc to the reset timing tep, and the time length TCc of the period WCc of time corresponds to a period of time elapsed from the timing tsc to the reset timing tep.

For example, the comparison signal CCP2 transitions from a low level to a high level at the timing ts2 at which the comparison signal CP2 transitions from a low level to a high level, and transitions from a high level to a low level at the reset timing tep. Therefore, the period WC2 of time when the comparison signal CCP2 is at a high level is from the timing ts2 to the reset timing tep, and the time length TC2 of the period WC2 of time corresponds to a period of time elapsed from the timing ts2 to the reset timing tep.

For example, the comparison signal CCP1 transitions from a low level to a high level at the timing ts1 at which the comparison signal CP1 transitions from a low level to a high level, and transitions from a high level to a low level at the reset timing tep. Therefore, the period WC1 of time when the comparison signal CCP1 is at a high level is from the timing ts1 to the reset timing tep, and the time length TC1 of the period WC1 of time corresponds to a period of time elapsed from the timing ts1 to the reset timing tep.

As described above, in the first inspection mode, the comparison signals CCPc, CCP1, and CCP2 that correspond to a first portion signal that is included in the residual vibration signal VD and is in a first period TPP1 of time from time t10 to time t15 are generated. In the example illustrated in FIG. 9, a portion that is included in the residual vibration signal VD and is in the period of time from time t10 to time t15 corresponds to the first portion signal. It is preferable that the first period TPP1 of time be started before a first time elapses after the residual vibration signal VD is input to the signal generator 60. The first time is, for example, shorter than a period of time corresponding to one fourth of the period of the residual vibration signal VD. In this case, it is possible to suppress an increase in an inspection period. For example, it is possible to suppress an increase in a standby period from the input of the residual vibration signal VD to the signal generator 60 to the start of the generation of the comparison signals CCP. The comparison signals CCPc, CCP1, and CCP2 indicated by the solid lines in FIG. 9 are examples of the “state inspection signal” and a “first inspection mode signal”.

The amplitude Vamp corresponding to the amplitude VPK of the peak PK1 of the residual vibration signal VD is calculated according to Equation (1) or Equation (2) by approximating the waveform of the residual vibration signal

VD to a sine wave, as described with reference to FIG. 7. For example, when a period of time elapsed from time t10 is “t”, the angular velocity of the sine wave is “ω”, and the difference between the electrical potential of the residual vibration signal VD at time t and the threshold electrical potential VthC is “VE”, the difference VE between the electrical potentials is expressed by Equation (3) using the amplitude VPK. In the following expressions, “·” indicating multiplication is used as appropriate.

$$VE = VPK \cdot sin ( ω t ) \qquad ( 3 )$$

Since the time length TCc of the period WCc of time when the comparison signal CCPc is at a high level corresponds to one fourth of the period of the residual vibration signal VD, the angular velocity @ is expressed by Equation (4) using the time length TCc.

$$ω = \prod / ( 2 \cdot TCc ) \qquad ( 4 )$$

A period of time elapsed from time t10 to time t14 is represented by an expression “TCc−TC1” obtained by subtracting the time length TC1 from the time length TCc, and a period of time elapsed from time t10 to time t12 is represented by an expression “TCc-TC2” obtained by subtracting the time length TC2 from the time length TCc.

Therefore, the difference VE1 between the electrical potential of the residual vibration signal VD at time t14 and the threshold electrical potential VthC is expressed by Equation (5) using the time lengths TCc and TC1. The difference VE2 between the electrical potential of the residual vibration signal VD at time t12 and the threshold electrical potential VthC is expressed by Equation (6) using the time lengths TCc and TC2.

$$VE 1 = VPK \cdot sin ( TCc - TC 1 ) / ( 2 \cdot TCc ) ) \qquad ( 5 )$$

$$VE 2 = VPK \cdot sin ( TCc - TC 2 ) / ( 2 \cdot TCc ) ) \qquad ( 6 )$$

The amplitude VPK is expressed by Equation (7) obtained by transforming Equation (5). Alternatively, the amplitude VPK is expressed by Equation (8) by transforming Equation (6).

$$VPK = VE 1 / ( sin ( ( π / 2 ) \cdot ( 1 - TC 1 / TCc ) ) ) \qquad ( 7 )$$

$$VPK = VE 2 / ( sin ( ( π / 2 ) \cdot ( 1 - TC 2 / TCc ) ) ) \qquad ( 8 )$$

Since the electrical potential of the residual vibration signal VD at time t14 is equal to the threshold electrical potential Vth1, the difference VE1 between the electrical potentials is a value obtained by subtracting the threshold electrical potential VthC from the threshold electrical potential Vth1. Therefore, an expression “Vth1−VthC” obtained by subtracting the threshold electrical potential VthC from the threshold electrical potential Vth1 is substituted into the difference VE1 between the electrical potentials in Equation (7), and the amplitude Vamp is substituted into the amplitude VPK in Equation (7), whereby Equation (1) described with reference to FIG. 7 is obtained. Since the electrical potential of the residual vibration signal VD at time t12 is equal to the threshold electrical potential Vth2, the difference VE2 between the electrical potentials is a value obtained by subtracting the threshold electrical potential VthC from the threshold electrical potential Vth2. Therefore, an expression “Vth2−VthC” obtained by subtracting the threshold electrical potential VthC from the threshold electrical potential Vth2 is substituted into the difference VE2 between the electrical potentials in Equation (8), and the amplitude Vamp is substituted into the amplitude VPK in Equation (8), whereby Equation (2) described with reference to FIG. 7 is obtained.

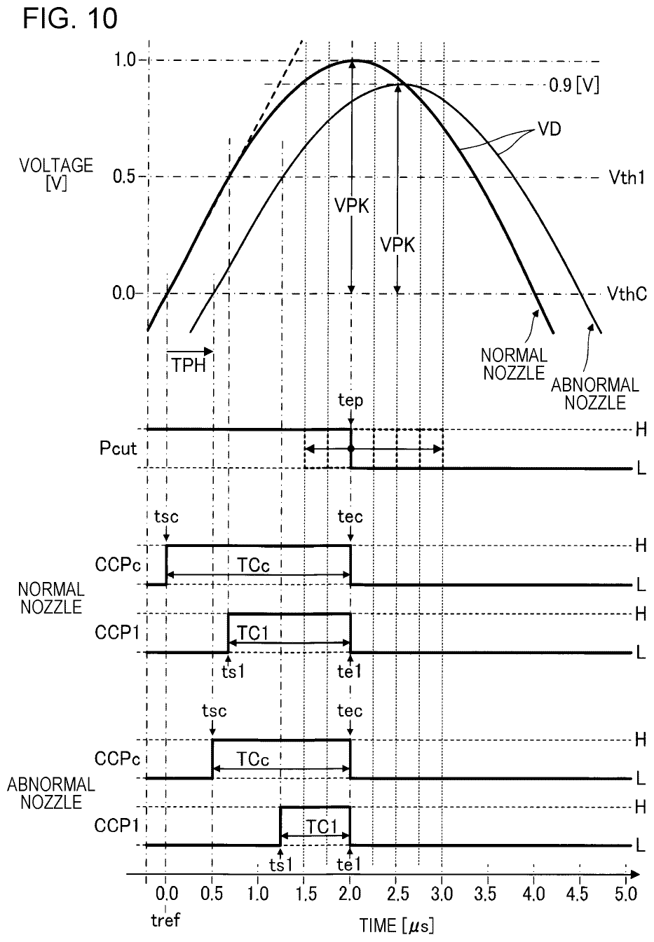

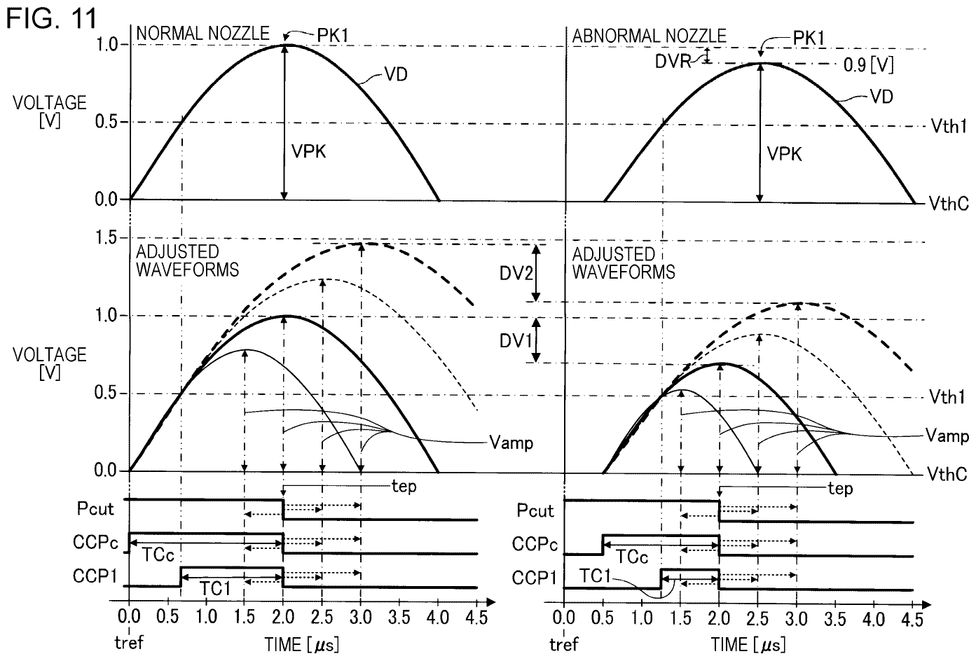

The amplitude Vamp calculated from Equation (1) is adjusted by adjusting at least one of the difference between the threshold electrical potential VthC and the threshold electrical potential Vth1 and a time ratio that is a ratio of the time length TC1 to the time length TCc, which will be described in detail with reference to FIG. 10 and the subsequent drawings. By adjusting the amplitude Vamp calculated from Equation (1), it is possible to adjust the difference between the amplitude Vamp calculated from Equation (1) for the ejection section D in a normal state and the amplitude Vamp calculated from Equation (1) for the ejection section D in an abnormal state. Therefore, by adjusting the amplitude Vamp calculated from Equation (1), it is possible to adjust sensitivity for the determination of the state of the ejection section D. Similarly, by adjusting the amplitude Vamp calculated from Equation (2), it is possible to adjust the sensitivity for the determination of the state of the ejection section D. In the present embodiment, the sensitivity for the determination of the state of the ejection section D may be adjusted by adjusting the amplitude Vamp calculated from Equation (1), and the sensitivity for the determination of the state of the ejection section D may be adjusted by adjusting the amplitude Vamp calculated from Equation (2).

Next, the comparison signals CCP and the like in the second inspection mode will be briefly described. In the second inspection mode, instead of the amplitude of the peak PK1 of the residual vibration signal VD, the amplitude of the peak PK3 of the residual vibration signal VD is used for the determination of the state of the ejection section D. Therefore, for example, the comparison signals CP from time t0 to time t25 are not used for the determination of the state of the ejection section D. Therefore, in the second inspection mode, for example, the mask signal MSK is maintained at a high level from time t0 to time t25 as indicated by a broken line in FIG. 9, and transitions from a high level to a low level at time t25. The mask signal MSK is, for example, maintained at a low level from time t25 to time t45. In a period of time when the mask signal MSK is at a high level, that is, in a period of time from time t0 to time t25, the comparison signals CCP are maintained at a low level regardless of the level of the comparison signals CP. In the second inspection mode, for example, the pulse detection period signal Pcut is maintained at a high level until time t45 as indicated by a broken line in FIG. 9, and transitions from a high level to a low level at time t45. Therefore, in the second inspection mode, time t45 corresponds to the reset timing tep.

As described above, the electrical potential of the residual vibration signal VD increases over time in the period of time from time t25 to time t35, and decreases over time in the period of time from time t35 to time t45. For example, at time t30 after time t25, the electrical potential of the residual vibration signal VD reaches the threshold electrical potential VthC. Therefore, the comparing circuit 620 changes the comparison signal CPC from a low level to a high level at time t30.

At time t32 after time t30, the electrical potential of the residual vibration signal VD reaches the threshold electrical potential Vth2 higher than the threshold electrical potential VthC. Therefore, the comparing circuit 622 changes the comparison signal CP2 from a low level to a high level at time t32.

At time t34 after time t32, the electrical potential of the residual vibration signal VD reaches the threshold electrical potential Vth1 higher than the threshold electrical potential Vth2. Therefore, the comparing circuit 621 changes the comparison signal CP1 from a low level to a high level at time t34.

At time t35 after time t34, the electrical potential of the residual vibration signal VD reaches the peak from the threshold electrical potential Vth1. Therefore, the electrical potential of the residual vibration signal VD starts decreasing from time t35.

At time t36 after time t35, the electrical potential of the residual vibration signal VD reaches the threshold electrical potential Vth1. Therefore, the comparing circuit 621 changes the comparison signal CP1 from a high level to a low level at time t36.

At time t38 after time t36, the electrical potential of the residual vibration signal VD reaches the threshold electrical potential Vth2. Therefore, the comparing circuit 622 changes the comparison signal CP2 from a high level to a low level at time t38.

At time t40 after time t38, the electrical potential of the residual vibration signal VD reaches the threshold electrical potential VthC. Therefore, the comparing circuit 620 changes the comparison signal CPc from a high level to a low level at time t40.

In the second inspection mode, time t45 corresponding to the reset timing tep is later than time t40. Therefore, for example, the comparison signal CCPc generated based on the logical product of the signal obtained by inverting the mask signal MSK, the pulse detection period signal Pcut, and the comparison signal CPC is a signal similar to the comparison signal CPC as indicated by the broken line in FIG. 9. The comparison signal CCP1 generated based on the logical product of the signal obtained by inverting the mask signal MSK, the pulse detection period signal Pcut, and the comparison signal CP1 is a signal similar to the comparison signal CP1, as indicated by the broken line in FIG. 9. The comparison signal CCP2 generated based on the logical product of the signal obtained by inverting the mask signal MSK, the pulse detection period signal Pcut, and the comparison signal CP2 is a signal similar to the comparison signal CP2, as indicated by the broken line in FIG. 9.

Therefore, in the second inspection mode, a time length TOc of a period WOc of time when the comparison signal CPc is at a high level is equal to the time length TCc of the period WCc of time when the comparison signal CCPc is at a high level. Similarly, a time length TO1 of a period WO1 of time when the comparison signal CP1 is at a high level is equal to the time length TC1 of the period WC1 of time when the comparison signal CCP1 is at a high level. A time length TO2 of a period WO2 of time when the comparison signal CP2 is at a high level is equal to the time length TC2 of the period WC2 of time when the comparison signal CCP2 is at a high level. Also in the second inspection mode, the amplitude Vamp of the residual vibration signal VD is calculated by Equation (1) or Equation (2) described with reference to FIG. 7 by approximating the waveform of the residual vibration signal VD to a sine wave.

As described above, in the second inspection mode, the comparison signals CCPC, CCP1, and CCP2 corresponding to a second portion signal that is included in the residual vibration signal VD and is in a second period TPP2 of time from time t30 to time t40 are generated. Therefore, in the second inspection mode, it is possible to identify the period of the residual vibration signal VD based on the comparison signals CCPc. In this case, it is possible to determine a plurality of state abnormalities including the thickened state of the ink in the ejection section D based on the amplitude Vamp and the period of the residual vibration signal VD. In the example illustrated in FIG. 9, a portion that is included in the residual vibration signal VD and is in the period of time from time t30 to time t40 corresponds to the second portion signal. The comparison signals CCPc, CCP1, and CCP2 indicated by the broken lines in FIG. 9 are examples of the “state inspection signal” and a “second inspection mode signal”.

The second period TPP2 of time is later than the first period TPP1 of time and is longer than the first period TPP1 of time. Therefore, in the second inspection mode, even in a case where noise is superimposed on the residual vibration signal VD when the control period TSS1 is switched to the control period TSS2 as illustrated in FIG. 8, it is possible to suppress the effect of the noise in the determination of the state of the ejection section D. On the other hand, in the first inspection mode, the comparison signals CCPc, CCP1, and CCP2 to be used for the determination of the state of the ejection section D are generated according to the first portion signal that is included in the residual vibration signal VD and that is in the first period TPP1 of time shorter than the second period TPP2 of time. Therefore, in the first inspection mode, the unit period TU can be shortened as compared with that in the second inspection mode, and thus the inspection period can be shortened. For example, the first period TPP1 of time is shorter than or equal to one fourth of the period of the residual vibration signal VD, and the second period TPP2 of time is longer than or equal to half the period of the residual vibration signal VD. That is, in the second inspection mode, the amplitude Vamp is calculated using the comparison signals CCP in the second period TPP2 of time that is longer than or equal to half the period of the residual vibration signal VD, but in the first inspection mode, the amplitude Vamp is calculated using the comparison signals CCP in the first period TPP1 of time that is shorter than or equal to one fourth of the period of the residual vibration signal VD.

The comparison signals CCP may be generated by a method other than the method of calculating the logical products of the comparison signals CP corresponding to the comparison signals CCP, the signal obtained by inverting the mask signal MSK, and the pulse detection period signal Pcut.

For example, in the first inspection mode, the comparison signal CCPc may be generated by a latch circuit or the like that causes an output signal to transition from a low level to a high level when the comparison signal CPC transitions from a low level to a high level, and resets the output signal to a low level when the pulse detection period signal Pcut transitions from a high level to a low level. Similarly, the comparison signal CCP1 may be generated by a latch circuit or the like that causes an output signal to transition from a low level to a high level when the comparison signal CP1 transitions from a low level to a high level, and resets the output signal to a low level when the pulse detection period signal Pcut transitions from a high level to a low level. The comparison signal CCP2 may be generated by a latch circuit or the like that causes an output signal to transition from a low level to a high level when the comparison signal CP2 transitions from a low level to a high level, and resets the output signal to a low level when the pulse detection period signal Pcut transitions from a high level to a low level. As described above, in a mode in which the comparison signals CCP are generated by the latch circuits or the like, for example, the reset timing tep can be set to be later than the timing at which the comparison signal CP1 transitions from a high level to a low level. In the mode in which the comparison signals CCP are generated by the latch circuits or the like, for example, the blocking timing at which the signal path for the residual vibration signal VD from the ejection section D to the signal generator 60 is blocked can be set to be earlier than the reset timing tep.

For example, in the second inspection mode, the comparison signal CPc may be output as the comparison signal CCPc from the adjusting circuit 630 to the identifying circuit 670. Similarly, the comparison signal CP1 may be output as the comparison signal CCP1 from the adjusting circuit 631 to the identifying circuit 671, and the comparison signal CP2 may be output as the comparison signal CCP2 from the adjusting circuit 632 to the identifying circuit 672.

For example, the pulse detection period signal Pcut and the mask signal MSK may be generated by the coupling state specifying circuit 310 of the switching circuit 31. Specifically, the coupling state specifying circuit 310 may generate the pulse detection period signal Pcut and the mask signal MSK based on at least one of the print signal SI, the latch signal LAT, and the period defining signal Tsig.

For example, a signal corresponding to a logical product of the pulse detection period signal Pcut illustrated in FIG. 9 and the signal obtained by inverting the mask signal MSK may be used as a signal serving as both the pulse detection period signal Pcut and the mask signal MSK.

For example, in the second inspection mode, the amplitude of the peak PK2 of the residual vibration signal VD or the like may be used for the determination of the state of the ejection section D. In this case, the comparing circuits 620, 621, and 622, the pulse detection period signal Pcut, and the mask signal MSK may operate as follows.

For example, the comparing circuit 620 generates a comparison signal CPc that is at a high level when the electrical potential of the residual vibration signal VD is lower than or equal to the threshold electrical potential VthC, and is at a low level when the electrical potential of the residual vibration signal VD is higher than the threshold electrical potential VthC. The comparing circuit 621 generates a comparison signal CP1 that is at a high level when the electrical potential of the residual vibration signal VD is lower than or equal to a threshold electrical potential Vthm1, and is at a low level when the electrical potential of the residual vibration signal VD is higher than the threshold electrical potential Vthm1. The comparing circuit 622 generates a comparison signal CP2 that is at a high level when the electrical potential of the residual vibration signal VD is lower than or equal to a threshold electrical potential Vthm2, and is at a low level when the electrical potential of the residual vibration signal VD is higher than the threshold electrical potential Vthm2. The mask signal MSK is maintained at a high level from time t0 to time t15, and transitions from a high level to a low level at time t15. The mask signal MSK is, for example, maintained at a low level from time t25 to time t45. The pulse detection period signal Pcut is maintained at a high level until time t35, and transitions from a high level to a low level at time t35. The threshold electrical potential Vthm2 is lower than the threshold electrical potential VthC, and the threshold electrical potential Vthm1 is lower than the threshold electrical potential Vthm2.

For example, in the second inspection mode, the amplitude of the peak PK1 of the residual vibration signal VD or the like may be used for the determination of the state of the ejection section D. In this case, for example, the pulse detection period signal Pcut in the second inspection mode may be maintained at a high level until time t25, and may transition from a high level to a low level at time t25. In the second inspection mode, in a case where the amplitude of the peak PK1 of the residual vibration signal VD or the like is used for the determination of the state of the ejection section D, the mask signal MSK may be omitted.

In the first inspection mode, the time ratio that is the ratio of the time length TC1 to the time length TCc and a time ratio that is a ratio of the time length TC2 to the time length TCc may be adjusted by adjusting the reset timing tep. In this case, since the amplitude Vamp calculated from Equation (1) or the like is adjusted, the sensitivity for the determination of the state of the ejection section D is adjusted. That is, in the first inspection mode, the sensitivity for the determination of the state of the ejection section D may be adjusted by adjusting the reset timing tep.

Next, with reference to FIGS. 10 to 12, the adjustment of the sensitivity for the determination of the state of the ejection section D in the first inspection mode will be described. FIGS. 10 to 12 illustrate a case where the electrical potential of the residual vibration signal VD is compared with the threshold electrical potential Vth1. A case where the electrical potential of the residual vibration signal VD is compared with the threshold electrical potential Vth2 is also described with reference to FIGS. 10 to 12 by replacing elements related to the threshold electrical potential Vth1 with elements related to the threshold electrical potential Vth2.

FIG. 10 is a diagram for explaining a relationship between residual vibration signals VD, the reset timing tep, and comparison signals CCP. FIG. 10 illustrates the pulse detection period signal Pcut, a residual vibration signal VD of a normal nozzle, a comparison signal CCPc and a comparison signal CCP1 of the normal nozzle, a residual vibration signal VD of an abnormal nozzle, and a comparison signal CCPc and a comparison signal CCP1 of the abnormal nozzle. The normal nozzle indicates the ejection section D in a normal state, and the abnormal nozzle indicates the ejection section D in an abnormal state.

In a graph of the residual vibration signals VD in FIG. 10, the vertical axis indicates a voltage [V] in a case where the threshold electrical potential VthC is set as a reference, that is, the vertical axis indicates a difference in electrical potential from the threshold electrical potential VthC, and the horizontal axis indicates a period of time [μs] elapsed from a reference timing tref. The unit [μs] indicates microsecond. In FIG. 10, the reference timing tref is a timing at which the electrical potential of the residual vibration signal VD of the normal nozzle reaches the threshold electrical potential VthC from an electrical potential lower than the threshold electrical potential VthC. In FIG. 10, it is assumed that the difference between the threshold electrical potential VthC and the threshold electrical potential Vth1 is 0.5 V. In FIG. 10, it is assumed that the amplitude VPK of the residual vibration signal VD of the normal nozzle is 1.0 V, the amplitude VPK of the residual vibration signal VD of the abnormal nozzle is 0.9 V, and a time TPH corresponding to the difference between the phase of the residual vibration signal VD of the normal nozzle and the phase of the residual vibration signal VD of the abnormal nozzle is 0.5 μs. In FIG. 10, it is assumed that the period of the residual vibration signal VD of the normal nozzle and the period of the residual vibration signal VD of the abnormal nozzle are equal to each other, and that one fourth of each of the periods is 2.0 μs. A broken line illustrated in the graph of the residual vibration signals VD in FIG. 10 indicates an inclination of the residual vibration signal VD of the normal nozzle at the threshold electrical potential Vth1. In FIG. 10, it is assumed that the inclination of the residual vibration signal VD of the normal nozzle at the threshold electrical potential Vth1 is nearly equal to an inclination of the residual vibration signal VD of the abnormal nozzle at the threshold electrical potential Vth1.

FIG. 10 illustrates the comparison signals CCPC and the comparison signals CCP1 in a case where the reset timing tep at which the pulse detection period signal Pcut transitions from a high level to a low level is after 2.0 μs elapse from the reference timing tref. In FIG. 10, an example of the adjusted reset timing tep is indicated by dotted lines.

For the normal nozzle and the abnormal nozzle, timings tsc at which the comparison signals CCPc transition from a low level to a high level are not adjusted even when the reset timing tep is adjusted. On the other hand, timings at which the comparison signals CCPc transition from a high level to a low level are adjusted to the same timing as the reset timing tep by adjusting the reset timing tep for the normal nozzle and the abnormal nozzle. Therefore, for the normal nozzle and the abnormal nozzle, time lengths TCc of periods WCc of time when the comparison signals CCPc are at a high level are adjusted by adjusting the reset timing tep.

For the normal nozzle and the abnormal nozzle, timings ts1 at which the comparison signals CCP1 transition from a low level to a high level are not adjusted even when the reset timing tep is adjusted. On the other hand, for the normal nozzle and the abnormal nozzle, timings at which the comparison signals CCP1 transition from a high level to a low level are adjusted to the same timing as the reset timing tep by adjusting the reset timing tep. Therefore, for the normal nozzle and the abnormal nozzle, time lengths TC1 of periods WC1 of time when the comparison signals CCP1 are at a high level are adjusted by adjusting the reset timing tep.

Next, a relationship between the adjustment of the reset timing tep and the amplitude Vamp calculated based on the time lengths TCc and TC1 adjusted by using the reset timing tep will be described with reference to FIG. 11.

FIG. 11 is a diagram for explaining the relationship between the reset timing tep and the amplitude Vamp calculated based on the time lengths TCc and TC1. Each of adjusted waveforms illustrated in FIG. 11 indicates a sine wave having an amplitude Vamp calculated from Equation (1) described with reference to FIG. 7 using the time lengths TCc and TC1 adjusted by using the reset timing tep. That is, each of the adjusted waveforms is a virtual waveform in which a residual vibration signal VD is treated to have an amplitude Vamp calculated based on the time lengths TCc and TC1, and is not necessarily the same waveform as that of the residual vibration signal VD actually output from the detecting circuit 33.

In a graph of the residual vibration signals VD and a graph of the adjusted waveforms in FIG. 11, the vertical axis indicates a voltage [V] in a case where the threshold electrical potential VthC is set as a reference, that is, the vertical axis indicates a difference in electrical potential from the threshold electrical potential VthC, and the horizontal axis indicates a period of time [μs] elapsed from the reference timing tref. In FIG. 11, the reference timing tref is a timing at which the electrical potential of the residual vibration signal VD of the normal nozzle reaches the threshold electrical potential VthC from an electrical potential lower than the threshold electrical potential VthC, and the difference between the threshold electrical potential VthC and the threshold electrical potential Vth1 is 0.5 V.

The residual vibration signal VD of the normal nozzle and the residual vibration signal VD of the abnormal nozzle illustrated in FIG. 11 are the same as or similar to the residual vibration signal VD of the normal nozzle and the residual vibration signal VD of the abnormal nozzle described with reference to FIG. 10, respectively. For example, the amplitude VPK of the residual vibration signal VD of the normal nozzle is 1.0 V, and the amplitude VPK of the residual vibration signal VD of the abnormal nozzle is 0.9 V. The time TPH corresponding to the difference between the phase of the residual vibration signal VD of the normal nozzle and the phase of the residual vibration signal VD of the abnormal nozzle is 0.5 μs. A period of time that is one fourth of each of the period of the residual vibration signal VD of the normal nozzle and the period of the residual vibration signal VD of the abnormal nozzle is 2.0 μs. Therefore, the electrical potential of the residual vibration signal VD of the normal nozzle reaches a peak PK1 at a timing at which 2.0 μs elapse from the reference timing tref, and the electrical potential of the residual vibration signal VD of the abnormal nozzle reaches a peak PK1 at a timing at which 2.5 μs elapse from the reference timing tref.

Hereinafter, the timings at which the electrical potentials of the residual vibration signals VD reach the peaks PK1 may be referred to as peak timings of the residual vibration signals VD. In the example illustrated in FIG. 10, the peak timing of each of the residual vibration signals VD corresponds to a timing at which the period of time that is one fourth of the period of the residual vibration signal VD elapses from a timing at which the electrical potential of the residual vibration signal VD reaches the threshold electrical potential VthC from an electrical potential lower than the threshold electrical potential VthC.

FIG. 11 illustrates four adjusted waveforms corresponding to respective four reset timings tep for each of the normal nozzle and the abnormal nozzle. The four reset timings tep illustrated in FIG. 11 are timings at which 1.5 μs, 2.0 μs, 2.5 μs, and 3.0 μs elapse from the reference timing tref.

As illustrated in FIG. 11, for each of the normal nozzle and the abnormal nozzle, the amplitude Vamp of the adjusted waveform is greater in a case where a period of time from the reference timing tref to the reset timing tep is long than that in a case where the period of time from the reference timing tref to the reset timing tep is short.

For example, as described above, the peak timing of the residual vibration signal VD of the normal nozzle is the timing at which 2.0 μs elapse from the reference timing tref. Therefore, for the normal nozzle, in a case where the reset timing tep is a timing at which 2.0 μs elapse from the reference timing tref, the amplitude Vamp of the adjusted waveform is 1.0 V, and matches the amplitude VPK of the residual vibration signal VD. In a case where the reset timing tep is a timing at which 1.5 μs elapse from the reference timing tref, the amplitude Vamp of the adjusted waveform is approximately 0.8 V, and is less than the amplitude VPK of the residual vibration signal VD. In a case where the reset timing tep is a timing at which 2.5 μs elapse from the reference timing tref, the amplitude Vamp of the adjusted waveform is approximately 1.2 V, and is greater than the amplitude VPK of the residual vibration signal VD. In a case where the reset timing tep is a timing at which 3.0 μs elapse from the reference timing tref, the amplitude Vamp of the adjusted waveform is approximately 1.5 V, and is greater than the amplitude VPK of the residual vibration signal VD. The amplitude Vamp of the adjusted waveform in the case where the reset timing tep is the timing at which 3.0 μs elapse from the reference timing tref is greater than the amplitude Vamp of the adjusted waveform in the case where the reset timing tep is the timing at which 2.5 μs elapse from the reference timing tref.

For example, as described above, the peak timing of the residual vibration signal VD of the abnormal nozzle is the timing at which 2.5 μs elapse from the reference timing tref. Therefore, for the abnormal nozzle, in a case where the reset timing tep is a timing at which 2.5 μs elapse from the reference timing tref, the amplitude Vamp of the adjustment waveform is 0.9 V, and matches the amplitude VPK of the residual vibration signal VD. In a case where the reset timing tep is a timing at which 2.0 μs elapse from the reference timing tref, the amplitude Vamp of the adjusted waveform is approximately 0.7 V, and is less than the amplitude VPK of the residual vibration signal VD. In a case where the reset timing tep is a timing at which 1.5 μs elapse from the reference timing tref, the amplitude Vamp of the adjusted waveform is approximately 0.5 V, and is less than the amplitude VPK of the residual vibration signal VD. The amplitude Vamp of the adjusted waveform in the case where the reset timing tep is the timing at which 1.5 μs elapse from the reference timing tref is less than the amplitude Vamp of the adjusted waveform in the case where the reset timing tep is the timing at which 2.0 μs elapse from the reference timing tref. In a case where the reset timing tep is a timing at which 3.0 μs elapse from the reference timing tref, the amplitude Vamp of the adjusted waveform is approximately 1.1 V, and is greater than the amplitude VPK of the residual vibration signal VD.

The end of the period WCc of time when the comparison signal CCPc is at a high level and the end of the period WC1 of time when the comparison signal CCP1 is at a high level are fixed by the reset timing tep. Therefore, each of the amplitudes Vamp calculated based on the time lengths TCc and TC1 includes information of both a change in the amplitude VPK and a change in the phase. For example, each of the amplitudes Vamp of the adjusted waveforms of the abnormal nozzle includes information of both a change in the amplitude VPK and a change in the phase of the residual vibration signal VD of the abnormal nozzle with respect to the residual vibration signal VD of the normal nozzle. In the example illustrated in FIG. 11, the amplitude Vamp of the adjusted waveform of the abnormal nozzle in the case where the reset timing tep is the timing at which 2.0 μs elapse from the reference timing tref is less than the amplitude VPK of the residual vibration signal VD of the abnormal nozzle as described above. As described above, since a change in the difference in phase can be obtained as a change in the amplitude Vamp in the first inspection mode, a parameter for determining the state of the ejection section D can be set to one pattern of the amplitude Vamp of an adjusted waveform from two patterns of the amplitude VPK and the phase. Accordingly, it is possible to simplify the ejection state determination process in the first inspection mode.

In the first inspection mode, since each of the amplitudes Vamp of the adjusted waveforms of the abnormal nozzle includes information of both a change in the amplitude VPK and a change in the phase, it is possible to suppress a reduction in the accuracy of the determination as to whether the state of the ejection section D is normal. For example, even in a case where the difference DVR in amplitude or the difference in phase between the residual vibration signal VD of the normal nozzle and the residual vibration signal VD of the abnormal nozzle is small in the first inspection mode, it is possible to suppress a reduction in the accuracy of the determination as to whether the state of the ejection section D is normal.

Specifically, in the example illustrated in FIG. 11, the difference DVR in amplitude between the residual vibration signal VD of the normal nozzle and the residual vibration signal VD of the abnormal nozzle is 0.1 V. On the other hand, for example, in a case where the reset timing tep is the timing at which 2.0 μs elapse from the reference timing tref, the difference DV1 in amplitude between the adjusted waveform of the normal nozzle and the adjusted waveform of the abnormal nozzle is approximately 0.3 V and is greater than 0.1 V. That is, the difference DV1 in amplitude between the adjusted waveform of the normal nozzle and the adjusted waveform of the abnormal nozzle in the case where the reset timing tep is the timing at which 2.0 μs elapse from the reference timing tref is greater than the difference DVR in amplitude between the residual vibration signal VD of the normal nozzle and the residual vibration signal VD of the abnormal nozzle. In this case, it is possible to determine whether the state of the ejection section D is normal based on the difference DV1 in amplitude that is greater than the difference DVR in amplitude between the residual vibration signal VD of the normal nozzle and the residual vibration signal VD of the abnormal nozzle. Therefore, in the first inspection mode, it is possible to accurately determine whether the state of the ejection section D is normal, compared to a case where the state of the ejection section D is determined based on the difference DVR in amplitude between the residual vibration signal VD of the normal nozzle and the residual vibration signal VD of the abnormal nozzle. For example, the determining circuit 69 may determine that the state of the ejection section D is abnormal in a case where the amplitude Vamp calculated by the amplitude calculating circuit 68 is less than a threshold amplitude predetermined based on the amplitudes Vamp of the adjusted waveforms of the normal nozzle.

For example, in the case where the reset timing tep is the timing at which 3.0 μs elapse from the reference timing tref, the difference DV2 in amplitude between the adjusted waveform of the normal nozzle and the adjusted waveform of the abnormal nozzle is approximately 0.4 V, and is greater than 0.3 V. That is, the difference DV2 in amplitude is greater than the difference DV1 in amplitude. Hereinafter, the differences DV2 and DV1 in amplitude may be collectively referred to as differences DV in amplitude. Hereinafter, the difference in amplitude between each of the adjusted waveforms of the normal nozzle and a corresponding one of the adjusted waveforms of the abnormal nozzle may be referred to as a difference DV in amplitude.

In the example illustrated in FIG. 11, the difference in amplitude DV between the adjusted waveform of the normal nozzle and the adjusted waveform of the abnormal nozzle in a case where the period of time from the reference timing tref to the reset timing tep is long is greater than that in a case where the period of time from the reference timing tref to the reset timing tep is short.

In this way, in the first inspection mode, since sensitivity for detection of a change in the phase of the residual vibration signal VD can be adjusted by adjusting the reset timing tep, it is possible to set the sensitivity for the determination of the state of the ejection section D according to the use.

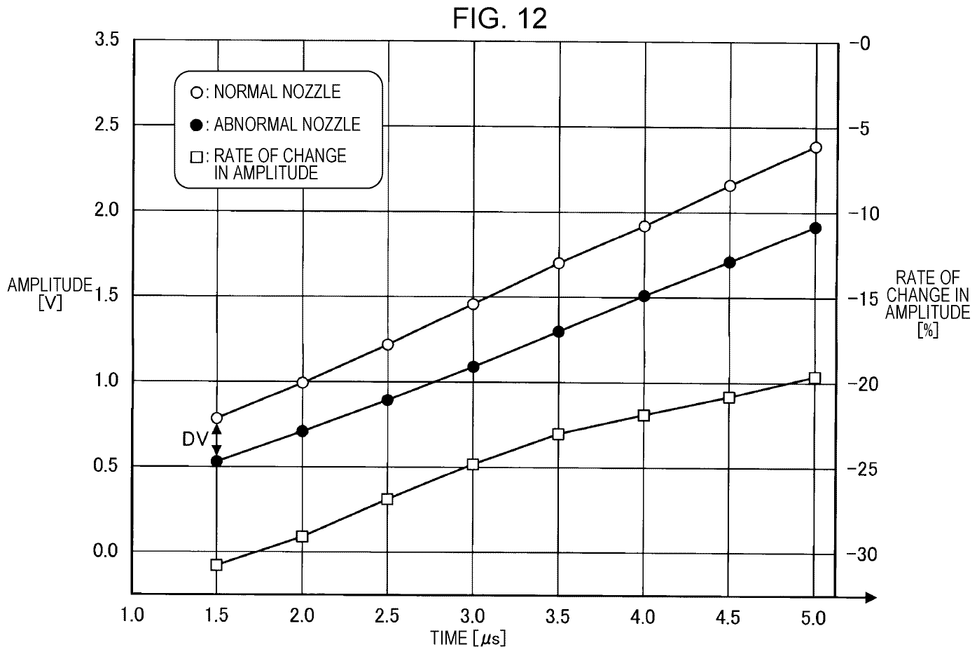

Next, a relationship between the reset timing tep, the amplitude Vamp, and the rate of change in the amplitude will be described with reference to FIG. 12.

FIG. 12 is a diagram for explaining the relationship between the reset timing tep, the amplitude Vamp, and the rate of change in the amplitude. In FIG. 12, one of the vertical axes indicates the voltage [V] of the amplitude Vamp in a case where the threshold electrical potential VthC is set as a reference, the other of the vertical axes indicates the rate [%] of change in the amplitude, and the horizontal axis indicates the time [μs] of the reset timing tep. The rate of change in the amplitude indicates a ratio [%] of the amplitude Vamp calculated for the abnormal nozzle to the amplitude Vamp calculated for the normal nozzle. The time of the reset timing tep indicates the period of time from the reference timing tref to the reset timing tep. Similarly to FIGS. 10 and 11, the reference timing tref is a timing at which the electrical potential of the residual vibration signal VD of the normal nozzle reaches the threshold electrical potential VthC from an electrical potential lower than the threshold electrical potential VthC. Hereinafter, the amplitude Vamp calculated for the normal nozzle may be referred to as the amplitude Vamp of the normal nozzle, and the amplitude Vamp calculated for the abnormal nozzle may be referred to as the amplitude Vamp of the abnormal nozzle.

FIG. 12 illustrates the amplitude Vamp and the rate of change in the amplitude in a case where the reset timing tep is adjusted for each of the residual vibration signal VD of the normal nozzle and the residual vibration signal VD of the abnormal nozzle illustrated in FIGS. 10 and 11. Each of white circles in FIG. 12 indicates the amplitude Vamp of the normal nozzle, each of black circles in FIG. 12 indicates the amplitude Vamp of the abnormal nozzle, and each of squares in FIG. 12 indicates the rate of change in the amplitude.

As illustrated in FIG. 12, each of the amplitude Vamp of the normal nozzle and the amplitude Vamp of the abnormal nozzle increases as the period of time from the reference timing tref to the reset timing tep is increased. The difference DV between the amplitude Vamp of the normal nozzle and the amplitude Vamp of the abnormal nozzle increases as the period of time from the reference timing tref to the reset timing tep is increased. In the example illustrated in FIG. 12, as the period of time from the reference timing tref to the reset timing tep is increased, the amplitude Vamp of the normal nozzle increases, and thus the absolute value of the rate of change in the amplitude that is the ratio of the amplitude Vamp of the abnormal nozzle to the amplitude Vamp of the normal nozzle decreases.

As described above, the amplitude Vamp and the like can be adjusted by adjusting the reset timing tep in the first inspection mode. Therefore, in the first inspection mode, by adjusting the reset timing tep, it is possible to adjust the sensitivity for the determination of the state of the ejection section D. For example, the difference DV between the amplitude Vamp of the normal nozzle and the amplitude Vamp of the abnormal nozzle in a case where the period of time from the reference timing tref to the reset timing tep is set to be long is greater than that in a case where the period of time from the reference timing tref to the reset timing tep is short. In a case where the difference DV between the amplitudes is large, the resolution is improved and thus it is possible to improve the accuracy of the determination as to whether the state of the ejection section D is normal, compared to a case where the difference DV between the amplitudes is small.

As described with reference to FIG. 11, for each of the normal nozzle and the abnormal nozzle, in a case where the reset timing tep matches the peak timing of the residual vibration signal VD, the amplitude Vamp matches the amplitude VPK of the residual vibration signal VD. Therefore, the sensitivity for the determination of the state of the ejection section D may be adjusted based on the case where the reset timing tep matches the peak timing of the residual vibration signal VD of the normal nozzle.

The reset timing tep may be adjusted for each nozzle N. In this aspect, for example, correction information for generating the pulse detection period signal Pcut that defines the reset timing tep corresponding to each nozzle N may be stored in the storage unit 5. In this aspect, for example, two ejection sections D having two nozzles N correspond to a “first ejection section” and a “second ejection section”. Among signals corresponding to an ejection section D that is the “first ejection section”, a comparison signal CPc corresponds to a “first reference signal”, each of comparison signals CP1 and CP2 corresponds to a “first inspection signal”, time information NTCc corresponds to “first reference signal information”, time information NTC1 and NTC2 correspond to “first inspection signal information”, and correction information corresponds to “first correction information”. Similarly, among signals corresponding to an ejection section D that is the “second ejection section”, a comparison signal CPc corresponds to a “second reference signal”, each of comparison signals CP1 and CP2 corresponds to a “second inspection signal”, time information NTCc corresponds to “second reference signal information”, time information NTC1 and NTC2 correspond to “second inspection signal information”, and correction information corresponds to “second correction information”.

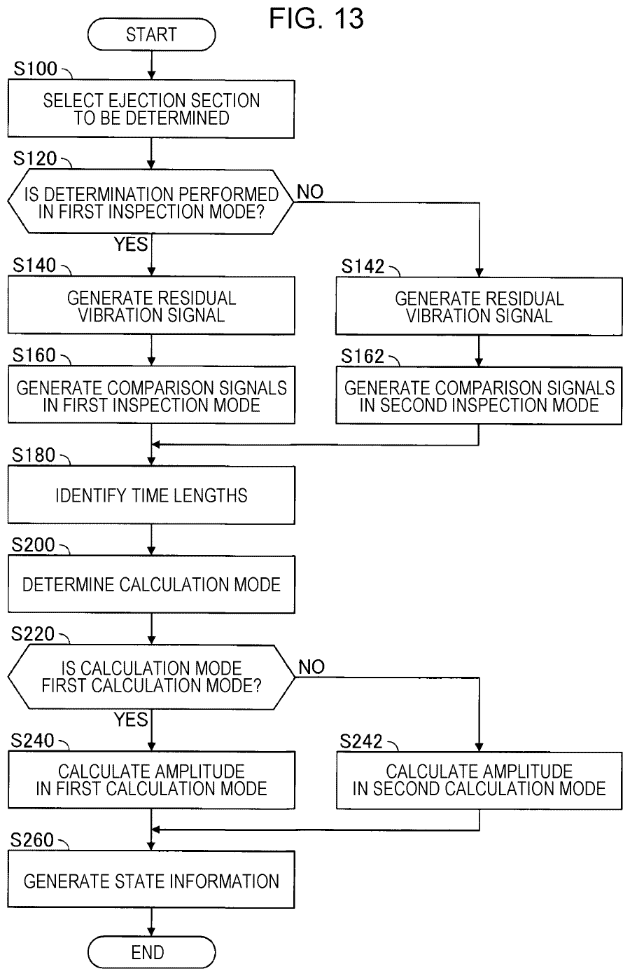

Next, an operation of the ink jet printer 1 to execute the ejection state determination process will be described with reference to FIG. 13.

FIG. 13 is a flowchart illustrating an example of the operation of the ink jet printer 1 to execute the ejection state determination process.

First, in step S100, the control unit 2 of the ink jet printer 1 functions as the drive controller 22 and selects an ejection section D to be determined from among the ejection sections D[1] to D[J]. In the following description, a case where the ejection section D[j] is selected as the ejection section D to be determined will be described as an example.

Next, in step S120, the control unit 2 functions as the drive controller 22 and determines whether the determination of the state of the ejection section D is performed in the first inspection mode. For example, the drive controller 22 may determine an inspection mode based on operation information indicating the content of an operation performed on the ink jet printer 1. Alternatively, the drive controller 22 may determine whether the determination of the state of the ejection section D is performed in the first inspection mode, based on the purpose of the determination of the state of the ejection section D and a situation in which the determination is performed. The purpose of the determination of the state of the ejection section D, the situation in which the determination is performed, and association with the inspection mode may be set in advance by the manufacturer or the like of the head unit 3. For example, the determination of the state of the ejection section D in the first inspection mode can shorten the inspection period compared to the second inspection mode, and thus is effective in a case where the state of the ejection section D is determined within a short time. Immediately after the start of the ink jet printer 1, there is a high possibility that ink in the cavity CV is in a stagnant state and that the ink is thickened. Therefore, after the ink jet printer 1 is started, the determination of the state of the ejection section D in the first inspection mode may be performed in preference to the determination of the state of the ejection section D in the second inspection mode. Therefore, the first inspection mode may be set in advance as the inspection mode after the start of the ink jet printer 1.

If the result of the determination in step S120 is affirmative, that is, in a case where the state of the ejection section D is determined in the first inspection mode, the drive controller 22 causes the process to proceed to step S140. On the other hand, if the result of the determination in step S120 is negative, that is, in a case where the state of the ejection section D is determined in the second inspection mode, the drive controller 22 causes the process to proceed to step S142.

In step S140, the ink jet printer 1 generates a residual vibration signal VD. Although not illustrated in FIG. 13, a step of generating the residual vibration signal VD includes, for example, a first step and a second step described below. In the first step included in the step of generating the residual vibration signal VD, the control unit 2 functions as the drive controller 22 and controls the switching circuit 31 of the head unit 3 so as to drive the ejection section D[j] as the ejection section D to be determined. Then, in the second step included in the step of generating the residual vibration signal VD, the detecting circuit 33 of the head unit 3 detects a detection signal Vout[j] indicating residual vibration generated in the ejection section D[j], and generates a residual vibration signal VD[j] based on the detection signal Vout[j].

Although not illustrated in FIG. 13, step 140 includes a step of supplying the pulse detection period signal Pcut and the mask signal MSK for the first inspection mode to the signal generator 60 of the inspection unit 6. For example, the drive controller 22 may supply the pulse detection period signal Pcut and the mask signal MSK for the first inspection mode to the signal generator 60 of the inspection unit 6. Alternatively, the drive controller 22 may control the switching circuit 31 of the head unit 3 so as to supply the pulse detection period signal Pcut and the mask signal MSK for the first inspection mode to the signal generator 60 of the inspection unit 6. After executing the processing in step S140, the ink jet printer 1 causes the process to proceed to step S160.

In step S160, the signal generator 60 of the inspection unit 6 generates comparison signals CCPc, CCP1, and CCP2 in the first inspection mode. Then, the inspection unit 6 causes the process to proceed to step S180.

If the result of the determination in step S120 is negative, the processing in step S142 is executed as described above. In step S142, the ink jet printer 1 operates in a similar manner to step S140 and generates a residual vibration signal VD. However, in step S142, the pulse detection period signal Pcut and the mask signal MSK for the second inspection mode are supplied to the signal generator 60 of the inspection unit 6 instead of the pulse detection period signal Pcut and the mask signal MSK for the first inspection mode. After executing the processing in step S142, the ink jet printer 1 causes the process to proceed to step S162.

In step S162, the signal generator 60 of the inspection unit 6 generates comparison signals CCPc, CCP1, and CCP2 in the second inspection mode. Then, the inspection unit 6 causes the process to proceed to step S180.

In step S180, the identifying section 67 included in the determining section 64 of the inspection unit 6 identifies the time length TCc of the comparison signal CCPc, the time length TC1 of the comparison signal CCP1, and the time length TC2 of the comparison signal CCP2.

Next, in step S200, the amplitude calculating circuit 68 included in the determining section 64 of the inspection unit 6 determines a calculation mode. Since the method of determining the calculation mode has been described with reference to FIG. 7, the description thereof will be omitted.

Next, in step S220, the amplitude calculating circuit 68 included in the determining section 64 determines whether the calculation mode determined in step S200 is the first calculation mode.

If the result of the determination in step S220 is affirmative, that is, in a case where the calculation mode is the first calculation mode, the amplitude calculating circuit 68 calculates the amplitude Vamp in the first calculation mode in step S240, and causes the process to proceed to step S260. For example, in step S240, the amplitude calculating circuit 68 calculates the amplitude Vamp based on the time lengths TCc and TC1.

On the other hand, if the result of the determination in step S220 is negative, that is, in a case where the calculation mode is the second calculation mode, the amplitude calculating circuit 68 calculates the amplitude Vamp in the second calculation mode in step S242, and causes the process to proceed to step S260. For example, in step S242, the amplitude calculating circuit 68 calculates the amplitude Vamp based on the time lengths TCc and TC2.

In step S260, the determining circuit 69 included in the determining section 64 determines the state of the ejection section D[j] based on the amplitude Vamp calculated in step S240 or step S242, and generates state information Cinf including information indicating the result of the determination. Then, the determining circuit 69 outputs the state information Cinf to the control unit 2 and ends the ejection state determination process.

The operation of the ink jet printer 1 to execute the ejection state determination process is not limited to the example illustrated in FIG. 13. For example, the determination in step S120 may be executed before the processing in step S100. For example, the determination in step S220 may be included in the processing in step S200. That is, the determination in step S220 and the processing in step S200 may not be strictly distinguished from each other. For example, the step of supplying the pulse detection period signal Pcut and the mask signal MSK for the first inspection mode to the signal generator 60 of the inspection unit 6 may be included in step 160. Similarly, the step of supplying the pulse detection period signal Pcut and the mask signal MSK for the second inspection mode to the signal generator 60 of the inspection unit 6 may be included in step 162.

As described above, in the present embodiment, the ink jet printer 1 includes the ejection section D capable of ejecting ink in accordance with a drive signal COM input to the ejection section D, the signal generator 60 to which a residual vibration signal VD corresponding to residual vibration generated in the ejection section D in response to the input of the drive signal COM is input, and that generates a comparison signal CCP based on the residual vibration signal VD, and the determining section 64 that determines a state of the ejection section D based on the comparison signal CCP. The signal generator 60 has the first inspection mode in which a first inspection mode signal corresponding to a first portion signal that is included in the residual vibration signal VD and is in a first period TPP1 of time is generated as a comparison signal CCP and a second inspection mode in which a second inspection mode signal corresponding to a second portion signal that is included in the residual vibration signal VD and is in a second period TPP2 of time is generated as the comparison signal CCP. The first period TPP1 of time is shorter than the second period TPP2 of time.

In the present embodiment, the signal generator 60 and the determining section 64 described above are included in the head unit control module HCM that controls the head unit 3 including the ejection section D capable of ejecting ink in accordance with the drive signal COM input to the ejection section D. In the present embodiment, the method of determining the state of the ejection section D corresponds to a liquid ejection inspection method.

As described above, in the present embodiment, the signal generator 60 has the first inspection mode and the second inspection mode as the inspection modes for determining the state of the ejection section D. In the first inspection mode, the state of the ejection section D is determined using the first portion signal that is included in the residual vibration signal VD and that is in the first period TPP1 of time shorter than the second period TPP2 of time. Therefore, in the present embodiment, by determining the state of the ejection section D in the first inspection mode, it is possible to shorten the inspection period for determining the state of the ejection section D. In the second inspection mode, the state of the ejection section D is determined using the second portion signal that is included in the residual vibration signal VD and that is in the second period TPP2 of time longer than the first period TPP1 of time. Therefore, in the second inspection mode, it is possible to identify a plurality of pieces of information, such as the period of the residual vibration signal VD, the accumulation of differences in phase, and the attenuation of the amplitude, based on the second portion signal included in the residual vibration signal VD. Therefore, in the present embodiment, it is possible to accurately determine the state of the ejection section D by determining the state of the ejection section D in the second inspection mode.

In the present embodiment, the first period TPP1 of time may be shorter than or equal to one fourth of a period of the residual vibration signal VD, and the second period TPP2 of time may be longer than or equal to half the period of the residual vibration signal VD. In this aspect, by determining the state of the ejection section D in the first inspection mode, it is possible to shorten the inspection period by one fourth or more of the period of the residual vibration signal VD, compared to a case where the state of the ejection section D is determined in the second inspection mode.

In the present embodiment, the second period TPP2 of time is later than the first period TPP1 of time. The signal generator 60 generates the second inspection mode signal without using the first portion signal included in the residual vibration signal VD in the second inspection mode. In this aspect, the first portion signal that is included in the residual vibration signal VD and is in the first period TPP1 of time before the second period TPP2 of time is not used for determining the state of the ejection section D. Therefore, in this aspect, even in a case where noise is superimposed on the residual vibration signal VD immediately after the residual vibration signal DV is input to the signal generator 60, the effect of the noise on the determination of the state of the ejection section D can be suppressed by determining the state of the ejection section D in the second inspection mode.

In the present embodiment, the first period TPP1 of time may be started before a first time elapses after the residual vibration signal VD is input to the signal generator 60. The first time is shorter than the period of time corresponding to one fourth of the period of the residual vibration signal VD. Therefore, in the first inspection mode, it is possible to suppress an increase in a period of time from when the residual vibration signal VD is input to the signal generator 60 to when the comparison signals CCP are generated. As a result, in this aspect, it is possible to shorten the inspection period for determining the state of the ejection section D by determining the state of the ejection section D in the first inspection mode.

In the present embodiment, the signal path for the residual vibration signal VD[j] from the ejection section D[j] to the signal generator 60 is blocked at the blocking timing based on the coupling state specifying signal Qs[j]. In the present embodiment, the determining section 64 may operate as follows. For example, the determining section 64 determines the state of the ejection section D based on a plurality of pieces of time information NTC generated by using the plurality of comparison signals CP as signals reset at the reset timing tep based on the pulse detection period signal Pcut. In a case where the blocking timing is earlier than the reset timing tep, each of the plurality of pieces of time information NTC is generated by using a corresponding one of the plurality of comparison signals CP as a signal whose electrical potential at the blocking timing is held until the reset timing tep. In this aspect, since it is possible to shorten a period of time for the residual vibration signal VD[j] to be input from the ejection section D[j] to the signal generator 60, it is possible to shorten the inspection period.

In the present embodiment, a reset timing tep may be set for each of the ejection sections D. In this aspect, for example, the state of each of the two ejection sections D is determined based on time information NTC generated using a pulse detection period signal Pcut defining a reset timing tep corresponding to the ejection section D, and the comparison signals CP. Accordingly, in the aspect, for example, even in a case where the detection of residual vibration signals VD varies for the plurality of ejection sections D, it is possible to accurately determine the state of each of the ejection sections D.

### Second Embodiment

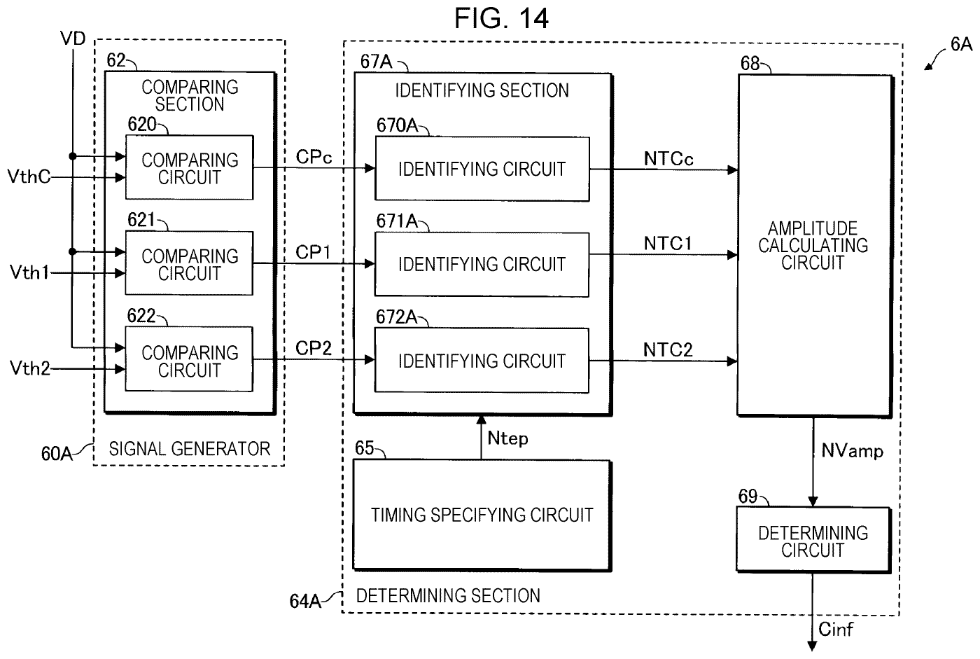

FIG. 14 is a block diagram illustrating an example of a configuration of an inspection unit 6A according to a second embodiment. The same elements as those described with reference to FIGS. 1 to 13 are denoted by the same reference signs, and detailed descriptions thereof will be omitted.

An ink jet printer 1 according to the present embodiment is the same as the ink jet printer 1 illustrated in FIG. 1 except that the ink jet printer 1 according to the present embodiment includes the inspection unit 6A instead of the inspection unit 6 illustrated in FIG. 1. In the present embodiment, it is assumed that reset information Ntep is used instead of the pulse detection period signal Pcut illustrated in FIG. 8 and the like. The reset information Ntep is an example of the “reset signal” and “timing information”. In the present embodiment, it is assumed that the determination of the state of the ejection section D in the second inspection mode described in the first embodiment is not executed. Therefore, in the present embodiment, the mask signal MSK illustrated in FIG. 8 and the like is not used. However, also in the present embodiment, the state of the ejection section D may be determined in the second inspection mode. The inspection unit 6A will be mainly described below.

The inspection unit 6A includes a signal generator 60A and a determining section 64A. The signal generator 60A has the same configuration as the signal generator 60 illustrated in FIG. 7 from which the adjusting section 63 is removed. For example, the signal generator 60A includes a comparing section 62 including comparing circuits 620, 621, and 622. The signal generator 60A outputs a comparison signal CPc generated by the comparing circuit 620, a comparison signal CP1 generated by the comparing circuit 621, and a comparison signal CP2 generated by the comparing circuit 622 to the determining section 64A.

The determining section 64A includes a timing specifying circuit 65, an identifying section 67A, an amplitude calculating circuit 68, and a determining circuit 69. The amplitude calculating circuit 68 and the determining circuit 69 are the same as the amplitude calculating circuit 68 and the determining circuit 69 illustrated in FIG. 7. For example, an amplitude Vamp of a residual vibration signal VD is calculated according to Equation (1) or Equation (2) described with reference to FIG. 7 by approximating a waveform of the residual vibration signal VD to a sine wave.

The timing specifying circuit 65 specifies a reset timing tep for the identifying section 67A by outputting the reset information Ntep indicating the reset timing tep to the identifying section 67A. For example, the timing specifying circuit 65 outputs, to the identifying section 67A, the reset information Ntep indicating a period of time from time to illustrated in FIG. 9, that is, the timing at which the supply of the residual vibration signal VD to the signal generator 60a is started, to the reset timing tep. The reset information Ntep is stored, for example, in the storage unit 5. Hereinafter, the timing at which the supply of the residual vibration signal VD to the signal generator 60A is started may be referred to as a measurement start timing. The measurement start timing is, for example, time to illustrated in FIG. 9, that is, the timing at which the coupling state specifying signal Qs[j] illustrated in FIG. 8 transitions from a low level to a high level.

For example, the identifying section 67A identifies time lengths TC from timings ts at which the comparison signals CPc, CP1, and CP2 transition from a low level to a high level to the reset timing tep. For example, the identifying section 67A includes identifying circuits 670A, 671A, and 672A to which the comparison signals CPC, CP1, and CP2 are supplied, respectively. The reset information Ntep is supplied to each of the identifying circuits 670A, 671A, and 672A.

For example, the identifying circuit 670A identifies the time length TCc from a timing tsc at which the comparison signal CPc transitions from a low level to a high level to the reset timing tep indicated by the reset information Ntep. Specifically, for example, the identifying circuit 670A measures a period of time from the measurement start timing to the timing tsc. Then, the identifying circuit 670A identifies, as the time length TCc, the difference between the period of time from the measurement start timing to the timing tsc and the period of time from the measurement start timing to the reset timing tep. The time length TCc identified by the identifying circuit 670A corresponds to, for example, the time length TCc of the period WCc of time when the comparison signal CCPC illustrated in FIG. 9 is at a high level. The identifying circuit 670A outputs, to the amplitude calculating circuit 68, time information NTCc indicating the time length TCc identified based on the comparison signal CPc and the reset information Ntep.

For example, the identifying circuit 671A identifies the time length TC1 from the timing ts1 at which the comparison signal CP1 transitions from a low level to a high level to the reset timing tep indicated by the reset information Ntep. For example, the identifying circuit 671A measures a period of time from the measurement start timing to the timing ts1. Then, the identifying circuit 671A identifies, as the time length TC1, the difference between the period of time from the measurement start timing to the timing ts1 and the period of time from the measurement start timing to the reset timing tep. The time length TC1 identified by the identifying circuit 671A corresponds to, for example, the time length TC1 of the period WC1 of time when the comparison signal CCP1 illustrated in FIG. 9 is at a high level. The identifying circuit 671A outputs, to the amplitude calculating circuit 68, time information NTC1 indicating the time length TC1 identified based on the comparison signal CP1 and the reset information Ntep.

For example, the identifying circuit 672A identifies the time length TC2 from the timing ts2 at which the comparison signal CP2 transitions from a low level to a high level to the reset timing tep indicated by the reset information Ntep. For example, the identifying circuit 672A measures a period of time from the measurement start timing to the timing ts2. Then, the identifying circuit 671A identifies, as the time length TC2, the difference between the period of time from the measurement start timing to the timing ts2 and the period of time from the measurement start timing to the reset timing tep. The time length TC2 identified by the identifying circuit 672A corresponds to, for example, the time length TC2 of the period WC2 of time when the comparison signal CCP2 illustrated in FIG. 9 is at a high level. The identifying circuit 672A outputs, to the amplitude calculating circuit 68, time information NTC2 indicating the time length TC2 identified based on the comparison signal CP2 and the reset information Ntep.

The time length TCc is expressed by Equation (9) using the timing tsc and the reset timing tep, and the time length TC1 is expressed by Equation (10) using the timing ts1 and the reset timing tep. The time length TC2 is expressed by Equation (11) using the timing ts2 and the reset timing tep.

$$TCc = tep - tsc \qquad ( 9 )$$

$$TC 1 = tep - ts 1 \qquad ( 10 )$$

$$TC 2 = tep - ts 2 \qquad ( 11 )$$

As described above, in the present embodiment, the time lengths TC can be identified without generating the comparison signals CCPc, CCP1, and CCP2 illustrated in FIG. 9.

The configuration of the inspection unit 6A is not limited to the example illustrated in FIG. 14. For example, the timing specifying circuit 65 may be included in the control unit 2.

For example, the timing specifying circuit 65 may supply, to the identifying circuits 670A, 671A, and 672A, an end point specifying signal that transitions from a high level to a low level at the reset timing tep and serves as the reset information Ntep. In this aspect, for example, the timing specifying circuit 65 measures a period of time elapsed from the measurement start timing, and changes the end point specifying signal from a high level to a low level when the result of the measurement matches the period of time from the measurement start timing to the reset timing tep. Then, for example, the identifying circuit 670A measures the period of time from the timing tsc at which the comparison signal CPc transitions from a low level to a high level to the reset timing tep at which the end point specifying signal transitions from a high level to a low level, and identifies the result of the measurement as the time length TCc. Similarly, the identifying circuit 671A measures the period of time from the timing ts1 to the reset timing tep, and identifies the result of the measurement as the time length TC1. The identifying circuit 672A measures the period of time from the timing ts2 to the reset timing tep, and identifies the result of the measurement as the time length TC2. In this aspect, the initial level of the end point specifying signal is not particularly limited, and may be a high level or a low level. However, in a case where the initial level of the end point specifying signal is a low level, the end point specifying signal transitions from a low level to a high level at a timing earlier than the reset timing tep.

For example, the timing specifying circuit 65 may supply, to the identifying circuits 670A, 671A, and 672A, an end point specifying signal that transitions from a low level to a high level at the reset timing tep and serves as the reset information Ntep.

Also in the present embodiment, the comparison signals CP may be generated based on a signal that is included in the residual vibration signal VD and that is in a first period TPP1 of time shorter than or equal to one fourth of the period of the residual vibration signal VD. The first period TPP1 of time is, for example, the first period TPP1 of time illustrated in FIG. 9. Also in the present embodiment, it is preferable that the first period TPP1 of time be started before a first time elapses after the residual vibration signal VD is input to the signal generator 60A. The first time is, for example, shorter than the period of time corresponding to one fourth of the period of the residual vibration signal VD.

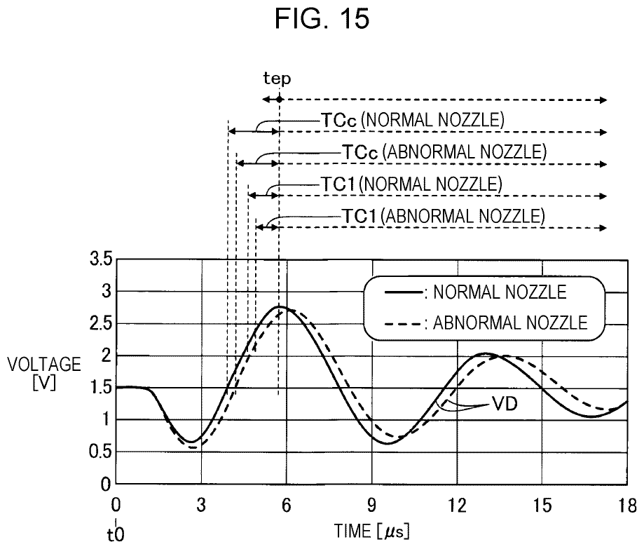

Next, an outline of the adjustment of the reset timing tep will be described with reference to FIG. 15.

FIG. 15 is a diagram for explaining the outline of the adjustment of the reset timing tep. In FIG. 15, the vertical axis indicates a voltage [V] of each of residual vibration signals VD in a case where a ground electrical potential is set as a reference, and the horizontal axis indicates a period of time elapsed from the measurement start timing, for example, the horizontal axis indicates a period of time [μs] elapsed from time to.

In the example illustrated in FIG. 15, the first peak PK of each of the residual vibration signals VD is a peak PK at which the electrical potential of the residual vibration signal VD is a local minimum value. Therefore, in FIG. 15, it is assumed that the electrical potential of each of the residual vibration signals VD in a range from a threshold electrical potential VthC to the second peak PK of the residual vibration signal VD is compared with the threshold electrical potential VthC, a threshold electrical potential Vth1, and the like. For example, in FIG. 15, the difference between the ground electrical potential and the threshold electrical potential VthC is 1.5 V, and the difference between the ground electrical potential and the threshold electrical potential Vth1 is 2.5 V.

The residual vibration signal VD indicated by a solid line in FIG. 15 indicates the residual vibration signal VD of a normal nozzle, and the residual vibration signal VD indicated by a broken line in FIG. 15 indicates the residual vibration signal VD of an abnormal nozzle that causes ink drop misdirection.

For example, in a case where paper dust adheres to a portion in the vicinity of the nozzle N, the surface of the ink in the nozzle N is sucked up in the ejection direction due to the paper dust, and thus an abnormality such as ink drop misdirection occurs. In this case, as illustrated in FIG. 15, the period of residual vibration, that is, the period of the residual vibration signal VD of the abnormal nozzle with the paper dust adhering to the portion in the vicinity of the nozzle N is slightly longer than that of the normal nozzle. In the example illustrated in FIG. 15, the residual vibration signal VD of the abnormal nozzle changes by approximately 4% in period and by approximately 9% in amplitude with respect to the residual vibration signal VD of the normal nozzle. As described above, in a case where the changes in the residual vibration signal VD of the abnormal nozzle with respect to the residual vibration signal VD of the normal nozzle are small, it is difficult to detect the abnormality of the ejection state by a method of simply identifying, from the residual vibration signals VD, the characteristics of the waveforms of the residual vibration signals VD. Therefore, in the present embodiment, by adjusting the reset timing tep, the accuracy of the determination as to whether the state of the ejection section D is normal is improved.

For example, by adjusting the reset timing tep, the time lengths TCc and TC1 are adjusted. As a result, since the time ratio that is the ratio of the time length TC1 to the time length TCc is adjusted, the amplitude Vamp calculated from Equation (1) described with reference to FIG. 7 is adjusted. In the present embodiment, for example, since it is not necessary to actually generate a pulse having a period of the time length TCc, such as the comparison signal CCPc illustrated in FIG. 9, it is possible to make the period of time from the measurement start timing to the reset timing tep longer than that in the first embodiment described above. Therefore, in the present embodiment, it is possible to increase an adjustment range in which the reset timing tep is adjusted. As a result, in the present embodiment, it is possible to easily adjust the accuracy of the determination as to whether the state of the ejection section D is normal.

For example, the reset timing tep is adjusted such that the period of time from a blocking timing to the reset timing tep is longer in a case where the accuracy of the inspection of the state of the ejection section D is set to be high than in a case where the accuracy of the inspection is low. For example, the reset timing tep is adjusted such that the period of time from the blocking timing to the reset timing tep is shorter in a case where an inspection period for the inspection of the state of the ejection section D is set to be short than in a case where the inspection period is long.

In the present embodiment, it is possible to set the blocking timing to be earlier than the reset timing tep. The blocking timing is a timing at which a signal path for the residual vibration signal VD[j] from the ejection section D[j] to be determined to the signal generator 60A is blocked. Therefore, in the present embodiment, for example, even in a case where the period of time from the measurement start timing to the reset timing tep is set to be long, it is possible to cause the ejection section D[j] to perform another operation at a timing later than the blocking timing regardless of the reset timing tep. Alternatively, in the present embodiment, regardless of the reset timing tep, the ejection section D other than the ejection section D[j] can be operated at the timing after the blocking timing as the ejection section D to be determined. In this way, in the present embodiment, even when the period of time from the measurement start timing to the reset timing tep is set to be long, it is possible to suppress an increase in the inspection period.

In the aspect in which the end point specifying signal that transitions from a high level to a low level at the reset timing tep is used as the reset information Ntep, the reset timing tep for the ejection section D to be determined is earlier than the measurement start timing for the ejection section D to be determined next. However, also in this aspect, since the blocking timing can be set to be earlier than the reset timing tep, it is possible to suppress an increase in the inspection period. For example, even in this aspect, after the blocking timing of the ejection section D to be determined, the drive signal COM can be supplied to the ejection section D to be determined next at a timing earlier than the reset timing tep for the ejection section D to be determined.

In FIG. 15, it is assumed that the electrical potential of the residual vibration signal VD in the range from the threshold electrical potential VthC to the second peak PK of the residual vibration signal VD is compared with the threshold electrical potentials VthC, Vth1, and the like, but the present disclosure is not limited to such an aspect. For example, regarding the residual vibration signal VD illustrated in FIG. 15, the electrical potential of the residual vibration signal VD in the range from the threshold electrical potential VthC to the first peak PK of the residual vibration signal VD may be compared with the threshold electrical potentials VthC, Vth1, and the like. In this case, for example, instead of comparing the electrical potential of the residual vibration signal VD with the threshold electrical potential Vth1, the electrical potential of the residual vibration signal VD is compared with a threshold electrical potential lower than the threshold electrical potential VthC, for example, the threshold electrical potential Vthm1 illustrated in FIG. 9. The method of generating the comparison signals CP based on the result of comparing the threshold electrical potential lower than the threshold electrical potential VthC with the electrical potential of the residual vibration signal VD is similar to the method using the threshold electrical potential Vthm1 described with reference to FIG. 9.

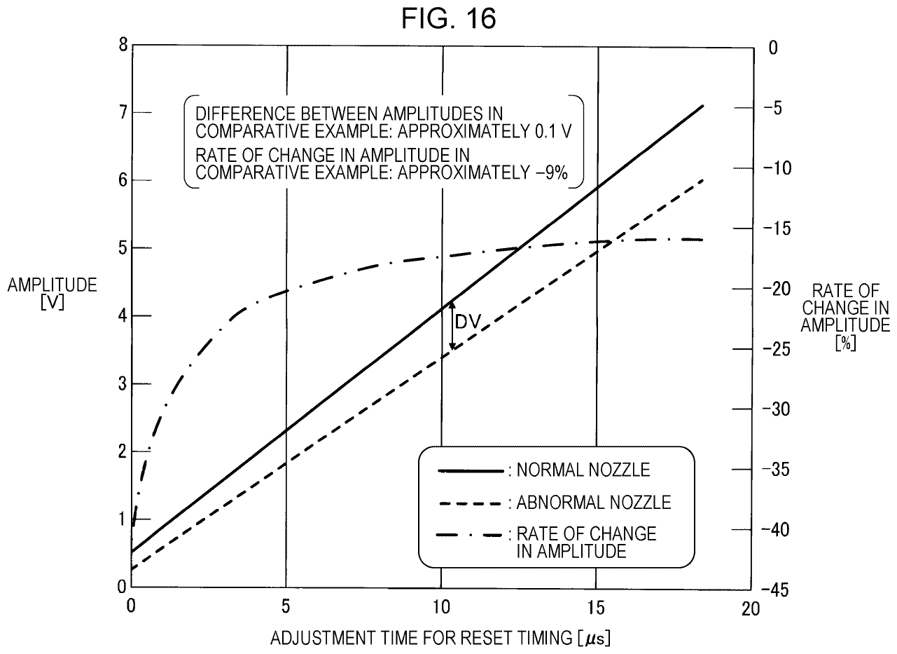

Next, a relationship between the reset timing tep, the amplitude Vamp, and the rate of change in the amplitude will be described with reference to FIG. 16.

FIG. 16 is a diagram for explaining the relationship between the reset timing tep, the amplitude Vamp, and the rate of change in the amplitude. In FIG. 16, one of the vertical axes indicates the voltage [V] of the amplitude Vamp in a case where the threshold electrical potential VthC is set as a reference, the other of the vertical axes indicates the rate [%] of change in the amplitude, and the horizontal axis indicates an adjustment time [μs] for the reset timing tep. The adjustment time for the reset timing tep indicates a time us from a lower limit value of the adjustment range in which the reset timing tep is adjusted. However, the adjustment range in which the reset timing tep is adjusted and the lower limit value of the adjustment range are introduced for convenience of description, and may not be actually set. Similarly to FIG. 12, the rate of change in the amplitude indicates a ratio [%] of the amplitude Vamp calculated for the abnormal nozzle to the amplitude Vamp calculated for the normal nozzle.

A solid line in FIG. 16 indicates the amplitude Vamp of the normal nozzle, a broken line in FIG. 16 indicates the amplitude Vamp of the abnormal nozzle that causes ink drop misdirection, and an alternate long and short dash line in FIG. 16 indicates the rate of change in the amplitude. FIG. 16 illustrates, in parentheses, numerical values of the difference in amplitude and the rate of change in the amplitude in a comparative example in which the amplitude Vamp of the residual vibration signal VD is calculated by the same method as that in the second inspection mode described in the first embodiment. For example, the difference between the amplitude Vamp of the normal nozzle and the amplitude Vamp of the abnormal nozzle calculated in the comparative example is approximately 0.1 V, and the rate of change in the amplitude in the comparative example is approximately-9%.

In the present embodiment, as illustrated in FIG. 16, for each of the normal nozzle and the abnormal nozzle, the amplitude Vamp increases as the adjustment time for the reset timing tep is increased. The difference DV between the amplitude Vamp of the normal nozzle and the amplitude Vamp of the abnormal nozzle increases as the adjustment time for the reset timing tep is increased. The difference between the amplitudes in the comparative example is approximately 0.1 V, whereas the difference DV between the amplitudes can be adjusted in a range from approximately 0.2 V to approximately 1.0 V in the example illustrated in FIG. 16. The absolute value of the rate of change in the amplitude that is the ratio of the amplitude Vamp of the abnormal nozzle to the amplitude Vamp of the normal nozzle decreases as the adjustment time for the reset timing tep is increased. The difference between the amplitudes in the comparative example is approximately-9%, whereas the rate of change in the amplitude can be adjusted in a range from approximately-16% to approximately-42% in the example illustrated in FIG. 16.

As described above, in the present embodiment, the amplitude Vamp and the like can be adjusted by adjusting the reset timing tep. For example, in a case where the difference DV between the amplitudes is large, the resolution is improved compared to a case where the difference DV between the amplitudes is small. Therefore, it is possible to increase the accuracy of the determination as to whether the state of the ejection section D is normal. Therefore, in the present embodiment, by adjusting the reset timing tep, it is possible to adjust the sensitivity for the determination of the state of the ejection section D. For example, in the present embodiment, by adjusting the reset timing tep, it is possible to increase the sensitivity for the detection of ink drop misdirection.

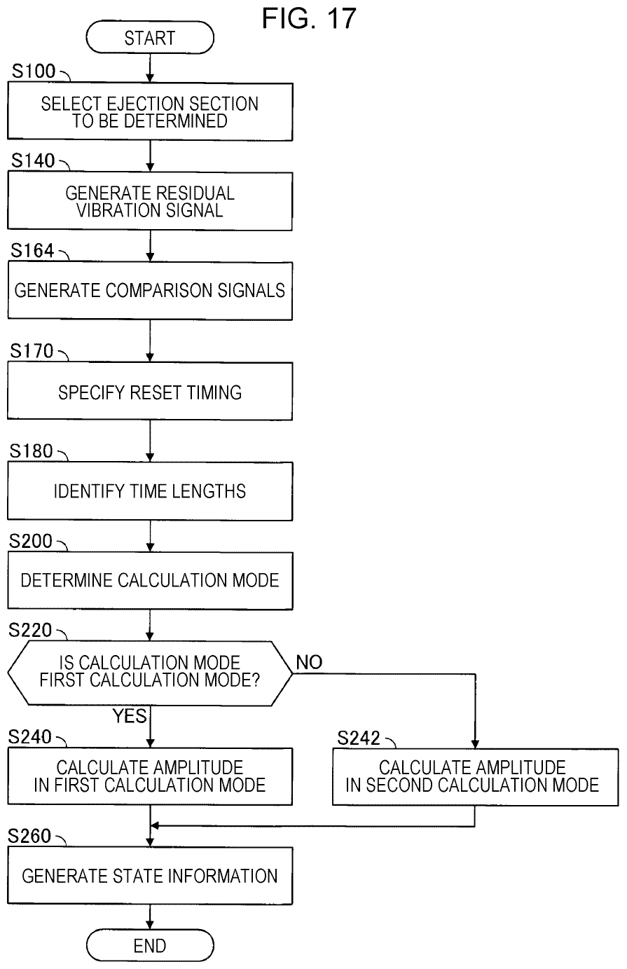

Next, an operation of the ink jet printer 1 to execute the ejection state determination process will be described with reference to FIG. 17.

FIG. 17 is a flowchart illustrating an example of the operation of the ink jet printer 1 to execute the ejection state determination process. The operation illustrated in FIG. 17 is the same as the operation illustrated in FIG. 13 except that the processing in steps S120, S142, and S162 illustrated in FIG. 13 is omitted from the operation illustrated in FIG. 13 and that processing in steps S164 and S170 is executed in the operation illustrated in FIG. 17. The processing in steps S164 and S170 will be mainly described with reference to FIG. 17.

The processing in step S164 is executed after the processing in step S140 is executed. For example, the ink jet printer 1 causes the process to proceed to step S164 after executing the processing in step S140.

In step S164, the signal generator 60A of the inspection unit 6A generates the comparison signals CPC, CP1, and CP2 by comparing the electrical potential of the residual vibration signal VD with each of the threshold electrical potentials VthC, Vth1, and Vth2. Then, the inspection unit 6A causes the process to proceed to step S170.

In step S170, the timing specifying circuit 65 included in the determining section 64A of the inspection unit 6A specifies the reset timing tep for the identifying section 67A by outputting the reset information Ntep indicating the reset timing tep to the identifying section 67A. Then, the inspection unit 6A causes the process to proceed to step S180.

In step S180, the identifying section 67A included in the determining section 64A of the inspection unit 6A identifies the time lengths TCc, TC1, and TC2 based on, for example, Equations (9), (10), and (11) described with reference to FIG. 14.

The operation of the ink jet printer 1 to execute the ejection state determination process is not limited to the example illustrated in FIG. 17. For example, the processing in step S170 may be executed before the processing in step S100 as long as the processing in step S170 is executed before the processing in step S180.

As described above, in the present embodiment, the ink jet printer 1 includes the ejection section D capable of ejecting ink in accordance with a drive signal COM input to the ejection section D, the signal generator 60A to which a residual vibration signal VD corresponding to residual vibration generated in the ejection section D in response to the input of the drive signal COM is input, and that generates a plurality of comparison signals CP based on the residual vibration signal VD, and the determining section 64A that determines a state of the ejection section D. The signal path for the residual vibration signal VD[j] from the ejection section D[j] to the signal generator 60A is blocked at a blocking timing based on a coupling state specifying signal Qs[j]. The determining section 64A determines the state of the ejection section D based on a plurality of pieces of time information NTC generated by using the plurality of comparison signals CP as signals reset at a reset timing tep based on reset information Ntep. In a case where the blocking timing is earlier than the reset timing tep, each of the plurality of pieces of time information NTC is generated by using a corresponding one of the plurality of comparison signals CP as a signal whose electrical potential at the blocking timing is held until the reset timing tep.

In the present embodiment, the signal generator 60A and the determining section 64A described above are included in the head unit control module HCM that controls the head unit 3 including the ejection section D capable of ejecting ink in accordance with the drive signal COM input to the ejection section D. In the present embodiment, the method of determining the state of the ejection section D corresponds to the liquid ejection inspection method.

As described above, in the present embodiment, the signal path for the residual vibration signal VD[j] from the ejection section D[j] to the signal generator 60A is blocked at the blocking timing. Iin the present embodiment, in a case where the blocking timing is earlier than the reset timing tep, each of the plurality of pieces of time information NTC is generated by using a corresponding one of the plurality of comparison signals CP as a signal whose electrical potential at the blocking timing is held until the reset timing tep. Therefore, in the present embodiment, for example, it is possible to cause the ejection section D[j] to perform another operation at a timing after the blocking timing regardless of the reset timing tep. Alternatively, in the present embodiment, regardless of the reset timing tep, the ejection section D other than the ejection section D[j] can be operated at the timing after the blocking timing as the ejection section D to be determined. That is, in the present embodiment, for example, even in a case where the period of time from the timing at which the supply of the residual vibration signal VD to the signal generator 60A is started to the reset timing tep is set to be long, it is possible to shorten the inspection period for determining the state of the ejection section D.

In the present embodiment, the reset timing tep may be adjusted such that the period of time from the blocking timing to the reset timing tep is shorter in a case where the inspection period for the inspection of the state of the ejection section D is set to be short than in a case where the inspection period is long. As described above, in this aspect, by adjusting the reset timing tep, it is possible to easily shorten the inspection period for the inspection of the state of the ejection section D.

In the present embodiment, the reset timing tep may be adjusted such that the period of time from the blocking timing to the reset timing tep is longer in a case where the accuracy of the inspection of the state of the ejection section D is set to be high than in a case where the accuracy of the inspection is low. As described above, in this aspect, by adjusting the reset timing tep, it is possible to easily improve the accuracy of the inspection of the state of the ejection section D. For example, when the period of time from the blocking timing to the reset timing tep is increased, the period of time from the timing at which the supply of the residual vibration signal VD to the signal generator 60A is started to the reset timing tep increases. Therefore, when the period of time from the blocking timing to the reset timing tep is adjusted to be increased, the amplitudes of the adjusted waveforms of the sine waves based on the plurality of comparison signals CP increase, and thus it is possible to increase the resolution and improve the accuracy of the inspection.

In the present embodiment, the signal generator 60A may generate the plurality of comparison signals CP based on a signal that is included in the residual vibration signal VD and that is in the first period TPP1 of time shorter than or equal to one fourth of the period of the residual vibration signal VD. In this manner, in the aspect, since it is possible to shorten the time required to generate the comparison signals CP, it is possible to shorten the inspection period for determining the state of the ejection section D.

In the present embodiment, the signal generator 60A is electrically decoupled from the ejection section D[j] by the coupling state specifying signal Qs[j]. For example, in the present embodiment, the wiring Li[j] is electrically decoupled from the wiring Ls in accordance with the coupling state specifying signal Qs[j]. As described above, in the present embodiment, since the signal generator 60A is electrically decoupled from the ejection section D[j] by the coupling state specifying signal Qs[j], it is possible to cause the ejection section D[j] to perform another operation before the end of the determination of the state of the ejection section D[j]. Alternatively, in the present embodiment, before the end of the determination of the state of the ejection section D[j], the ejection section D other than the ejection section D[j] can be operated as the ejection section D to be determined.

In the present embodiment, the plurality of comparison signals CP may be generated based on a signal that is included in the residual vibration signal VD and that is in in the first period TPP1 of time shorter than or equal to one fourth of the period of the residual vibration signal VD. The first period TPP1 of time is started before the first time elapses after the residual vibration signal VD is input to the signal generator 60A, and the first time is shorter than the period of time corresponding to one fourth of the period of the residual vibration signal VD. In this aspect, it is possible to suppress an increase in a period of time from when the residual vibration signal VD is input to the signal generator 60A to when the comparison signals CP are generated. As a result, in this aspect, it is possible to shorten the inspection period for determining the state of the ejection section D.

### Third Embodiment

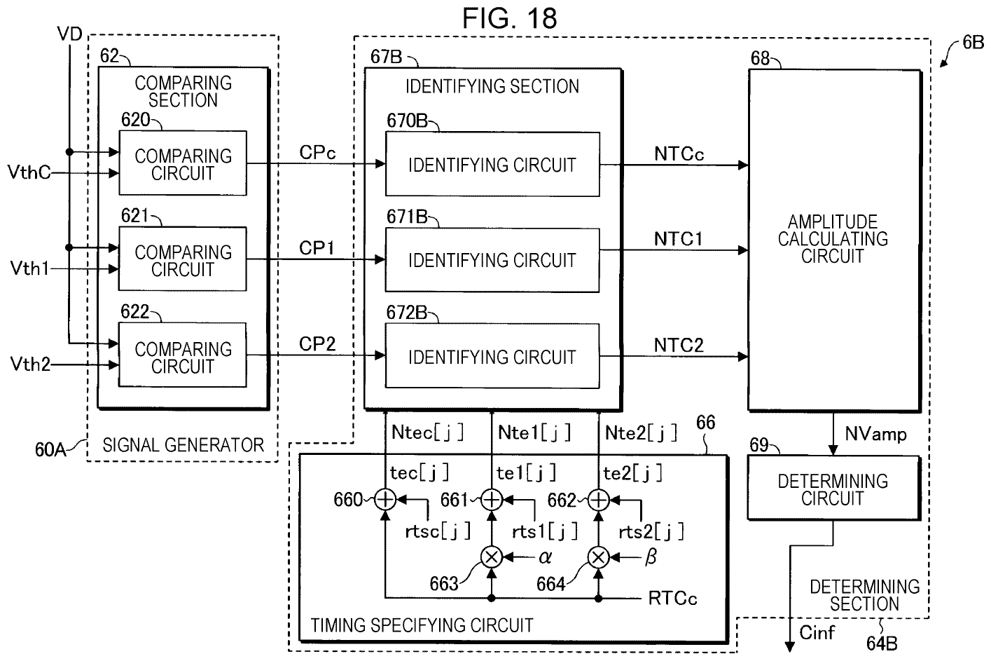

FIG. 18 is a block diagram illustrating an example of a configuration of an inspection unit 6B according to a third embodiment. The same elements as those described with reference to FIGS. 1 to 17 are denoted by the same reference signs, and detailed descriptions thereof will be omitted.

An ink jet printer 1 according to the present embodiment is the same as the ink jet printer 1 illustrated in FIG. 1 except that the ink jet printer 1 according to the present embodiment includes the inspection unit 6B instead of the inspection unit 6 illustrated in FIG. 1. In the present embodiment, similarly to the second embodiment described above, it is assumed that the determination of the state of the ejection section D in the second inspection mode described above in the first embodiment is not executed. Therefore, in the present embodiment, the mask signal MSK illustrated in FIG. 8 and the like is not used. However, also in the present embodiment, the state of the ejection section D may be determined in the second inspection mode. The inspection unit 6B will be mainly described below.

In the inspection unit 6B, reset information Ntec, Nte1, and Nte2 are used instead of the reset information Ntep illustrated in FIG. 14. The reset information Ntec is information indicating a reset timing tec for a comparison signal CPc, and the reset information Nte1 is information indicating a reset timing te1 for a comparison signal CP1. The reset information Nte2 is information indicating a reset timing te2 for a comparison signal CP2. The reset information Ntec, Nte1, and Nte2 are examples of the “reset signal” and the “timing information”. Hereinafter, the reset information Ntep, Ntec, Nte1, and Nte2 may be collectively referred to as reset information Nte. Hereinafter, the reset timings tep, tec, te1, and te2 may be collectively referred to as reset timings te.

The inspection unit 6B is the same as the inspection unit 6A illustrated in FIG. 14 except that the inspection unit 6B includes a determining section 64B instead of the determining section 64A illustrated in FIG. 14. For example, the inspection unit 6B includes a signal generator 60A and the determining section 64B. The signal generator 60A is the same as the signal generator 60A illustrated in FIG. 14. For example, also in the present embodiment, similarly to the second embodiment described above, a timing tsc is a timing at which the comparison signal CPc transitions from a low level to a high level. A timing ts1 is a timing at which the comparison signal CP1 transitions from a low level to a high level, and a timing ts2 is a timing at which the comparison signal CP2 transitions from a low level to a high level.

The determining section 64B is the same as the determining section 64A illustrated in FIG. 14 except that the determining section 64B includes a timing specifying circuit 66 and an identifying section 67B instead of the timing specifying circuit 65 and the identifying section 67A illustrated in FIG. 14. For example, the determining section 64B includes the timing specifying circuit 66, the identifying section 67B, an amplitude calculating circuit 68, and a determining circuit 69. The amplitude calculating circuit 68 and the determining circuit 69 are the same as the amplitude calculating circuit 68 and the determining circuit 69 illustrated in FIG. 7. For example, an amplitude Vamp of a residual vibration signal VD is calculated according to Equation (1) or Equation (2) described with reference to FIG. 7 by approximating a waveform of a residual vibration signal VD to a sine wave.

The identifying section 67B is the same as the identifying section 67A illustrated in FIG. 14 except that the identifying section 67B includes identifying circuits 670B, 671B, and 672B instead of the identifying circuits 670A, 671A, and 672A illustrated in FIG. 14. The identifying circuit 670B is the same as the identifying circuit 670A except that the identifying circuit 670B identifies a time length TCc using the reset timing tec instead of the reset timing tep. The identifying circuit 671B is the same as the identifying circuit 671A except that the identifying circuit 671B identifies a time length TC1 using the reset timing te1 instead of the reset timing tep. The identifying circuit 672B is the same as the identifying circuit 672A except that the identifying circuit 672B identifies a time length TC2 using the reset timing te2 instead of the reset timing tep.

As described above, in the present embodiment, the reset timings tec, te1, and te2 corresponding to the comparison signals CPc, CP1, and CP2 are used to identify the time lengths TCc, TC1, and TC2, respectively. In the present embodiment, the reset timings the are adjusted for each of the ejection sections D. An operation and the like of the timing specifying circuit 66 will be described below by taking, as an example, a case where the ejection section D[j] is an ejection section D to be determined.

The timing specifying circuit 66 specifies a reset timing tec[j] for the identifying circuit 670B by outputting reset information Ntec[j] corresponding to the comparison signal CPc to the identifying circuit 670B of the identifying section 67B. The timing specifying circuit 66 specifies a reset timing te1[j] for the identifying circuit 671B by outputting reset information Nte1[j] corresponding to the comparison signal CP1 to the identifying circuit 671B of the identifying section 67B. The timing specifying circuit 66 specifies a reset timing te2[j] for the identifying circuit 672B by outputting reset information Nte2[j] corresponding to the comparison signal CP2 to the identifying circuit 672B of the identifying section 67B.

For example, the timing specifying circuit 66 includes adders 660, 661, and 662 and multipliers 663 and 664.

The adder 660 adds a reference period length RTCc to a reference set timing rtsc[j] and outputs, to the identifying circuit 670B, the reset information Ntec indicating the reset timing tec[j] that is the result of the addition. The reference period length RTCc is a parameter for determining the reference period length for reducing a variation in the amplitudes Vamp for the plurality of ejection sections D, and is common to the J ejection sections D. For example, the reference period length RTCc may be set to approximately one fourth of the period of the normal residual vibration signal VD. Information indicating the reference period length RTCc is, for example, stored in the storage unit 5. The reference set timing rtsc[j] is, for example, the timing tsc at which the comparison signal CPC transitions from a low level to a high level in a state where the ejection section D[j] is normal. Information indicating the reference set timing rtsc[j] is, for example, stored in the storage unit 5 in association with the ejection section D[j].

The adder 661 receives a result of multiplication by the multiplier 663. For example, the multiplier 663 multiplies the reference period length RTCc by a coefficient α and outputs the result of the multiplication to the adder 661. Then, the adder 661 adds the result of the multiplication of the reference period length RTCc by the coefficient α to a reference set timing rts1[j] and outputs, to the identifying circuit 671B, the reset information Nte1 indicating the reset timing te1[j] that is the result of the addition. The reference set timing rts1[j] is, for example, the timing ts1 at which the comparison signal CP1 transitions from a low level to a high level in a state where the ejection section D[j] is normal. Information indicating the reference set timing rts1[j] is, for example, stored in the storage unit 5 in association with the ejection section D[j].

The coefficient α is a coefficient for adjusting the sensitivity for the determination of the state of the ejection section D, and is determined so as to satisfy “α<100%”. For example, the coefficient α may be common to the J ejection sections D, or coefficients α may be determined for the respective ejection sections D. Alternatively, coefficients α may be determined for respective groups each including a plurality of ejection sections D. Each of the groups each including a plurality of ejection sections D may be, for example, a group of a plurality of ejection sections D corresponding to a nozzle row NL. Information indicating the coefficient α is, for example, stored in the storage unit 5. In a case where the coefficients α are determined for the respective ejection sections D, information indicating the coefficients α is stored in the storage unit 5 in association with the respective ejection sections D. In a case where the coefficients α are determined for the respective groups of the plurality of ejection sections D, information indicating the coefficients α are stored in the storage unit 5 in association with the respective groups.

The adder 662 receives a result of multiplication by the multiplier 664. For example, the multiplier 664 multiplies the reference period length RTCc by a coefficient β and outputs the result of the multiplication to the adder 662. Then, the adder 662 adds the result of the multiplication of the reference period length RTCc by the coefficient β to a reference set timing rts2[j] and outputs, to the identifying circuit 672B, the reset information Nte2 indicating the reset timing te2[j] that is the result of the addition. The reference set timing rts2[j] is, for example, the timing ts2 at which the comparison signal CP2 transitions from a low level to a high level in a state where the ejection section D[j] is normal. Information indicating the reference set timing rts2[j] is, for example, stored in the storage unit 5 in association with the ejection section D[j].

The coefficient β is a coefficient for adjusting the sensitivity for the determination of the state of the ejection section D, and is determined so as to satisfy “β<100%”. For example, the coefficient β may be common to the J ejection sections D, or coefficients β may be determined for the respective ejection sections D. Alternatively, coefficients β may be determined for respective groups each including a plurality of ejection sections D. Each of the groups each including a plurality of ejection sections D may be, for example, a group of a plurality of ejection sections D corresponding to a nozzle row NL. Information indicating the coefficient β is, for example, stored in the storage unit 5. In a case where the coefficients β are determined for the respective ejection sections D, information indicating the coefficients β is stored in the storage unit 5 in association with the respective ejection sections D. In a case where the coefficients β are determined for the respective groups each including a plurality of ejection sections D, information indicating the coefficients β is stored in the storage unit 5 in association with the respective groups.

The reset timing tec[j] is expressed by Equation (12) using the reference period length RTCc and the reference set timing rtsc[j]. The reset timing te1[j] is expressed by Equation (13) using the reference period length RTCc, the reference set timing rts1[j], and the coefficient α. The reset timing te2[j] is expressed by Equation (14) using the reference period length RTCc, the reference set timing rts2[j], and the coefficient β.

$$tec [ j ] = RTCc + rtsc [ j ] \qquad ( 12 )$$

$$te 1 [ j ] = α \cdot RTCc + rts 1 [ j ] \qquad ( 13 )$$

$$te 2 [ j ] = β \cdot RTCc + rts 2 [ j ] \qquad ( 14 )$$

As can be seen from Equation (13), the reset timing te1[j] is adjusted by adjusting the coefficient α. Similarly, as can be seen from Equation (14), the reset timing te2[j] is adjusted by adjusting the coefficient β.

A time length TCc[j] is expressed by Equation (15) using the timing tsc[j] and the reset timing tec[j], and a time length TC1[j] is expressed by Equation (16) using the timing ts1[j] and the reset timing te1[j]. A time length TC2[j] is expressed by Equation (17) using the timing ts2[j] and the reset timing te2[j].

$$TCc [ j ] = tec [ j ] - tsc [ j ] \qquad ( 15 )$$

$$TC 1 [ j ] = te 1 [ j ] - ts 1 [ j ] \qquad ( 16 )$$

$$TC 2 [ j ] = te 2 [ j ] - ts 2 [ j ] \qquad ( 17 )$$

The time length TCc[j] is expressed by Equation (18) from Equation (12) and Equation (15). The time length TC1[j] is expressed by Equation (19) from Equation (13) and Equation (16). The time length TC2[j] is expressed by Equation (20) from Equation (14) and Equation (17).

$$TCc [ j ] = RTCc + rtsc [ j ] - tsc [ j ] \qquad ( 18 )$$

$$TC 1 [ j ] = α \cdot RTCc + rts 1 [ j ] - ts 1 [ j ] \qquad ( 19 )$$

$$TC 2 [ j ] = β \cdot RTCc + rts 2 [ j ] - ts 2 [ j ] \qquad ( 20 )$$

As can be seen from Equation (18), the time length TCc[j] is represented by the sum of the reference period length RTCc and a value obtained by subtracting the timing tsc[j] from the reference set timing rtsc[j]. As can be seen from Equation (19), the time length TC1[j] is represented by the sum of the product of the reference period length RTCc and the coefficient α and a value obtained by subtracting the timing ts1[j] from the reference set timing rts1[j]. As can be seen from Equation (20), the time length TC2[j] is represented by the sum of the product of the reference period length RTCc and the coefficient β and a value obtained by subtracting the timing ts2[j] from the reference set timing rts2[j]. In the present embodiment, the time lengths TC can be identified without generating the comparison signals CCPc, CCP1, and CCP2 illustrated in FIG. 9.

The configuration of the inspection unit 6B is not limited to the example illustrated in FIG. 18. For example, the timing specifying circuit 66 may be included in the control unit 2. Alternatively, the timing specifying circuit 66 may be included in the identifying section 67B. In an aspect in which the timing specifying circuit 66 is included in the identifying section 67B, the time lengths TCc[j], TC1[j], and TC2[j] may be calculated based on Equations (18), (19), and (20) without calculating the reset timings tec[j] te1[j], and te2[j]. For example, the reset information Ntec[j], Nte1[j], and Nte2[j] may be stored in the storage unit 5 in association with the ejection section D[j]. In this aspect, the timing specifying circuit 66 outputs, for example, the reset information Ntec[j], Nte1[j], and Nte2[j] read from the storage unit 5 to the identifying section 67B.

For example, an end point specifying signal whose level transitions at the reset timing tec[j], an end point specifying signal whose level transitions at the reset timing te1[j], and an end point specifying signal whose level transitions at the reset timing te2[j] may be used as the reset information Ntec[j], Nte1[j], and Nte2[j], respectively.

Also in the present embodiment, the comparison signals CP may be generated based on a signal that is included in the residual vibration signal VD and that is in a first period TPP1 of time shorter than or equal to one fourth of the period of the residual vibration signal VD. The first period TPP1 of time is, for example, the first period TPP1 of time illustrated in FIG. 9. Also in the present embodiment, it is preferable that the first period TPP1 of time be started before a first time elapses after the residual vibration signal VD is input to the signal generator 60A. The first time is, for example, shorter than the period of time corresponding to one fourth of the period of the residual vibration signal VD.

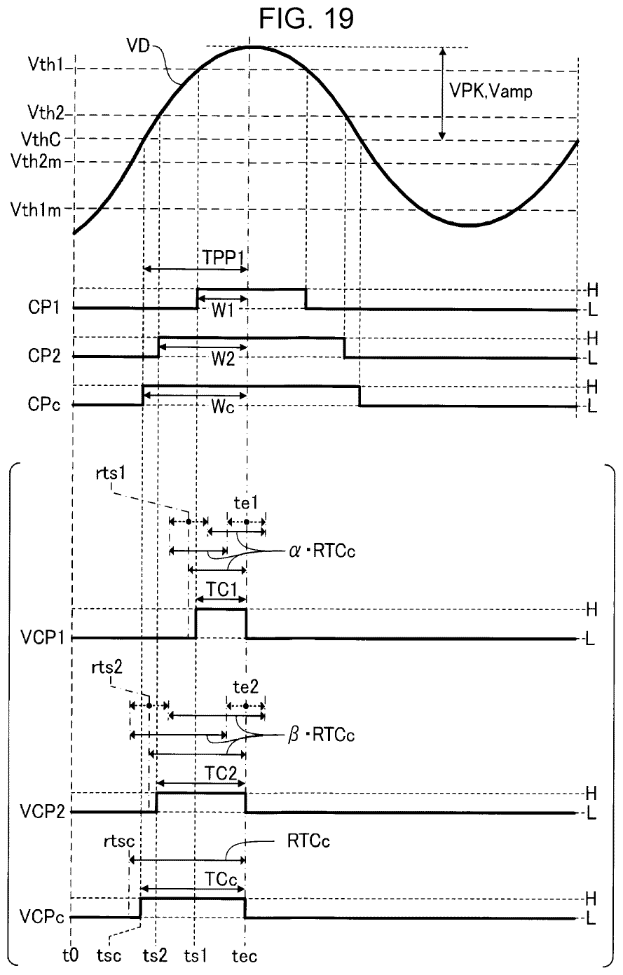

Next, a relationship between the residual vibration signal VD, the reset timing te, and the comparison signals CP will be described with reference to FIG. 19. FIG. 19 is a diagram for explaining the relationship between the residual vibration signal VD, the reset timing te, and the comparison signals CP. Although the subscript [j] is omitted in FIG. 19, the subscript [j] is used as appropriate in the description of FIG. 19.

Time t0 in FIG. 19 indicates a timing at which the supply of a residual vibration signal VD[j] to the signal generator 60A is started. The timing at which the supply of the residual vibration signal VD[j] to the signal generator 60A is started is, for example, a timing at which the coupling state specifying signal Qs[j] illustrated in FIG. 8 transitions from a low level to a high level. With reference to FIG. 19, for easy understanding of the description, the comparison signals CP and the like will be described assuming that the coupling state specifying signal Qs[j] is maintained at a high level. However, in the present embodiment, for example, the coupling state specifying signal Qs[j] can be transitioned from a high level to a low level at a timing between the timing ts1 and the reset timing te1.

FIG. 19 illustrates virtual comparison signals VCPc, VCP1, and VCP2 in parentheses for easy understanding of the description. The comparison signals VCPc, VCP1, and VCP2 correspond to the comparison signals CCPc, CCP1, and CCP2 illustrated in FIG. 9, respectively. Note that the comparison signals VCPc, VCP1, and VCP2 are not actually generated. The comparison signal VCPc is a virtual signal obtained by resetting the comparison signal CPC at the reset timing tec. The comparison signal VCP1 is a virtual signal obtained by resetting the comparison signal CP1 at the reset timing te1. The comparison signal VCP2 is a virtual signal obtained by resetting the comparison signal CP2 at the reset timing te2. FIG. 19 illustrates the comparison signals VCPC, VCP1, and VCP2 in a case where the reset timings tec, te1, and te2 are the same.

In FIG. 19, a period Wc of time is from the timing tsc at which the comparison signal CPc transitions from a low level to a high level to the reset timing tec, and the time length of the period Wc is the time length TCc. A period W1 of time is from the timing ts1 at which the comparison signal CP1 transitions from a low level to a high level to the reset timing te1, and the time length of the period W1 is the time length TC1. A period W2 of time is from the timing ts2 at which the comparison signal CP2 transitions from a low level to a high level to the reset timing te2, and the time length of the period W2 is the time length TC2.

In a state where the ejection section D[j] is normal, the time length TCc[j] from the timing tsc[j] to the reset timing tec[j] matches the time length from the reference set timing rtsc[j] to the reset timing tec[j], that is, the reference period length RTCc. It is to be noted that the term “match” includes not only a case where the time lengths exactly match but also a case where the time lengths are slightly different due to an error such as a manufacturing error or an operation error. In a state where the states of the J ejection sections D are normal, the time lengths TCc[j] of the J ejection sections D match the reference period length RTCc that is common to the J ejection sections D.

In a state where the ejection section D[j] is normal, the time length TC1[j] from the timing ts1[j] to the reset timing te1[j] matches the time length from the reference set timing rts1[j] to the reset timing te1[j], that is, the product of the reference period length RTCc and the coefficient α. Similarly, the time length TC2[j] from the timing ts2[j] to the reset timing te2[j] matches the time length from the reference set timing rts2[j] to the reset timing te2[j], that is, the product of the reference period length RTCc and the coefficient β.

As described with reference to FIG. 18, the reset timing te1[j] is adjusted by adjusting the coefficient α. For example, by adjusting the coefficient α, the reset timing te1[j] is set to the same timing as the reset timing tec[j], a timing later than the reset timing tec[j], or a timing earlier than the reset timing tec[j].

In a case where the reset timing te1[j] is later than the reset timing tec[j], the electrical potential of the residual vibration signal VD is treated to have reached the threshold electrical potential Vth1 at a timing earlier than the actual timing ts1[j], and the amplitude Vamp is identified. For example, a case where the reset timing te1[j] is shifted so as to match the reset timing tec[j] in a state where the time length from the reference set timing rts1[j] to the reset timing te1[j] is maintained will be considered. In this case, an amount by which the reset timing te1[j] is shifted is referred to as a first shift amount. In this case, the reference set timing rts1[j] is also shifted to be earlier by the first shift amount. As described with reference to FIG. 18, the time length TC1[j] is represented by the sum of the product of the reference period length RTCc and the coefficient α and the value obtained by subtracting the timing ts1[j] from the reference set timing rts1[j]. When the measured time length TC1 is maintained, the value obtained by subtracting the timing ts1[j] from the reference set timing rts1[j] is also maintained. Therefore, the timing ts1[j] is also shifted to be earlier by the first shift amount. In this case, the electrical potential of the residual vibration signal VD is treated to have reached the threshold electrical potential Vth1 at a timing that is earlier than the actual timing ts1[j] by the first shift amount, and the amplitude Vamp is identified.

In a case where the reset timing te1[j] is earlier than the reset timing tec[j], the electrical potential of the residual vibration signal VD is treated to have reached the threshold electrical potential Vth1 at a timing later than the actual timing ts1[j], and the amplitude Vamp is identified. For example, a case where the reset timing te1[j] is shifted so as to match the reset timing tec[j] in a state where the time length from the reference set timing rts1[j] to the reset timing te1[j] is maintained will be considered. In this case, an amount by which the reset timing te1[j] is shifted is referred to as a second shift amount. In this case, the reference set timing rts1[j] is also shifted to be later by the second shift amount. When the measured time length TC1 is maintained, the timing ts1[j] is also shifted to be later by the second shift amount. In this case, the electrical potential of the residual vibration signal VD is treated to have reached the threshold electrical potential Vth1 at a timing later than the actual timing ts1[j] by the second shift amount, and the amplitude Vamp is identified.

The reset timing te2[j] is also adjusted by adjusting the coefficient β, similarly to the reset timing te1[j]. For example, in a case where the reset timing te2[j] is later than the reset timing tec[j], the electrical potential of the residual vibration signal VD is treated to have reached the threshold electrical potential Vth2 at a timing earlier than the actual timing ts2[j], and the amplitude Vamp is identified. For example, in a case where the reset timing te2[j] is earlier than the reset timing tec[j], the electrical potential of the residual vibration signal VD is treated to have reached the threshold electrical potential Vth2 at a timing later than the actual timing ts2[j], and the amplitude Vamp is identified.

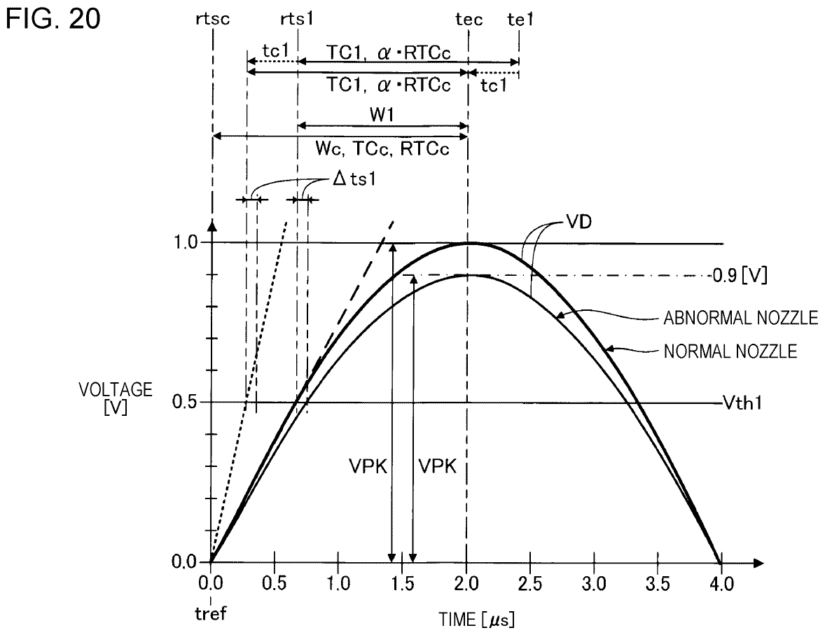

Next, an outline of the adjustment of the sensitivity for the determination of the state of the ejection section D will be described with reference to FIG. 20. Hereinafter, the adjustment of the sensitivity for the determination of the state of the ejection section D may be simply referred to as sensitivity adjustment.

FIG. 20 is a diagram for explaining the outline of the adjustment of the sensitivity for the determination of the state of the ejection section D. With reference to FIG. 20, the sensitivity adjustment by the adjustment of the reset timing te1 will be mainly described. FIG. 20 illustrates a residual vibration signal VD of a normal nozzle and a residual vibration signal VD of an abnormal nozzle. In FIG. 20, the vertical axis indicates a voltage [V] in a case where the threshold electrical potential VthC is set as a reference, that is, the vertical axis indicates a difference in electrical potential from the threshold electrical potential VthC, and the horizontal axis indicates a period of time [μs] elapsed from a reference timing tref.

In FIG. 20, the reference timing tref is a timing at which the electrical potential of the residual vibration signal VD of the normal nozzle reaches the threshold electrical potential VthC from an electrical potential lower than the threshold electrical potential VthC. That is, the reference timing tref is the reference set timing rtsc[j]. In FIG. 20, it is assumed that the difference between the threshold electrical potentials VthC and Vth1 is 0.5 V. In FIG. 20, a broken line indicates an inclination of the residual vibration signal VD of the normal nozzle at the threshold electrical potential Vth1, and a dotted line indicates the inclination after the sensitivity adjustment.

In FIG. 20, it is assumed that the amplitude VPK of the residual vibration signal VD of the normal nozzle is 1.0 V, the amplitude VPK of the residual vibration signal VD of the abnormal nozzle is 0.9 V, and the difference in phase between the residual vibration signal VD of the normal nozzle and the residual vibration signal VD of the abnormal nozzle is 0. In FIG. 10, it is assumed that the period of the residual vibration signal VD of the normal nozzle and the period of the residual vibration signal VD of the abnormal nozzle are equal to each other, and that one fourth of each of the periods is 2.0 μs. That is, in FIG. 20, it is assumed that only the amplitude VPK among the amplitude VPK, the period, and the phase changes between the residual vibration signal VD of the normal nozzle and the residual vibration signal VD of the abnormal nozzle.

In a case where only the amplitude VPK among the amplitude VPK, the period, and the phase changes, the period Wc of the comparison signal CPc does not change and the period W1 of the comparison signal CP1 changes between the normal nozzle and the abnormal nozzle. For example, the difference in the period W1 of the comparison signal CP1 between the normal nozzle and the abnormal nozzle is a time difference Δts1.

As illustrated in FIG. 20, before the sensitivity adjustment, the time difference Δts1 corresponds to the amount of change corresponding to the inclination of the electrical potential of the residual vibration signal VD of the normal nozzle at electrical potentials close to the threshold electrical potential Vth1. In the sensitivity adjustment, for example, the reset timing te1 is adjusted by adding the product of the reference period length RTCc and the coefficient α to the reference set timing rtsc in a state where the time difference Δts1 is maintained such that the inclination after the sensitivity adjustment becomes steep. In the example illustrated in FIG. 20, the reset timing te1 is adjusted to be later than the reset timing tec by time tc1.

For example, a case is considered where the reset timing te1 is shifted to be earlier by time tc1 so as to match the reset timing tec in a state where the time length from the reference set timing rts1 to the reset timing te1 is maintained. In this case, the reference set timing rts1 is also shifted to be earlier by time tc1. Since the time difference Δts1 is maintained, the timing ts1 of the abnormal nozzle is also shifted to be earlier by time tc1. As a result, the inclination after the sensitivity adjustment becomes steeper than that before the sensitivity adjustment as indicated by the dotted line in FIG. 20.

In the method of making the inclination steep by simply amplifying the amplitude VPK of the residual vibration signal VD, since the inclination of the residual vibration signal VD of the abnormal nozzle also changes in a similar manner to the inclination of the residual vibration signal VD of the normal nozzle, the time difference Δts1 changes. Therefore, it is difficult to appropriately adjust the sensitivity for the determination of the state of the ejection section D by the method of making the inclination steep by simply amplifying the amplitude VPK of the residual vibration signal VD.

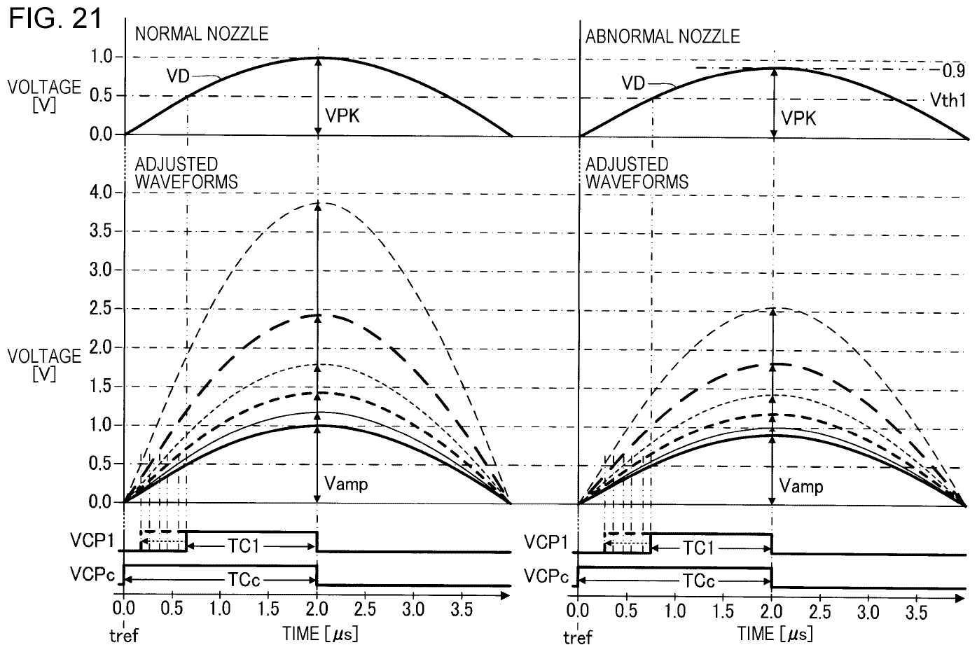

Next, a relationship between the reset timing te and the amplitude Vamp calculated based on the time lengths TC will be described with reference to FIG. 21.

FIG. 21 is a diagram for explaining the relationship between the reset timing te and the amplitude Vamp calculated based on the time lengths TC. Each of adjusted waveforms illustrated in FIG. 21 indicates a sine wave having an amplitude Vamp calculated from Equation (1) described with reference to FIG. 7 using the time length TCc adjusted by using the reset timing tec and the time length TC1 adjusted by using the reset timing te1. That is, each of the adjusted waveforms is a virtual waveform in which the residual vibration signal VD is treated to have an amplitude Vamp calculated based on the time lengths TCc and TC1, and is not necessarily the same waveform as that of the residual vibration signal VD actually output from the detecting circuit 33. The comparison signal VCPc illustrated in FIG. 21 is a virtual signal obtained by resetting the comparison signal CPc at the reset timing tec, and the comparison signal VCP1 is a virtual signal obtained by resetting the comparison signal CP1 at the reset timing te1.

In each of a graph of the residual vibration signals VD and a graph of the adjusted waveforms in FIG. 21, the vertical axis indicates a voltage [V] in a case where the threshold electrical potential VthC is set as a reference, that is, the vertical axis indicates a difference in electrical potential from the threshold electrical potential VthC, and the horizontal axis indicates a period of time [μs] elapsed from a reference timing tref. Also in FIG. 21, the reference timing tref is a timing at which the electrical potential of the residual vibration signal VD of the normal nozzle reaches the threshold electrical potential VthC from an electrical potential lower than the threshold electrical potential VthC, and the difference between the threshold electrical potential VthC and the threshold electrical potential Vth1 is 0.5 V.

The residual vibration signal VD of the normal nozzle and the residual vibration signal VD of the abnormal nozzle illustrated in FIG. 21 are the same as or similar to the residual vibration signal VD of the normal nozzle and the residual vibration signal VD of the abnormal nozzle described with reference to FIG. 20. For example, the amplitude VPK of the residual vibration signal VD of the normal nozzle is 1.0 V, the amplitude VPK of the residual vibration signal VD of the abnormal nozzle is 0.9 V, and the difference in phase between the residual vibration signal VD of the normal nozzle and the residual vibration signal VD of the abnormal nozzle is 0. A period of time that is one fourth of each of the period of the residual vibration signal VD of the normal nozzle and the period of the residual vibration signal VD of the abnormal nozzle is 2.0 μs. Therefore, each of the residual vibration signal VD of the normal nozzle and the residual vibration signal VD of the abnormal nozzle has a peak PK at a timing at which 2.0 μs elapse from the reference timing tref.

FIG. 21 illustrates six adjusted waveforms respectively corresponding to six reset timings te1 for each of the normal nozzle and the abnormal nozzle. FIG. 21 illustrates the adjusted waveforms and the virtual comparison signal VCP1 in a case where the reset timing te1 is shifted so as to match the reset timing tec.

As illustrated in FIG. 21, by adjusting the reset timing te1, a time ratio that is a ratio of the time length TC1 to the time length TCc in a state where the ejection section D is normal is adjusted. Regarding each of the normal nozzle and the abnormal nozzle, in a state where the ejection section D is normal, the amplitudes Vamp of the adjusted waveforms in a case where the time ratio that is the ratio of the time length TC1 to the time length TCc is high are greater than those in a case where the time ratio is low.

The reset timing te1 is adjusted by, for example, adjusting the coefficient α of Equation (13) described with reference to FIG. 18. The coefficient α corresponds to the time ratio that is the ratio of the time length TC1 to the time length TCc in a state where the ejection section D is normal. The reset timing te1 is adjusted, for example, by adjusting the coefficient α of Equation (13) described with reference to FIG. 18. Note that the reset timing te1 may be adjusted by adjusting the reference set timing rts1. Also in the adjustment of the reference set timing rts1, the time ratio that is the ratio of the time length TC1 to the time length TCc in a state where the ejection section D is normal is adjusted.

An amount by which the time length te1 is adjusted according to the adjustment of the reset timing TC1 corresponds to an amount by which the comparison signal CP1 is corrected. Although not illustrated in FIG. 21, an amount by which the time length te2 is adjusted according to the adjustment of the reset timing TC2 corresponds to an amount by which the comparison signal CP2 is corrected. The amount of change in the amplitude Vamp due to the adjustment of the time length TC1 may be treated as the amount by which the comparison signal CP1 is corrected.

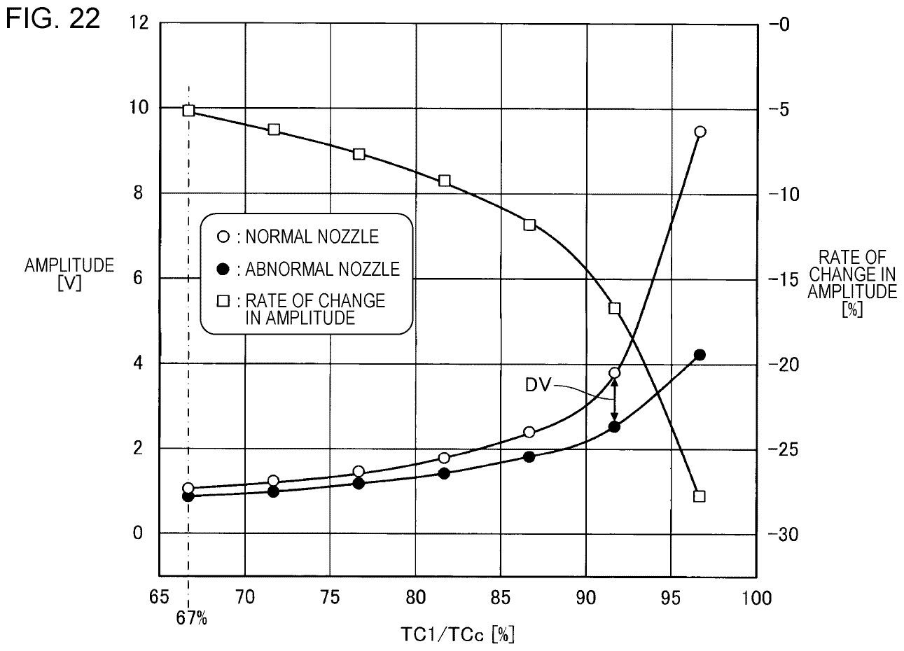

Next, a relationship between the time ratio that is the ratio of the time length TC1 to the time length TCc, the amplitude Vamp, and the rate of change in the amplitude in a state where the ejection section D is normal will be described with reference to FIG. 22.

FIG. 22 is a diagram for explaining the relationship between the time ratio of the time lengths TCc and TC1, the amplitude Vamp, and the rate of change in the amplitude. In FIG. 22, one of the vertical axes indicates the voltage [V] of the amplitude Vamp in a case where the threshold electrical potential VthC is set as a reference, the other of the vertical axes indicates the rate [%] change in the amplitude, and the horizontal axis represents the time ratio [%] of the time lengths TCc and TC1. Similarly to FIG. 12, the rate of change in the amplitude indicates the ratio [%] of the amplitude Vamp calculated for the abnormal nozzle to the amplitude Vamp calculated for the normal nozzle. The time ratio of the time lengths TCc and TC1 indicates the ratio [%] of the time length TC1 to the time length TCc in a state where the ejection section D is normal. For example, the time ratio corresponds to the coefficient α of Equation (13) and Equation (19) described with reference to FIG. 18.

Each of white circles in FIG. 22 indicates the amplitude Vamp of the normal nozzle, each of black circles in FIG. 22 indicates the amplitude Vamp of the abnormal nozzle, and each of squares in FIG. 22 indicates the rate of change in the amplitude.

As illustrated in FIG. 22, for each of the normal nozzle and the abnormal nozzle, the amplitude Vamp increases as the time ratio of the time lengths TCc and TC1 increases. The difference DV between the amplitude Vamp of the normal nozzle and the amplitude Vamp of the abnormal nozzle increases as the time ratio of the time lengths TCc and TC1 increases. The absolute value of the rate of change in the amplitude that is the ratio of the amplitude Vamp of the abnormal nozzle to the amplitude Vamp of the normal nozzle increases as the time ratio of the time lengths TCc and TC1 increases. In the example illustrated in FIG. 16, when the time ratio of the time lengths TCc and TC1 is set to approximately 90%, the rate of change in the amplitude increases to approximately three times the rate of change in the amplitude when the time ratio of the time lengths TCc and TC1 is approximately 67%.

As described above, in the present embodiment, the amplitude Vamp, the rate of change in the amplitude, and the like can be adjusted by adjusting the time ratio of the time lengths TCc and TC1, for example, the coefficient α. The time ratio of the time lengths TCc and TC1 may be determined for each of the ejection sections D in accordance with the amount of ink to be ejected in a state where the ejection section D is normal. For example, in a case where the i-th ejection section D different from the j-th ejection section D[j] among the J ejection sections D is the ejection section D[i], the time ratio of the time lengths TCc and TC1 may be adjusted for each of the ejection section D[j] and the ejection section D[i] in accordance with the amount of ink to be ejected from each of the ejection section D[j] and the ejection section D[i]. The variable i is a positive integer satisfying “1≤i≤J” and “i≠j”. Hereinafter, in a case where a constituent element, a signal, or the like of the ink jet printer 1 corresponds to the ejection section D[i] among the J ejection sections D, a suffix [i] may be added to a reference sign for representing the constituent element, the signal, or the like.

For example, when the amount of ink to be ejected by the ejection section D[i] is less than the amount of ink to be ejected by the ejection section D[j], the amplitude VPK[i] of the residual vibration signal VD[i] of the ejection section D[i] tends to be less than the amplitude VPK[j] of the residual vibration signal VD[j] of the ejection section D[j]. Therefore, when the amount of ink to be ejected by the ejection section D[i] is less than the amount of ink to be ejected by the ejection section D[j], for example, the time ratio of the time lengths TCc and TC1 is adjusted such that an amount by which the amplitude Vamp[i] of the ejection section D[i] is adjusted is greater than an amount by which the amplitude Vamp[j] of the ejection section D[j] is adjusted. In this case, the time ratio of the time lengths TCc and TC1 may be adjusted by adjusting the coefficients α for the respective ejection sections D. That is, the value of the coefficient α for the ejection section D[j] may be different from the value of the coefficient α for the ejection section D[i]. Hereinafter, the coefficient α used for calculation of the reset timing te1[j] may be referred to as a coefficient α[j], and the coefficient α used for calculation of the reset timing te1[i] may be referred to as a coefficient α[i]. The reset timing te1[j] is an example of a “first timing”. In the above-described example, the ejection section D[j] is an example of the “first ejection section”, and the ejection section D[i] is an example of the “second ejection section”. The residual vibration signal VD[j] is an example of a “first residual vibration signal”, and the residual vibration signal VD[i] is an example of a “second residual vibration signal”. A comparison signal CPc[j] of the ejection section D[j] is an example of the “first reference signal”, and comparison signals CP1[j] and CP2[j] of the ejection section D[j] are examples of the “first inspection signal”. Time information NTCc[j] of the ejection section D[j] is an example of the “first reference signal information”, and time information NTC1[j] and NTC2[j] of the ejection section D[j] are examples of the “first inspection signal information”. Information indicating the reference set timing rts1[j] and information indicating the coefficient α[j] are examples of the “first correction information”. Similarly, a comparison signal CPc[i] of the ejection section D[i] is an example of the “second reference signal”, and comparison signals CP1[i] and CP2[i] of the ejection section D[i] are examples of the “second inspection signal”. Time information NTCc[i] of the ejection section D[i] is an example of the “second reference signal information”, and time information NTC1[i] and NTC2[i] of the ejection section D[i] are examples of the “second inspection signal information”. Information indicating a reference set timing rts1[i] and information indicating a coefficient α[i] are examples of the “second correction information”. However, in a case where the coefficient α is common to the ejection section D[j] and the ejection section D[i], the information indicating the coefficient α may not be included in the “first correction information” and the “second correction information”.

In the present embodiment, as described above, for each of the ejection section D[j] and the ejection section D[i], the time ratio of the time lengths TCc and TC1 can be adjusted based on an amount of ink to be ejected. Accordingly, in the present embodiment, it is possible to inspect the ejection section D[j] and the ejection section D[i] with the same reference.

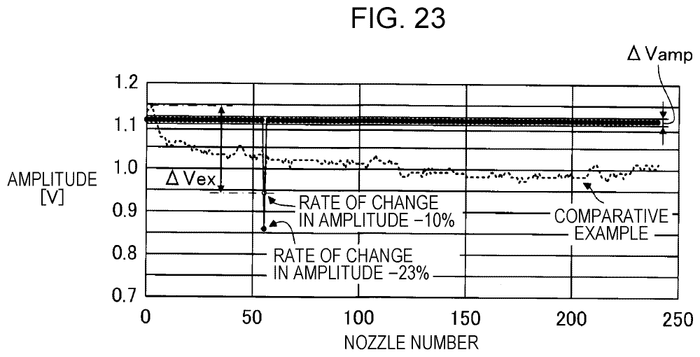

Next, an example of a variation in the amplitudes Vamp calculated for the nozzles N based on the time lengths TCc and TC1 will be described with reference to FIG. 23.

FIG. 23 is a diagram for explaining the example of the variation in the amplitudes Vamp calculated for the nozzles N based on the time lengths TCc and TC1. FIG. 23 illustrates results obtained by an experiment. In FIG. 23, the vertical axis indicates a voltage [V] in a case where the threshold electrical potential VthC is set as a reference, that is, the vertical axis indicates a difference in electrical potential from the threshold electrical potential VthC, and the horizontal axis indicates a nozzle number for identifying each of the J nozzles N. FIG. 23 illustrates a comparative example in which the amplitude Vamp of a residual vibration signal VD is calculated by the same method as that in the second inspection mode described in the first embodiment without execution of adjustment of a variation in amplitudes calculated for nozzles. In the comparative example, the variation ΔVex in the amplitudes Vamp for the J nozzles N is approximately 2 V, and the rate of change in the amplitude is approximately −10%.

In the present embodiment, since the reset timing the is adjusted for each of the ejection sections D, the time lengths TCc in a state where the ejection sections D are normal are substantially the same value for the J nozzles N corresponding to the J ejection sections D, and the time lengths TC1 in a state where the ejection sections D are normal are substantially the same value for the J nozzles N corresponding to the J ejection sections D. Therefore, as illustrated in FIG. 23, the amplitudes Vamp calculated based on the time lengths TCc and TC1 are substantially the same value for the J nozzles N. That is, the variation ΔVamp in the amplitudes Vamp for the J nozzles N is substantially 0. Since the characteristics of each of the nozzles N change due to an environmental change such as a change in temperature, a variation in repeated measurement, aging degradation of the piezoelectric elements PZ, or the like, the variation ΔVamp in the amplitudes Vamp for the J nozzles N is not strictly 0. In the present embodiment, the rate of change in the amplitude can be improved from approximately-10% to approximately-23%, as compared to the comparative example.

As described above, in the present embodiment, it is possible to significantly reduce the variation ΔVamp in the amplitudes Vamp for the J nozzles N while improving the rate of change in the amplitude compared to the comparative example. In the present embodiment, for example, by adjusting the coefficient α, it is possible to improve the sensitivity for the determination of the states of the ejection sections D while reducing the variation ΔVamp in the amplitudes Vamp for the J nozzles N.

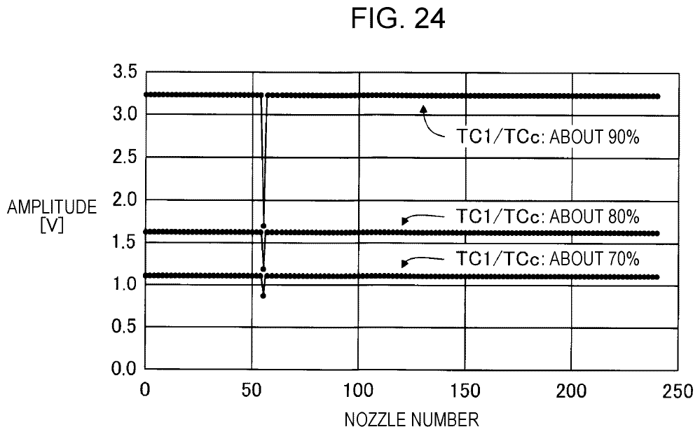

Next, an example of the amplitudes Vamp calculated in a case where the sensitivity for the determination of the states of the ejection sections D is adjusted will be described with reference to FIG. 24.

FIG. 24 is a diagram for explaining an example of the amplitudes Vamp calculated in a case where the sensitivity for the determination of the states of the ejection sections D is adjusted. FIG. 24 illustrates results obtained by an experiment. FIG. 24 illustrates the amplitudes Vamp in a case where the sensitivity for the determination of the states of the ejection sections D is adjusted by adjusting the time ratio of the time lengths TCc and TC1 in a state where the ejection sections D are normal. In FIG. 24, it is assumed that the coefficient α is common to the J ejection sections D, and that the time ratio of the time lengths TCc and TC1 is adjusted by adjusting the coefficient α.

As illustrated in FIG. 24, in any of cases where the time ratios of the time lengths TCc and TC1 are approximately 70%, approximately 80%, and approximately 90%, the variation ΔVamp in the amplitudes Vamp for the J nozzles N is substantially 0. Even in the example illustrated in FIG. 24, as described with reference to FIG. 22, when the time ratio of the time lengths TCc and TC1 increases, the amplitudes Vamp, the difference DV between the amplitude Vamp of the normal nozzle and the amplitude Vamp of the abnormal nozzle, and the absolute value of the rate of change in the amplitude increase.

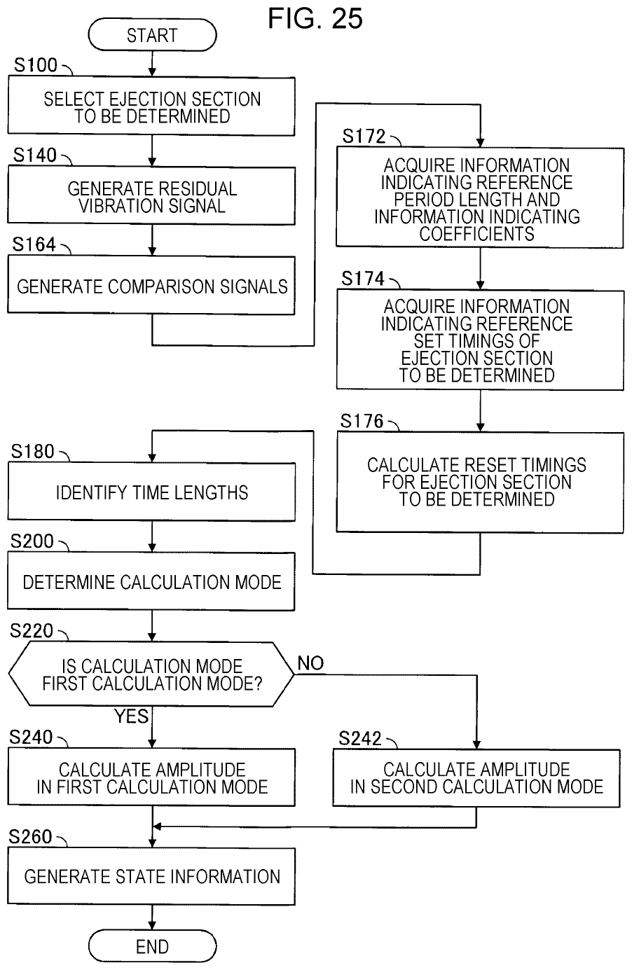

Next, an operation of the ink jet printer 1 to execute an ejection state determination process will be described with reference to FIG. 25.

FIG. 25 is a flowchart illustrating an example of the operation of the ink jet printer 1 to execute the ejection state determination process. The operation illustrated in FIG. 25 is the same as the operation illustrated in FIG. 17 except that processing in steps S172, S174, and S176 is executed instead of the processing in step S170 illustrated in FIG. 17. In FIG. 25, the processing in steps S172, S174, and S175 will be mainly described by taking, as an example, a case where the ejection section D to be determined is the ejection section D[j].

The processing in step S172, S174, and S175 is executed by the timing specifying circuit 66 included in the determining section 64B of the inspection unit 6B after the processing in step S164 is executed. For example, the ink jet printer 1 causes the process to proceed to step S164 after executing the processing in step S172.

In step S172, the timing specifying circuit 66 acquires information indicating the reference period length RTCc, information indicating the coefficient α, and information indicating the coefficient β. For example, the timing specifying circuit 66 reads the information indicating the reference period length RTCc, the information indicating the coefficient α, and the information indicating the coefficient β from the storage unit 5. Thereafter, the inspection unit 6B causes the process to proceed to step S174.

In step S174, the timing specifying circuit 66 acquires information indicating the reference set timings rtsc[j], rts1[j], and rts2[j] of the ejection section D[j] to be determined. For example, the timing specifying circuit 66 reads the information indicating the reference set timings rtsc[j] rts1[j], and rts2[j] from the storage unit 5. Thereafter, the inspection unit 6B causes the process to proceed to step S176.

In step S176, the timing specifying circuit 66 calculates the reset timings tec[j], te1[j], and te2[j] for the ejection section D[j] to be determined. For example, the timing specifying circuit 66 calculates the reset timings tec[j], te1[j], and te2[j] based on Equations (12), (13), and (14) described with reference to FIG. 18. Then, the timing specifying circuit 66 outputs, to the identifying section 67B, the reset information Ntec[j] indicating the reset timing tec[j], the reset information Nte1[j] indicating the reset timing te1[j], and the reset information Nte2[j] indicating the reset timing te2[j]. As a result, the reset timings tec[j], te1[j], and te2[j] are specified for the identifying section 67B. After the timing specifying circuit 66 outputs the reset information Ntec[j], Nte1[j], and Nte2[j] to the identifying section 67B, the inspection unit 6B causes the process to proceed to step S180.

In step S180, the identifying section 67B included in the determining section 64B of the inspection unit 6B identifies the time lengths TCc[j], TC1[j], and TC2[j] based on, for example, Equations (15), (16), and (17) described with reference to FIG. 18.

The operation of the ink jet printer 1 to execute the ejection state determination process is not limited to the example illustrated in FIG. 25. For example, it suffices for the processing in step S172, S174, and S175 to be executed after the processing in step S100 and before the processing in step S180, and the processing in step S172, S174, and S175 may be executed before the processing in step S140. For example, in a case where each of the coefficient α and the coefficient β is common to the J ejection sections D, the processing in step S172 may be executed before the processing in step S100. Alternatively, the reference period length RTCc, the coefficient α, and the coefficient β may be set in the timing specifying circuit 66 in advance. In this case, step S172 is omitted. For example, in a case where the coefficients α are determined for the respective ejection sections D, and the coefficients β are determined for the respective ejection sections D, the timing specifying circuit 66 acquires information indicating the coefficient α and the coefficient β of the ejection section D[j] to be determined in step S172.

For example, the processing in step S172 and the processing in step S174 may not be strictly distinguished from each other. For example, the processing in step S176 and the processing in step S180 may not be strictly distinguished from each other. For example, the inspection unit 6B may identify the time lengths TCc[j], TC1[j], and TC2[j] based on Equations (18), (19), and (20) described with reference to FIG. 18 without calculating the reset timings tec[j], te1[j], and te2[j]. In this aspect, for example, the timing specifying circuit 66 may output, to the identifying section 67B, the information indicating the reference period length RTCc, the information indicating the coefficient α, and the information indicating the coefficient β in step S172. Then, in step S174, the timing specifying circuit 66 may output, to the identifying section 67B, the information indicating the reference set timings rtsc[j], rts1[j], and rts2[j] of the ejection section D[j] to be determined.

As described above, in the present embodiment, the ink jet printer 1 includes the ejection section D[j] and the ejection section D[i] that are capable of ejecting ink in accordance with a drive signal COM input to the ejection section D[j] and the ejection section D[i], the signal generator 60A that generates a comparison signal CP1[j] and a comparison signal CPc[j] based on a residual vibration signal VD[j] corresponding to residual vibration generated in the ejection section D[j] in response to the input of the drive signal COM when the residual vibration signal VD[j] is input to the signal generator 60A, and that generates a comparison signal CP1[i] and a comparison signal CPc[i] based on a residual vibration signal VD[i] corresponding to residual vibration generated in the ejection section D[i] in response to the input of the drive signal COM when the residual vibration signal VD[i] is input to the signal generator 60A, the determining section 64B that determines a state of the ejection section D[j] and a state of the ejection section D[i], and the storage unit 5 that stores information indicating a reference set timing rts1[j] and information indicating a reference set timing rts1[i]. The determining section 64B determines the state of the ejection section D[j] using time information NTC1[j] generated based on the reference set timing rts1[j] and the comparison signal CP1[j] without using the reference set timing rts1[i], and time information NTCc[j] generated based on the comparison signal CPc[j] without using the reference set timings rts1[j] and rts1[i], and determines the state of the ejection section D[i] using time information NTC [i] generated based on the reference set timing rts1[i] and the comparison signal CP1[i] without using the reference set timing rts[j], and time information NTCc[i] generated based on the comparison signal Cpc[i] without using the reference set timings rts1[j] and rts1[i].

In the present embodiment, the signal generator 60A and the determining section 64B are included in the head unit control module HCM that controls the head unit 3 including the ejection section D[j] and the ejection section D[i] that are capable of ejecting ink in accordance with the drive signal COM input to the ejection section D[j] and the ejection section D[i]. Also in the present embodiment, the method of determining the state of the ejection section D[j] and the state of the ejection section D[i] corresponds to the liquid ejection inspection method.

As described above, in the present embodiment, the reference set timing rts1[j] used to generate the time information NTC1[j] and the reference set timing rts1[i] used to generate the time information NTC1[i] are prepared. Therefore, in the present embodiment, it is possible to suppress a variation in the time information NTC1, more accurately, for example, the time lengths TC1 indicated by the time information NTC1 for the ejection section D[j] and the ejection section D[i]. As a result, in the present embodiment, it is possible to inspect the ejection section D[j] and the ejection section D[i] with the same reference. In the present embodiment, since the variation in the time lengths NTC1 indicated by the time information TC1 is suppressed, it is not necessary to perform processing for handling the variation for each of the ejection sections D in the determination process or the like using the time information NTC1. Therefore, in the present embodiment, it is possible to efficiently inspect the states of the ejection sections D. As a result, in the present embodiment, it is possible to suppress an increase in the inspection period for determining the states of the ejection sections D. In the present embodiment, the time information NTC1 is generated based on the reference set timing rts1 and the comparison signal CP1. For example, in the present embodiment, in order to shorten the inspection period for determining the states of the ejection sections D, it is possible to generate the time information NTC1 using the comparison signal CP1 reset based on the reference set timing rts1 or the like. That is, in the present embodiment, it is possible to shorten the inspection period for determining the states of the ejection sections D.

In the present embodiment, the time information NTC1[j] is generated based on information obtained by correcting the comparison signal CP1[j] using the reference set timing rts1[j], and the time information NTC1[i] is generated based on information obtained by correcting the comparison signal CP1[i] using the reference set timing rts1[i]. In a case where the amount of ink ejected by the ejection section D[i] is less than the amount of ink ejected by the ejection section D[j], an amount by which the comparison signal CP1[i] is corrected using the reference set timing rts1[i] is greater than an amount by which the comparison signal CP1[j] is corrected using the reference set timing rts1[j]. As described above, in the present embodiment, the amounts of the correction are adjusted according to the amounts of ink ejected from the ejection section D[j] and the ejection section D[i]. Accordingly, in the present embodiment, it is possible to inspect the ejection section D[j] and the ejection section D[i] with the same reference.

In the present embodiment, the comparison signal CPc[j] indicates whether the residual vibration signal VD[j] is at an electrical potential higher than or equal to the threshold electrical potential VthC, the comparison signal CP1[j] indicates whether the residual vibration signal VD[j] is at an electrical potential higher than or equal to the threshold electrical potential Vth1 different from the threshold electrical potential VthC, and the time information NTC1[j] is generated by using the comparison signal CP1[j] as a signal indicating that the residual vibration signal VD[j] is at an electrical potential higher than or equal to the threshold electrical potential Vth1 until the reset timing te1[j] corresponding to the reference set timing rts1[j] regardless of whether the residual vibration signal VD[j] has transitioned to an electrical potential lower than the threshold electrical potential Vth1. In this way, in the present embodiment, by correcting the period of the comparison signal CP1[j] indicating that the residual vibration signal VD[j] is at an electrical potential higher than or equal to the threshold electrical potential Vth1, it is possible to easily correct the adjusted waveform of the sine wave based on the comparison signal CP1[j]. In the present embodiment, for example, even in a case where the period of time from the timing at which the supply of the residual vibration signal VD[j] to the signal generator 60A is started to the reset timing te1[j] is set to be long, it is possible to shorten the inspection period for determining the state of the ejection section D[j].

In the present embodiment, the signal path for the residual vibration signal VD[j] from the ejection section D[j] to the signal generator 60A is blocked at the blocking timing based on the coupling state specifying signal Qs[j]. The determining section 64B generates the time information NTC1[j] by using the comparison signal CP1[j] as a signal reset at the reset timing te1[j] corresponding to the reference set timing rts1[j]. In a case where the blocking timing is earlier than the reset timing te1[j], the time information NTC1[j] is generated by using the comparison signal CP1[j] as a signal whose electrical potential at the blocking timing is held until the reset timing te1[j]. Accordingly, in the present embodiment, for example, it is possible to cause the ejection section D[j] to perform another operation at a timing after the blocking timing regardless of the reset timing te1[j]. Alternatively, in the present embodiment, regardless of the reset timing te1[j], the ejection section D[i] other than the ejection section D[j] can be operated as the ejection section D to be determined at a timing later than the blocking timing. Therefore, in the present embodiment, for example, even in a case where the period of time from the timing at which the supply of the residual vibration signal VD[j] to the signal generator 60A is started to the reset timing te1[j] is set to be long, it is possible to shorten the inspection period for determining the state of the ejection section D[j].

In the present embodiment, the signal generator 60A may generate the comparison signals CP1[j] and CPc[j] based on a signal that is included in the residual vibration signal VD[j] and that is in the first period TPP1 of time shorter than or equal to one fourth of the period of the residual vibration signal VD[j]. In this aspect, since it is possible to shorten the time required to generate the comparison signals CP1[j] and CPc[j], it is possible to shorten the inspection period for determining the state of the ejection section D[j].

In the present embodiment, the signal generator 60A is electrically decoupled from the ejection section D[j] by the coupling state specifying signal Qs[j]. For example, in the present embodiment, the wiring Li[j] is electrically decoupled from the wiring Ls in accordance with the coupling state specifying signal Qs[j]. As described above, in the present embodiment, since the signal generator 60A is electrically decoupled from the ejection section D[j] by the coupling state specifying signal Qs[j], it is possible to cause the ejection section D[j] to perform another operation before the end of the determination of the state of the ejection section D[j]. Alternatively, in the present embodiment, before the end of the determination of the state of the ejection section D[j], the ejection section D[i] other than the ejection section D[j] can be operated as the ejection section D to be determined.

In the present embodiment, the comparison signals CP1[j] and CPc[j] may be generated based on a signal that is in the residual vibration signal VD[j] and that is in the first period TPP1 of time shorter than or equal to one fourth of the period of the residual vibration signal VD[j]. The first period TPP1 of time is started before the first time elapses after the residual vibration signal VD[j] is input to the signal generator 60A, and the first time is shorter than the period of time corresponding to one fourth of the period of the residual vibration signal VD[j]. In this aspect, it is possible to suppress an increase in a period of time from when the residual vibration signal VD[j] is input to the signal generator 60A to when the comparison signals CP1[j] and CPc[j] are generated. As a result, in this aspect, it is possible to shorten the inspection period for determining the state of the ejection section D[j].

### 2. MODIFICATIONS

The embodiments described above can be modified in various manners. Specific modifications are illustrated below. Two or more aspects selected in any manner from the following examples can be appropriately combined with one another within a range in which the aspects are not inconsistent with one another. In the modifications described below, elements having the same effects and functions as those described in the embodiments will be given the reference signs used in the above description, and each detailed description thereof will be appropriately omitted.

### First Modification

In the above-described embodiments, the inspection units 6, 6A, and 6B may include a switching section that switches whether to supply the residual vibration signal VD to the comparing section 62. In the present modification, a control signal for switching whether to supply the residual vibration signal VD to the comparing section 62, that is, the control signal of the switching section may be treated as a “blocking signal”.

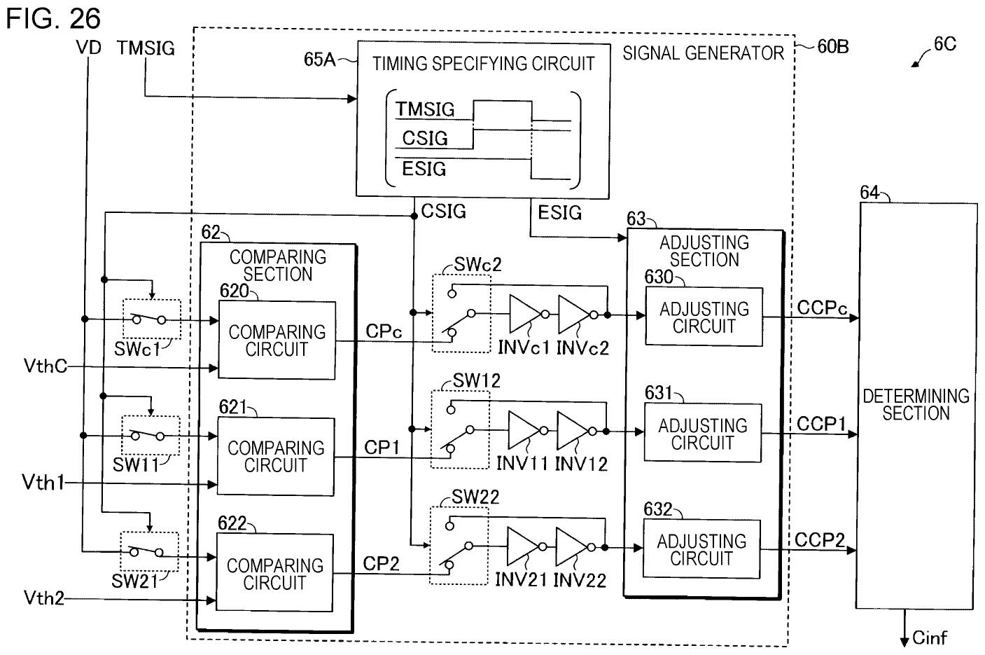

FIG. 26 is a block diagram illustrating an example of a configuration of an inspection unit 6C according to the first modification. The same elements as those described with reference to FIGS. 1 to 25 are denoted by the same reference signs, and detailed descriptions thereof will be omitted.

An ink jet printer 1 according to the present modification is the same as the ink jet printer 1 illustrated in FIG. 1 except that the ink jet printer 1 according to the present modification includes the inspection unit 6C instead of the inspection unit 6 illustrated in FIG. 1. The control unit 2 supplies a timing signal TMSIG to the inspection unit 6C instead of the pulse detection period signal Pcut illustrated in FIG. 8 and the like. In the present modification, it is assumed that the determination of the states of the ejection sections D in the second inspection mode described in the above-described first embodiment is not executed. Therefore, in the present modification, the mask signal MSK illustrated in FIG. 8 and the like is not used. However, also in the present modification, the states of the ejection sections D may be determined in the second inspection mode. The inspection unit 6C will be mainly described below.

The inspection unit 6C includes a signal generator 60B, a determining section 64, and switches SWc1, SW11, SW21, SWc2, SW12, and SW22. The signal generator 60B is the same as the signal generator 60 illustrated in FIG. 7, except that the signal generator 60B includes the switches SWc2, SW12, and SW22, inverters INVc1, INVc2, INV11, INV12, INV21, and INV22, and a timing specifying circuit 65A. Each of the inverters INVc1, INVc2, INV11, INV12, INV21, and INV22 outputs a signal obtained by inverting an input signal. The determining section 64 is the same as the determining section 64 illustrated in FIG. 7.

The timing specifying circuit 65A generates a blocking signal CSIG and an end point specifying signal ESIG based on, for example, the timing signal TMSIG supplied from the control unit 2. Then, the timing specifying circuit 65A outputs the blocking signal CSIG to the switches SWc1, SW11, and SW21 and the switches SWc2, SW12, and SW22. The timing specifying circuit 65A outputs the end point specifying signal ESIG to the adjusting section 63.

The timing signal TMSIG is, for example, a signal that is initially at a low level, transitions from a low level to a high level at the blocking timing, and transitions from a high level to a low level at the reset timing te after the blocking timing. That is, a timing based on a rising edge of the timing signal TMSIG is the blocking timing, and a timing based on a falling edge of the timing signal TMSIG is the reset timing tep. The blocking timing may be, for example, a timing based on the timing at which the coupling state specifying signal Qs[j] transitions from a high level to a low level.

The blocking signal CSIG is, for example, a signal that is initially at a low level and transitions from a low level to a high level when the timing signal TMSIG transitions from a low level to a high level. For example, the blocking signal CSIG may transition from a high level to a low level before the start of a unit period TU following a unit period TU including the timing at which the timing signal TMSIG transitions from a low level to a high level.

The end point specifying signal ESIG is, for example, a signal that is initially at a low level and transitions from a low level to a high level when the timing signal TMSIG transitions from a low level to a high level. For example, the end point specifying signal ESIG may transition from a low level to a high level before the start of the control period TSS2 included in the unit period TU following the unit period TU including the timing at which the timing signal TMSIG transitions from a low level to a high level.

As described above, in the present modification, the blocking signal CSIG and the end point specifying signal ESIG are based on the timing signal TMSIG input to the signal generator 60B through a single signal line. The end point specifying signal ESIG is an example of the “reset signal”.

The switches SWc1, SW11, and SW21 switch between conduction and non-conduction between the detecting circuit 33 included in the head unit 3 and the comparing section 62 included in the signal generator 60B based on the blocking signal CSIG. For example, when the switch SWc1 is turned off, a signal path for a residual vibration signal VD from the detecting circuit 33 to the comparing circuit 620 included in the comparing section 62 is blocked. When the switch SW11 is turned off, a signal path for a residual vibration signal VD from the detecting circuit 33 to the comparing circuit 621 included in the comparing section 62 is blocked. When the switch SW21 is turned off, a signal path for a residual vibration signal VD from the detecting circuit 33 to the comparing circuit 622 included in the comparing section 62 is blocked.

In the example illustrated in FIG. 26, the switches SWc1, SW11, and SW21 are on when the blocking signal CSIG is at a low level, and are off when the blocking signal CSIG is at a high level. For example, when the switch SWc1 is turned on, the residual vibration signal VD from the detecting circuit 33 is supplied to the comparing circuit 620. Similarly, when the switch SW11 is turned on, the residual vibration signal VD from the detecting circuit 33 is supplied to the comparing circuit 621. When the switch SW21 is turned on, the residual vibration signal VD from the detecting circuit 33 is supplied to the comparing circuit 622.

The switch SWc2 switches whether to couple an input of the inverter INVc1 to an output of the comparing circuit 620 or to an output of the inverter INVc2 based on the blocking signal CSIG. In the example illustrated in FIG. 26, the switch SWc2 couples the input of the inverter INVc1 to the output of the comparing circuit 620 when the blocking signal CSIG is at a low level, and couples the input of the inverter INVc1 to the output of the inverter INVc2 when the blocking signal CSIG is at a high level. An output of the inverter INVc1 is coupled to an input of the inverter INVc2. Therefore, when the blocking signal CSIG transitions from a low level to a high level, the output of the inverter INVc2 is held at an electrical potential at the timing when the blocking signal CSIG transitions from a low level to a high level. The output of the inverter INVc2 is coupled to an input of the adjusting circuit 630 included in the adjusting section 63. Therefore, when the blocking signal CSIG transitions from a low level to a high level, the input of the adjusting circuit 630 is held at an electrical potential at the timing when the blocking signal CSIG transitions from a low level to a high level.

The switch SW12 switches whether to couple an input of the inverter INV11 to an output of the comparing circuit 621 or to an output of the inverter INV12 based on the blocking signal CSIG. In the example illustrated in FIG. 26, the switch SW12 couples the input of the inverter INV11 to the output of the comparing circuit 621 when the blocking signal CSIG is at a low level, and couples the input of the inverter INV11 to the output of the inverter INV12 when the blocking signal CSIG is at a high level. An output of the inverter INV11 is coupled to an input of the inverter INV12. Therefore, when the blocking signal CSIG transitions from a low level to a high level, the output of the inverter INV12 is held at an electrical potential at the timing when the blocking signal CSIG transitions from a low level to a high level. The output of the inverter INV12 is coupled to an input of the adjusting circuit 631 included in the adjusting section 63. Therefore, when the blocking signal CSIG transitions from a low level to a high level, the input of the adjusting circuit 631 is held at an electrical potential at the timing when the blocking signal CSIG transitions from a low level to a high level.

The switch SW22 switches whether to couple an input of the inverter INV21 to an output of the comparing circuit 622 or to an output of the inverter INV22 based on the blocking signal CSIG. In the example illustrated in FIG. 26, the switch SW22 couples the input of the inverter INV21 to the output of the comparing circuit 622 when the blocking signal CSIG is at a low level, and couples the input of the inverter INV21 to the output of the inverter INV22 when the blocking signal CSIG is at a high level. An output of the inverter INV21 is coupled to an input of the inverter INV22. Therefore, when the blocking signal CSIG transitions from a low level to a high level, the output of the inverter INV22 is held at an electrical potential at the timing when the blocking signal CSIG transitions from a low level to a high level. The output of the inverter INV22 is coupled to an input of the adjusting circuit 632 included in the adjusting section 63. Therefore, when the blocking signal CSIG transitions from a low level to a high level, the input of the adjusting circuit 632 is held at an electrical potential at the timing when the blocking signal CSIG transitions from a low level to a high level.

As described above, in the present modification, the signal generator 60B, more specifically, the inverters INVc1 and INVc2 hold an electrical potential of a comparison signal CPc at the blocking timing. Similarly, the signal generator 60B, more specifically, the inverters INV11 and INV12 hold an electrical potential of a comparison signal CP1 at the blocking timing. The signal generator 60B, more specifically, the inverters INV21 and INV22 hold an electrical potential of a comparison signal CP2 at the blocking timing.

The adjusting section 63 operates in a similar manner to the adjusting section 63 illustrated in FIG. 7. However, signals output from the inverters INVc2, INV12, and INV22 are input to the adjusting section 63 illustrated in FIG. 26, instead of the comparison signals CPc, CP1, and CP2, and the end point specifying signal ESIG is input to the adjusting section 63 illustrated in FIG. 26, instead of the pulse detection period signal Pcut. As described above, the mask signal MSK is not used in the present modification.

The adjusting circuit 630 included in the adjusting section 63 generates a comparison signal CCPC indicating a logical product of the signal output from the inverter INVc2 and the end point specifying signal ESIG. As a result, the comparison signal CCPc is at a level equal to the level of the comparison signal CPc in a period of time before the blocking timing, and is maintained at a level equal to the level of the comparison signal CPc at the blocking timing in a period of time from the blocking timing to the reset timing tep. After the reset timing tep, the comparison signal CCPc is maintained at a low level. The adjusting circuits 631 and 632 included in the adjusting section 63 also operate in a similar manner to the adjusting circuit 630. In this way, the signal generator 60B treats the electrical potential of the residual vibration signal VD at the blocking timing as being maintained, and generates the comparison signal CCPc and comparison signals CCP1 and CCP2.

The configuration of the inspection unit 6C is not limited to the example illustrated in FIG. 26. For example, the timing specifying circuit 65A may be disposed outside the signal generator 60B. That is, the signal generator 60B may be defined without including the timing specifying circuit 65A.

For example, the adjusting circuit 630 may include a latch circuit or the like that causes the comparison signal CCPc to transition from a low level to a high level when the signal output from the inverter INVc2 transitions from a low level to a high level, and resets the comparison signal CCPc to a low level when the end point specifying signal ESIG transitions from a high level to a low level. Each of the adjusting circuits 631 and 632 may also include a latch circuit or the like. In this aspect, since the levels of the comparison signals CP at the blocking timing are held by the latch circuits, the switches SWc2, SW12, and SW22 and the inverters INVc1, INVc2, INV11, INV12, INV21 and INV22 may be omitted.

For example, instead of the switches SWc2, SW12, and SW22 and the inverters INVc1, INVc2, INV11, INV12, INV21, and INV22, a latch circuit that holds the levels of the comparison signals CP at the blocking timing may be disposed.

The end point specifying signal ESIG may be supplied to the identifying section 67 included in the determining section 64. In this aspect, the switches SWc2, SW12, and SW22, the inverters INVc1, INVc2, INV11, INV12, INV21, and INV22, and the adjusting circuit 630 may be omitted. For example, in this aspect, the identifying circuit 670 included in the identifying section 67 measures a period of time from the timing tsc at which the comparison signal CPc transitions from a low level to a high level to the reset timing tep at which the end point specifying signal ESIG transitions from a high level to a low level, and identifies the result of the measurement as the time length TCc. The identifying circuits 671 and 672 included in the identifying section 67 operate in a similar manner to the identifying circuit 670.

For example, the reset timing tep, that is, the timing at which the timing signal TMSIG transitions from a high level to a low level may be adjusted for each nozzle N.

For example, the polarity of each of the timing signal TMSIG, the blocking signal CSIG, and the end point specifying signal ESIG may be appropriately determined according to the characteristics of each component such as the switch SWc1. For example, the timing signal TMSIG may be a signal that is initially at a high level, transitions from a high level to a low level at the blocking timing, and transitions from a low level to a high level at the reset timing te.

As described above, also in the present modification, it is possible to obtain similar effects to those obtained in the embodiments described above.

In the present modification, the signal generator 60B holds the levels of the comparison signals CPC, CP1, and CP2 at the blocking timing. Therefore, in the present modification, it is possible to shorten a period of time from the input of the residual vibration signal VD to the signal generator 60B to the blocking timing. As a result, in the present modification, it is possible to easily shorten an inspection period for determining the states of the ejection sections D.

In the present modification, the adjusting section 63 of the signal generator 60B resets the levels of the comparison signals CCPc, CCP1, and CCP2 in response to the input of the end point specifying signal ESIG. The input of the end point specifying signal ESIG indicates, for example, the transition of the level of the end point specifying signal ESIG from a high level to a low level. As described above, in the present modification, the reset of the comparison signals CCPc, CCP1, and CCP2 is controlled by the end point specifying signal ESIG. Accordingly, in the present modification, for example, it is possible to easily adjust the comparison signals CCPC, CCP1, and CCP2 compared to an aspect in which the comparison signals CCPC, CCP1, and CCP2 are reset after a predetermined time elapses from the input of the blocking signal CSIG. As a result, in the present modification, for example, it is possible to easily adjust sensitivity for the determination of the states of the ejection sections D compared to an aspect in which the comparison signals CCPc, CCP1, and CCP2 are reset after a predetermined time elapses from the input of the blocking signal CSIG.

In the present modification, the blocking signal CSIG and the end point specifying signal ESIG are based on the timing signal TMSIG input to the signal generator 60B, more specifically, the timing specifying circuit 65A, through the single signal line. One of the blocking timing and the reset timing tep is based on a rising edge of the timing signal TMSIG, and the other of the blocking timing and the reset timing tep is based on a falling edge of the timing signal TMSIG. In this way, in the present modification, by defining the blocking timing and the reset timing tep in an exclusive relationship based on the rising edge and the falling edge of one timing signal TMSIG, it is possible to suppress an increase in the number of signal lines and interfaces for the signal generator 60B.

In the present modification, the reset timing tep may be adjusted such that the period of time from the blocking timing to the reset timing tep is shorter in a case where the inspection period for inspection of the states of the ejection sections D is set to be short than in a case where the inspection period is long. As described above, in this aspect, by adjusting the reset timing tep, it is possible to easily shorten the inspection period for inspection of the states of the ejection sections D. For example, in this aspect, by shortening the period of time from the blocking timing to the reset timing tep, it is possible to shorten a period of time when the comparison signals CP are output.

### Second Modification

The case where the amplitude Vamp is adjusted by adjusting the time ratio of the time lengths TCc and TC1 has been described in the embodiments and the modification, but the present disclosure is not limited to such an aspect. For example, the amplitude calculating circuit 68 may calculate the amplitude Vamp by treating the threshold electrical potential Vth1 as a correction electrical potential different from the actual electrical potential.

Specifically, in the above-described embodiments, for example, to calculate the amplitude Vamp of the residual vibration signal VD illustrated in FIG. 10 based on the time lengths TCc and TC1, “0.5” and “0” are substituted into the threshold electrical potentials Vth1 and VthC in Equation (1) described with reference to FIG. 7, respectively. On the other hand, in the present modification, for example, “0” is substituted into the threshold electrical potential VthC in Equation (1), and a value greater than the actual electrical potential difference of “0.5 V” from the threshold electrical potential VthC or a value less than the actual electrical potential difference of “0.5 V” is substituted into the threshold electrical potential Vth1 in Equation (1). The value substituted into the threshold electrical potential Vth1 in Equation (1) is, for example, a value based on the correction electrical potential. Correction information indicating the correction electrical potential is, for example, stored in the storage unit 5. Correction information indicating a correction electrical potential to be used for determination of the state of the ejection section D[j] is an example of the “first correction information”, and correction information indicating a correction electrical potential to be used for determination of the state of the ejection section D[i] is an example of the “second correction information”.

The calculated amplitude Vamp in a case where a value greater than the actual electrical potential difference of “0.5 V” from the threshold electrical potential VthC is substituted into the threshold electrical potential Vth1 in Equation (1) is greater than that in a case where the actual electrical potential difference of “0.5 V” from the threshold electrical potential VthC is substituted into the threshold electrical potential Vth1 in Equation (1). That is, the amplitude Vamp calculated based on the time lengths TCc and TC1 is adjusted to be increased.

The calculated amplitude Vamp in a case where a value less than the actual electrical potential difference of “0.5 V” from the threshold electrical potential VthC is substituted into the threshold electrical potential Vth1 in Equation (1) is less than that in a case where the actual electrical potential difference of “0.5 V” from the threshold electrical potential VthC is substituted into the threshold electrical potential Vth1 in Equation (1). That is, the amplitude Vamp calculated based on the time lengths TCc and TC1 is adjusted to be decreased.

As described above, in the present modification, the threshold electrical potential Vth1 compared with the electrical potential of the residual vibration signal VD in order to generate the comparison signal CP1 is treated as a correction electrical potential different from the actual electrical potential, and the amplitude Vamp calculated based on the time lengths TCc and TC1 is adjusted. For example, the determining section 64B uses the comparison signal CP1[j] as a signal indicating whether the residual vibration signal VD[j] is at an electrical potential higher than or equal to the correction electrical potential based on the correction information. The correction electrical potential may be appropriately determined in accordance with an amount by which the amplitude Vamp is adjusted. In the present modification, both the adjustment of the amplitude Vamp by treating the threshold electrical potential Vth1 as the correction electrical potential and the adjustment of the time ratio of the time lengths TCc and TC1 may be executed.

As described above, in the present modification, the ink jet printer 1 includes the ejection section D[j] and the ejection section D[i] that are capable of ejecting ink in accordance with a drive signal COM input to the ejection section D[j] and the ejection section D[i], the signal generator 60A that generates a comparison signal CP1[j] and a comparison signal CPc[j] based on a residual vibration signal VD[j] corresponding to residual vibration generated in the ejection section D[j] in response to the input of the drive signal COM when the residual vibration signal VD[j] is input to the signal generator 60A, and that generates a comparison signal CP1[i] and a comparison signal CPc[i] based on a residual vibration signal VD[i] corresponding to residual vibration generated in the ejection section D[i] in response to the input of the drive signal COM when the residual vibration signal VD[i] is input to the signal generator 60A, the storage unit 5 that stores first correction information for the comparison signal CP1[j] and second correction information for the comparison signal CP1[i], and the determining section 64B that determines a state of the ejection section D[j] using the first correction information, the comparison signal CP1[j], and the comparison signal CPc[j] without using the second correction information and determines a state of the ejection section D[i] using the second correction information, the comparison signal CP1[i], and the comparison signal CPc[i] without using the first correction information. The comparison signal CPc[j] indicates whether the residual vibration signal VD[j] is at an electrical potential higher than or equal to the threshold electrical potential VthC, and the comparison signal CP1[j] indicates whether the residual vibration signal VD[j] at an electrical potential higher than or equal to the threshold electrical potential Vth1 different from the threshold electrical potential VthC. The determining section 64B determines the state of the ejection section D[j] using the comparison signal CP1[j] as a signal indicating whether the residual vibration signal VD[j] is at an electrical potential higher than or equal to a correction electrical potential based on the first correction information.

Also in the present modification, it is possible to obtain similar effects to those obtained in the embodiments and modification described above. In the present modification, an adjusted waveform of a sine wave based on the comparison signal CP1[j] can be easily corrected by treating the threshold electrical potential Vth1 as the correction electrical potential different from the actual electrical potential.

### Third Modification

The case where each of the reset timings tec, te1, and te2 is adjusted for each of the ejection sections D has been described in the third embodiment, but the present disclosure is not limited to such an aspect. For example, each of the reset timings tec, te1, and te2 may be determined for each of groups each including a plurality of ejection sections D. Each of the groups each including a plurality of ejection sections D may be, for example, a group of a plurality of ejection sections D corresponding to a nozzle row NL. As described above, also in this modification, it is possible to obtain similar effects to those obtained in the above-described third embodiment. Fourth Modification

The case where the piezoelectric element PZ[j] is deformed in the Z1 direction by changing the electrical potential of the individual drive signal Vin[j] from a low electrical potential to a high electrical potential has been described in the embodiments and the modifications, but the present disclosure is not limited to such an aspect. For example, the piezoelectric element PZ[j] that is deformed in the Z1 direction when the electrical potential of the individual drive signal Vin[j] changes from a high electrical potential to a low electrical potential may be used. In this case, for example, the electrical potential of a portion included in the drive signal COM and corresponding to the expansion element changes from a low electrical potential to a high electrical potential, and the electrical potential of a portion included in the drive signal COM and corresponding to the contraction element changes from the high electrical potential to the low electrical potential. Also in the present modification, it is possible to obtain similar effects to those obtained in the embodiments and modifications described above.

### Fifth Modification

The case where each of the head units 3 includes one nozzle row NL has been described in the embodiments and the modifications, but the present disclosure is not limited to such an aspect. For example, each of the head units 3 may include a plurality of nozzle rows NL. Also in the present modification, it is possible to obtain similar effects to those obtained in the embodiments and modifications described above.

### Sixth Modification

The case where the ink jet printer 1 includes the four head units 3 has been described in the embodiments and modifications, but the present disclosure is not limited to such an aspect. For example, the ink jet printer 1 may have one or more and three or less head units 3, or may have five or more head units 3. Alternatively, the ink jet printer 1 may include one or more and three or less head units 3A, or may include five or more head units 3A.

### Seventh Modification

The case where the amplitude Vamp is calculated based on the time lengths of the periods of time when the electrical potential of the residual vibration signal VD is higher than or equal to the threshold electrical potentials has been described in the embodiments and the modifications, but the present disclosure is not limited to such an aspect. For example, the inspection unit 6 may calculate the amplitude Vamp based on the time lengths of periods of time when the electrical potential of the residual vibration signal VD is lower than or equal to the threshold electrical potentials. Also in the present modification, it is possible to obtain similar effects to those obtained in the embodiments and modifications described above.

### Eighth Modification

The case where the plurality of inspection units 6 corresponding to the plurality of head units 3 on a one to-one basis are provided has been described in the embodiments and the modifications, but the present disclosure is not limited to such an aspect. For example, one inspection unit 6 may be provided for a plurality of head units 3, or a plurality of inspection units 6 may be provided for one head unit 3. Also in the present modification, it is possible to obtain similar effects to those obtained in the embodiments and modifications described above.

### Ninth Modification

The case where the ink jet printer 1 is a serial printer is assumed in each of the embodiments and the modifications, but the present disclosure is not limited to such an aspect. The ink jet printer 1 may be a so-called line printer in which a head module HM has a plurality of nozzles N extending wider than the width of the recording sheet P. Also in the present modification, it is possible to obtain similar effects to those obtained in the embodiments and modifications described above.

### 3. SUPPLEMENTARY NOTES

From the embodiments described above, for example, the following configurations can be ascertained.

### Supplementary Note A1

A liquid ejecting apparatus according to Supplementary Note A1 includes: an ejection section capable of ejecting liquid in accordance with an input drive signal; a signal generator to which a residual vibration signal corresponding to residual vibration generated in the ejection section in response to input of the drive signal is input, and that generates a state inspection signal based on the residual vibration signal; and a determining section that determines a state of the ejection section based on the state inspection signal, wherein the signal generator has a first inspection mode in which the signal generator generates, as the state inspection signal, a first inspection mode signal corresponding to a first portion signal that is included in the residual vibration signal and is in a first period of time, and a second inspection mode in which the signal generator generates, as the state inspection signal, a second inspection mode signal corresponding to a second portion signal that is included in the residual vibration signal and is in a second period of time, and the first period of time is shorter than the second period of time.

According to Supplementary Note A1, it is possible to shorten an inspection period for determining the state of the ejection section by determining the state of the ejection section in the first inspection mode, and it is possible to accurately determine the state of the ejection section by determining the state of the ejection section in the second inspection mode.

### Supplementary Note A2

A liquid ejecting apparatus Supplementary Note A2 is the liquid ejecting apparatus according to Supplementary Note A1, wherein the first period of time is shorter than or equal to one fourth of a period of the residual vibration signal, and the second period of time is longer than or equal to half the period of the residual vibration signal.

According to Supplementary Note A2, by determining the state of the ejection section in the first inspection mode, it is possible to shorten the inspection period by a period that is longer than or equal to one fourth of the period of the residual vibration signal, compared to a case where the state of the ejection section is determined in the second inspection mode.

### Supplementary Note A3

A liquid ejecting apparatus Supplementary Note A3 is the liquid ejecting apparatus according to Supplementary Note A1 or A2, wherein the second period of time is later than the first period of time, and the signal generator generates the second inspection mode signal without using the first portion signal included in the residual vibration signal in the second inspection mode.

According to Supplementary Note A3, even in a case where noise is superimposed on the residual vibration signal immediately after the residual vibration signal is input to the signal generator, it is possible to suppress the effect of the noise on the determination of the state of the ejection section by determining the state of the ejection section in the second inspection mode.

### Supplementary Note A4

A liquid ejecting apparatus according to Supplementary Note A4 is the liquid ejecting apparatus according to any one of Supplementary Notes A1 to A3, wherein the first period of time is started before a first time elapses after the residual vibration signal is input to the signal generator, and the first time is shorter than a period of time corresponding to one fourth of a period of the residual vibration signal.

According to Supplementary Note A4, in the first inspection mode, it is possible to suppress an increase in a period of time from when the residual vibration signal is input to the signal generator to when the state inspection signal is generated.

### Supplementary Note A5

A head unit control circuit according to Supplementary Note A5 that controls a head unit including an ejection section capable of ejecting liquid in accordance with an input drive signal includes: a signal generator to which a residual vibration signal corresponding to residual vibration generated in the ejection section in response to input of the drive signal is input, and that generates a state inspection signal based on the residual vibration signal; and a determining section that determines a state of the ejection section based on the state inspection signal, wherein the signal generator has a first inspection mode in which the signal generator generates, as the state inspection signal, a first inspection mode signal corresponding to a first portion signal that is included in the residual vibration signal and is in a first period of time, and a second inspection mode in which the signal generator generates, as the state inspection signal, a second inspection mode signal corresponding to a second portion signal that is included in the residual vibration signal and is in a second period of time, and the first period of time is shorter than the second period of time.

According to Supplementary Note A5, it is possible to obtain an effect similar to that obtained in Supplementary Note A1 described above.

### Supplementary Note A6

A head unit control circuit according to Supplementary Note A6 is the head unit control circuit according to Supplementary Note A5, wherein the first period of time is shorter than or equal to one fourth of a period of the residual vibration signal, and the second period of time is longer than or equal to half the period of the residual vibration signal.

According to Supplementary Note A6, it is possible to obtain an effect similar to that obtained in Supplementary Note A2 described above.

### Supplementary Note A7

A head unit control circuit according to Supplementary Note A7 is the head unit control circuit according to Supplementary Note A5 or A6, wherein the second period of time is later than the first period of time, and the signal generator generates the second inspection mode signal without using the first portion signal included in the residual vibration signal in the second inspection mode.

According to Supplementary Note A7, it is possible to obtain an effect similar to that obtained in Supplementary Note A3 described above.

### Supplementary Note A8

A liquid ejecting apparatus according to Supplementary Note A8 is the head unit control circuit according to any one of Supplementary Notes A5 to A7, wherein the first period of time is started before a first time elapses after the residual vibration signal is input to the signal generator, and the first time is shorter than a period of time corresponding to one fourth of a period of the residual vibration signal.

According to Supplementary Note A8, it is possible to obtain an effect similar to that obtained in Supplementary Note A4 described above.

### Supplementary Note A9

A liquid ejection inspection method according to Supplementary Note A9 for a liquid ejecting apparatus including an ejection section capable of ejecting liquid in accordance with an input drive signal, the liquid ejection inspection method including: generating a state inspection signal based on a residual vibration signal corresponding to residual vibration generated in the ejection section in response to input of the drive signal; determining a state of the ejection section based on the state inspection signal; when a first inspection mode is selected as an inspection mode for determining the state of the ejection section, generating, as the state inspection signal, a first inspection mode signal corresponding to a first portion signal that is included in the residual vibration signal and is in a first period of time; and when a second inspection mode is selected as the inspection mode, generating, as the state inspection signal, a second inspection mode signal corresponding to a second portion signal that is included in the residual vibration signal and is in a second period of time, wherein the first period of time is shorter than the second period of time.

According to Supplementary Note A9, it is possible to obtain an effect similar to that obtained in Supplementary Note A1 described above.

### Supplementary Note A10

A liquid ejection inspection method according to Supplementary Note A10 is the liquid ejection inspection method according to Supplementary Note A9, wherein the first period of time is shorter than or equal to one fourth of a period of the residual vibration signal, and the second period of time is longer than or equal to half the period of the residual vibration signal.

According to Supplementary Note A10, it is possible to obtain the same effect as Supplementary Note A2 described above.

### Supplementary Note A11

A liquid ejection inspection method according to Supplementary Note A11 is the liquid ejection inspection method according to Supplementary Note A9 or A10, wherein the second period of time is later than the first period of time, and the second inspection mode signal is generated without using the first portion signal included in the residual vibration signal in the second inspection mode.

According to Supplementary Note A11, it is possible to obtain an effect similar to that obtained in Supplementary Note A3 described above.

### Supplementary Note A12

A liquid ejection inspection method according to Supplementary Note A12 is the liquid ejection inspection method according to any one of Supplementary Note A9 to A11, wherein the first period of time is started before a first time elapses after the input of the drive signal to the ejection section is ended, and the first time is shorter than a period of time corresponding to one fourth of a period of the residual vibration signal.

According to Supplementary Note A12, it is possible to obtain an effect similar to that obtained in Supplementary Note A4 described above.

### Supplementary Note B1

A liquid ejecting apparatus according to Supplementary Note B1 includes: an ejection section capable of ejecting liquid in accordance with an input drive signal; a signal generator to which a residual vibration signal corresponding to residual vibration generated in the ejection section in response to input of the drive signal is input, and that generates a plurality of inspection signals based on the residual vibration signal; and a determining section that determines a state of the ejection section, wherein a signal path for the residual vibration signal from the ejection section to the signal generator is blocked at a blocking timing based on a blocking signal, the determining section determines the state of the ejection section based on a plurality of pieces of inspection signal information generated by using the plurality of inspection signals as signals reset at a reset timing based on a reset signal, and in a case where the blocking timing is earlier than the reset timing, each of the plurality of pieces of inspection signal information is generated by using a corresponding one of the plurality of inspection signals as a signal whose electrical potential at the blocking timing is held until the reset timing.

According to Supplementary Note B1, even in a case where a period of time from the timing at which the supply of the residual vibration signal to the signal generator is started to the reset timing is set to be long, it is possible to shorten an inspection period for determining the state of the ejection section.

### Supplementary Note B2

A liquid ejecting apparatus according to Supplementary Note B2 is the liquid ejecting apparatus according to Supplementary Note B1, wherein the signal generator holds an electrical potential of each of the plurality of inspection signals at the blocking timing.

According to Supplementary Note B2, it is possible to shorten a period of time from the input of the residual vibration signal to the signal generator to the blocking timing.

### Supplementary Note B3

A liquid ejecting apparatus according to Supplementary Note B3 is the liquid ejecting apparatus according to Supplementary Note B1 or B2, wherein the signal generator resets an electrical potential of each of the plurality of inspection signals in response to input of the reset signal to the signal generator.

According to Supplementary Note B3, it is possible to easily adjust the plurality of inspection signals. Supplementary Note B4

A liquid ejecting apparatus according to Supplementary Note B4 is the liquid ejecting apparatus according to any one of Supplementary Notes B1 to B3, wherein the blocking signal and the reset signal are based on a timing signal input to the signal generator through a single signal line, one of the blocking timing and the reset timing is based on a rising edge of the timing signal, and the other of the blocking timing and the reset timing is based on a falling edge of the timing signal.

According to Supplementary Note B4, it is possible to suppress an increase in the number of signal lines and interfaces for the signal generator.

### Supplementary Note B5

A liquid ejecting apparatus according to Supplementary Note B5 is the liquid ejecting apparatus according to any one of Supplementary Notes B1 to B4, wherein the reset timing is adjusted such that a period of time from the blocking timing to the reset timing is shorter in a case where an inspection period for inspection of the state of the ejection section is set to be short than in a case where the inspection period is long.

According to Supplementary Note B5, it is possible to shorten a period of time when the plurality of inspection signals are output.

### Supplementary Note B6

A liquid ejecting apparatus according to Supplementary Note B6 is the liquid ejecting apparatus according to any one of Supplementary Notes B1 to B5, wherein the reset timing is adjusted such that a period of time from the blocking timing to the reset timing is longer in a case where accuracy of inspection of the state of the ejection section is set to be high than in a case where the accuracy of the inspection is low.

According to Supplementary Note B6, it is possible to increase the resolution and improve the accuracy of the inspection.

### Supplementary Note B7

A liquid ejecting apparatus according to Supplementary Note B7 is the liquid ejecting apparatus according to any one of Supplementary Notes B1 to B6, wherein the signal generator generates the plurality of inspection signals based on a signal that is included in the residual vibration signal and that is in a first period of time shorter than or equal to one fourth of a period of the residual vibration signal.

According to Supplementary Note B7, since it is possible to shorten the time required to generate the plurality of inspection signals, it is possible to shorten the inspection period for determining the state of the ejection section.

### Supplementary Note B8

A liquid ejecting apparatus according to Supplementary Note B8 is the liquid ejecting apparatus according to any one of Supplementary Notes B1 to B7, wherein the signal generator is electrically decoupled from the ejection section by the blocking signal.

According to Supplementary Note B8, it is possible to cause the ejection section to perform another operation before the end of the determination of the state of the ejection section.

### Supplementary Note B9

A liquid ejecting apparatus according to Supplementary Note B9 is the liquid ejecting apparatus according to any one of Supplementary Notes B1 to B8, wherein the plurality of inspection signals are generated based on a signal that is included in the residual vibration signal and that is in a first period of time shorter than or equal to one fourth of a period of the residual vibration signal, the first period of time is started before a first time elapses after the residual vibration signal is input to the signal generator, and the first time is shorter than a period of time corresponding to one fourth of the period of the residual vibration signal.

According to Supplementary Note B9, it is possible to suppress an increase in a period of time from when the residual vibration signal is input to the signal generator to when the plurality of inspection signals are generated.

### Supplementary Note B10

A head unit control circuit according to Supplementary Note B10 that controls a head unit including an ejection section capable of ejecting liquid in accordance with an input drive signal includes: a signal generator to which a residual vibration signal corresponding to residual vibration generated in the ejection section in response to input of the drive signal is input, and that generates a plurality of inspection signals based on the residual vibration signal; and a determining section that determines a state of the ejection section, wherein a signal path for the residual vibration signal from the ejection section to the signal generator is blocked at a blocking timing based on a blocking signal, the determining section determines the state of the ejection section based on a plurality of pieces of inspection signal information generated by using the plurality of inspection signals as signals reset at a reset timing based on a reset signal, and in a case where the blocking timing is earlier than the reset timing, each of the plurality of pieces of inspection signal information is generated by using a corresponding one of the plurality of inspection signals as a signal whose electrical potential at the blocking timing is held until the reset timing.

According to Supplementary Note B10, it is possible to obtain the same effect as Supplementary Note B1 described above.

### Supplementary Note B11

A head unit control circuit according to Supplementary Note B11 is the head unit control circuit according to Supplementary Note B10, wherein the signal generator holds an electrical potential of each of the plurality of inspection signals at the blocking timing.

According to Supplementary Note B11, it is possible to obtain an effect similar to that obtained in Supplementary Note B2 described above.

### Supplementary Note B12

A head unit control circuit according to Supplementary Note B12 is the head unit control circuit according to Supplementary Note B10 or B11, wherein the signal generator resets an electrical potential of each of the plurality of inspection signals in response to input of the reset signal to the signal generator.

According to Supplementary Note B12, it is possible to obtain an effect similar to that obtained in Supplementary Note B3 described above.

### Supplementary Note B13

A head unit control circuit according to Supplementary Note B13 is the head unit control circuit according to any one of Supplementary Notes B10 to B12, wherein the blocking signal and the reset signal are based on a timing signal input to the signal generator through a single signal line, one of the blocking timing and the reset timing is based on a rising edge of the timing signal, and the other of the blocking timing and the reset timing is based on a falling edge of the timing signal.

According to Supplementary Note B13, it is possible to obtain an effect similar to that obtained in Supplementary Note B4 described above.

### Supplementary Note B14

A head unit control circuit according to Supplementary Note B14 is the head unit control circuit according to any one of Supplementary Notes B10 to B13, wherein the reset timing is adjusted such that a period of time from the blocking timing to the reset timing is shorter in a case where an inspection period for inspection of the state of the ejection section is set to be short in a case where the inspection period is long.

According to Supplementary Note B14, it is possible to obtain an effect similar to that obtained in Supplementary Note B5 described above.

### Supplementary Note B15

A head unit control circuit according to Supplementary Note B15 is the head unit control circuit according to any one of Supplementary Notes B10 to B14, wherein the reset timing is adjusted such that a period of time from the blocking timing to the reset timing is longer in a case where accuracy of inspection of the state of the ejection section is set to be high than in a case where the accuracy of the inspection is low.

According to Supplementary Note B15, it is possible to obtain an effect similar to that obtained in Supplementary Note B6 described above.

### Supplementary Note B16

A head unit control circuit according to Supplementary Note B16 is the head unit control circuit according to any one of Supplementary Notes B10 to B15, wherein the signal generator generates the plurality of inspection signals based on a signal that is included in the residual vibration signal and that is in a first period of time shorter than or equal to one fourth of a period of the residual vibration signal.

According to Supplementary Note B16, it is possible to obtain an effect similar to that obtained in Supplementary Note B7 described above.

### Supplementary Note B17

A head unit control circuit according to Supplementary Note B17 is the head unit control circuit according to any one of Supplementary Notes B10 to B16, wherein the signal generator is electrically decoupled from the ejection section by the blocking signal.

According to Supplementary Note B17, it is possible to obtain an effect similar to that obtained in Supplementary Note B8 described above.

### Supplementary Note B18

A head unit control circuit according to Supplementary Note B18 is the head unit control circuit according to any one of Supplementary Notes B10 to B17, wherein the plurality of inspection signals are generated based on a signal that is included in the residual vibration signal and that is in a first period of time shorter than or equal to one fourth of a period of the residual vibration signal, the first period of time is started before a first time elapses after the residual vibration signal is input to the signal generator, and the first time is shorter than a period of time corresponding to one fourth of the period of the residual vibration signal.

According to Supplementary Note B18, it is possible to obtain an effect similar to that obtained in Supplementary Note B9 described above.

### Supplementary Note B19

A liquid ejection inspection method according to Supplementary Note B19 for a liquid ejecting apparatus including an ejection section capable of ejecting liquid in accordance with an input drive signal, the liquid ejection inspection method including: inputting a residual vibration signal corresponding to residual vibration generated in the ejection section in response to input of the drive signal and generating a plurality of inspection signals based on the residual vibration signal; and determining a state of the ejection section based on a plurality of pieces of inspection signal information generated by using the plurality of inspection signals as signals reset at a reset timing based on a reset signal, wherein a signal path for the residual vibration signal output from the ejection section is blocked at a blocking timing based on a blocking signal, and in a case where the blocking timing is earlier than the reset timing, each of the plurality of pieces of inspection signal information is generated by using a corresponding one of the plurality of inspection signals as a signal whose electrical potential at the blocking timing is held until the reset timing.

According to Supplementary Note B19, it is possible to obtain an effect similar to that obtained in Supplementary Note B1 described above.

### Supplementary Note B20

A liquid ejection inspection method according to Supplementary Note B20 is the liquid ejection inspection method according to Supplementary Note B19, wherein an electrical potential of each of the plurality of inspection signals at the blocking timing is held.

According to Supplementary Note B20, it is possible to obtain an effect similar to that obtained in Supplementary Note B2 described above.

### Supplementary Note B21

A liquid ejection inspection method according to Supplementary Note B21 is the liquid ejection inspection method according to Supplementary Note B19 or B20, wherein an electrical potential of each of the plurality of inspection signals is reset in response to input of the reset signal.

According to Supplementary Note B21, it is possible to obtain an effect similar to that obtained in Supplementary Note B3 described above.

### Supplementary Note B22

A liquid ejection inspection method according to Supplementary Note B22 is the liquid ejection inspection method according to any one of Supplementary Notes B19 to B21, wherein the blocking signal and the reset signal are based on a timing signal supplied through a single signal line, one of the blocking timing and the reset timing is based on a rising edge of the timing signal, the other of the blocking timing and the reset timing is based on a falling edge of the timing signal, and the blocking timing is earlier than the reset timing.

According to Supplementary Note B22, it is possible to obtain an effect similar to that obtained in Supplementary Note B4 described above.

### Supplementary Note B23

A liquid ejection inspection method according to Supplementary Note B23 is the liquid ejection inspection method according to any one of Supplementary Notes B19 to B22, wherein the reset timing is adjusted such that a period of time from the blocking timing to the reset timing is shorter in a case where an inspection period for inspection of the state of the ejection section is set to be short than in a case where the inspection period is long.

According to Supplementary Note B23, it is possible to obtain an effect similar to that obtained in Supplementary Note B5 described above.

### Supplementary Note B24

A liquid ejection inspection method according to Supplementary Note B24 is the liquid ejection inspection method according to any one of Supplementary Notes B19 to B23, wherein the reset timing is adjusted such that a period of time from the blocking timing to the reset timing is longer in a case where accuracy of inspection of the state of the ejection section is set to be high than in a case where the accuracy of the inspection is low.

According to Supplementary Note B24, it is possible to obtain an effect similar to that obtained in Supplementary Note B6 described above.

### Supplementary Note B25

A liquid ejection inspection method according to Supplementary Note B25 is the liquid ejection inspection method according to any one of Supplementary Notes B19 to B24, wherein the plurality of inspection signals are generated based on a signal that is included in the residual vibration signal and that is in a first period of time shorter than or equal to one fourth of a period of the residual vibration signal.

According to Supplementary Note B25, it is possible to obtain an effect similar to that obtained in Supplementary Note B7 described above.

### Supplementary Note B26

A liquid ejection inspection method according to Supplementary Note B26 is the liquid ejection inspection method according to any one of Supplementary Notes B19 to B25, wherein the signal path includes a first signal path and a second signal path, and the first signal path is electrically decoupled from the second signal path in accordance with the blocking signal.

According to Supplementary Note B26, it is possible to obtain an effect similar to that obtained in Supplementary Note B8 described above.

### Supplementary Note B27

A liquid ejection inspection method according to Supplementary Note B27 is the liquid ejection inspection method according to any one of Supplementary Notes B19 to B26, wherein the plurality of inspection signals are generated based on a signal that is included in the residual vibration signal and that is in a first period of time shorter than or equal to one fourth of a period of the residual vibration signal, the first period of time is started before a first time elapses after the input of the drive signal to the ejection section is ended, and the first time is shorter than a period of time corresponding to one fourth of the period of the residual vibration signal.

According to Supplementary Note B27, it is possible to obtain an effect similar to that obtained in Supplementary Note B9 described above.

### Supplementary Note C1

A liquid ejecting apparatus according to Supplementary Note C1 includes: a first ejection section and a second ejection section that are capable of ejecting liquid in accordance with an input drive signal; a signal generator that generates a first inspection signal and a first reference signal based on a first residual vibration signal corresponding to residual vibration generated in the first ejection section in response to input of the drive signal when the first residual vibration signal is input to the signal generator, and that generates a second inspection signal and a second reference signal based on a second residual vibration signal corresponding to residual vibration generated in the second ejection section in response to input of the drive signal when the second residual vibration signal is input to the signal generator; a determining section that determines a state of the first ejection section and a state of the second ejection section; and a storage section that stores first correction information and second correction information, wherein the determining section determines the state of the first ejection section using first inspection signal information generated based on the first correction information and the first inspection signal without using the second correction information, and first reference signal information generated based on the first reference signal without using the first correction information and the second correction information, and determines the state of the second ejection section using second inspection signal information generated based on the second correction information and the second inspection signal without using the first correction information, and second reference signal information generated based on the second reference signal without using the first correction information and the second correction information.

According to Supplementary Note C1, since the state of the ejection section can be efficiently inspected, it is possible to suppress an increase in an inspection period for determining the state of the ejection section.

### Supplementary Note C2

A liquid ejecting apparatus according to Supplementary Note C2 is the liquid ejecting apparatus according to Supplementary Note C1, wherein the first inspection signal information is generated based on information obtained by correcting the first inspection signal using the first correction information, the second inspection signal information is generated based on information obtained by correcting the second inspection signal using the second correction information, and in a case where an amount of liquid ejected by the second ejection section is less than an amount of liquid ejected by the first ejection section, an amount by which the second inspection signal is corrected using the second correction information is greater than an amount by which the first inspection signal is corrected using the first correction information.

According to Supplementary Note C2, the first ejection section and the second ejection section can be inspected by the same reference.

### Supplementary Note C3

A liquid ejecting apparatus according to Supplementary Note C3 includes: a first ejection section and a second ejection section that are capable of ejecting liquid in accordance with an input drive signal; a signal generator that generates a first inspection signal and a first reference signal based on a first residual vibration signal corresponding to residual vibration generated in the first ejection section in response to input of the drive signal when the first residual vibration signal is input to the signal generator, and that generates a second inspection signal and a second reference signal based on a second residual vibration signal corresponding to residual vibration generated in the second ejection section in response to input of the drive signal when the second residual vibration signal is input to the signal generator; a storage section that stores first correction information for the first inspection signal and second correction information for the second inspection signal; and a determining section that determines a state of the first ejection section using the first correction information, the first inspection signal, and the first reference signal without using the second correction information, and determines a state of the second ejection section using the second correction information, the second inspection signal, and the second reference signal without using the first correction information, wherein the first reference signal indicates whether the first residual vibration signal is at an electrical potential higher than or equal to a first electrical potential, the first inspection signal indicates whether the first residual vibration signal is at an electrical potential higher than or equal to a second electrical potential different from the first electrical potential, and the determining section determines the state of the first ejection section using the first inspection signal as a signal indicating whether the first residual vibration signal is at an electrical potential higher than or equal to a third electrical potential based on the first correction information.

According to Supplementary Note C3, it is possible to obtain an effect similar to that obtained in Supplementary Note C1 described above. According to Supplementary Note C3, by treating the second electrical potential as the third electrical potential different from the actual electrical potential, an adjusted waveform of a sine wave based on the first inspection signal can be easily corrected.

### Supplementary Note C4

A liquid ejecting apparatus according to Supplementary Note C4 is the liquid ejecting apparatus according to any one of Supplementary Notes C1 to C3, wherein the first reference signal indicates whether the first residual vibration signal is at an electrical potential higher than or equal to a first electrical potential, the first inspection signal indicates whether the first residual vibration signal is at an electrical potential higher than or equal to a second electrical potential different from the first electrical potential, and the first inspection signal information is generated by using the first inspection signal as a signal indicating that the first residual vibration signal is at an electrical potential higher than or equal to the second electrical potential until a first timing corresponding to the first correction information, regardless of whether the first residual vibration signal has transitioned to an electrical potential lower than the second electrical potential.

According to Supplementary Note C4, even in a case where a period of time from the timing at which the supply of the residual vibration signal to the signal generator is started to the first timing is set to be long, it is possible to shorten the inspection period for determining the state of the first ejection section.

### Supplementary Note C5

A liquid ejecting apparatus according to Supplementary Note C5 is the liquid ejecting apparatus according to any one of Supplementary Notes C1 to C4, wherein a signal path for the first residual vibration signal from the first ejection section to the signal generator is blocked at a blocking timing based on a blocking signal, the determining section generates the first inspection signal information by using the first inspection signal as a signal reset at a first timing corresponding to the first correction information, and in a case where the blocking timing is earlier than the first timing, the first inspection signal information is generated by using the first inspection signal as a signal whose electrical potential at the blocking timing is held until the first timing.

According to Supplementary Note C5, even in a case where the period of time from the timing at which the supply of the residual vibration signal to the signal generator is started to the first timing is set to be long, it is possible to shorten the inspection period for determining the state of the first ejection section.

### Supplementary Note C6

A liquid ejecting apparatus according to Supplementary Note C6 is the liquid ejecting apparatus according to any one of Supplementary Notes C1 to C5, wherein the signal generator generates the first inspection signal and the first reference signal based on a signal that is included in the first residual vibration signal and that is in a first period of time shorter than or equal to one fourth of a period of the first residual vibration signal.

According to Supplementary Note C6, since it is possible to shorten the time required to generate the first inspection signal and the first reference signal, it is possible to shorten the inspection period for determining the state of the first ejection section.

### Supplementary Note C7

A liquid ejecting apparatus according to Supplementary Note C7 is the liquid ejecting apparatus according to Supplementary Note C5, wherein the signal generator is electrically decoupled from the first ejection section by the blocking signal.

According to Supplementary Note C7, it is possible to cause the first ejection section to perform another operation before the end of the determination of the state of the first ejection section. According to Supplementary Note C7, the second ejection section can be operated as an ejection section to be determined before the end of the determination of the state of the first ejection section.

### Supplementary Note C8

A liquid ejecting apparatus according to Supplementary Note C8 is the liquid ejecting apparatus according to any one of Supplementary Notes C1 to C7, wherein the first inspection signal and the first reference signal are generated based on a signal that is included in the first residual vibration signal and that is in a first period of time shorter than or equal to one fourth of a period of the first residual vibration signal, the first period of time is started before a first time elapses after the first residual vibration signal is input to the signal generator, and the first time is shorter than a period of time corresponding to one fourth of the period of the first residual vibration signal.

According to Supplementary Note C8, it is possible to suppress an increase in a period of time from when the residual vibration signal is input to the signal generator to when the first inspection signal and the first reference signal are generated.

### Supplementary Note C9

A head unit control circuit according to Supplementary Note C9 that controls a head unit including a first ejection section and a second ejection section that are capable of ejecting liquid in accordance with an input drive signal includes: a signal generator that generates a first inspection signal and a first reference signal based on a first residual vibration signal corresponding to residual vibration generated in the first ejection section in response to input of the drive signal when the first residual vibration signal is input to the signal generator, and that generates a second inspection signal and a second reference signal based on a second residual vibration signal corresponding to residual vibration generated in the second ejection section in response to input of the drive signal when the second residual vibration signal is input to the signal generator; a determining section that determines a state of the first ejection section and a state of the second ejection section; and a storage section that stores first correction information and second correction information, wherein the determining section determines the state of the first ejection section using first inspection signal information generated based on the first correction information and the first inspection signal without using the second correction information, and first reference signal information generated based on the first reference signal without using the first correction information and the second correction information, and determines the state of the second ejection section using second inspection signal information generated based on the second correction information and the second inspection signal without using the first correction information, and second reference signal information generated based on the second reference signal without using the first correction information and the second correction information.

According to Supplementary Note C9, it is possible to obtain an effect similar to that obtained in Supplementary Note C1 described above.

### Supplementary Note C10

A head unit control circuit according to Supplementary Note C10 is the head unit control circuit according to Supplementary Note C9, wherein the first inspection signal information is generated based on information obtained by correcting the first inspection signal using the first correction information, the second inspection signal information is generated based on information obtained by correcting the second inspection signal using the second correction information, and in a case where an amount of liquid ejected by the second ejection section is less than an amount of liquid ejected by the first ejection section, an amount by which the second inspection signal is corrected using the second correction information is greater than an amount by which the first inspection signal is corrected using the first correction information.

According to Supplementary Note C10, it is possible to obtain an effect similar to that obtained in Supplementary Note C2 described above.

### Supplementary Note C11

A head unit control circuit according to Supplementary Note C11 controls a head unit including a first ejection section and a second ejection section that are capable of ejecting liquid in accordance with an input drive signal includes: a signal generator that generates a first inspection signal and a first reference signal based on a first residual vibration signal corresponding to residual vibration generated in the first ejection section in response to input of the drive signal when the first residual vibration signal is input to the signal generator, and that generates a second inspection signal and a second reference signal based on a second residual vibration signal corresponding to residual vibration generated in the second ejection section in response to input of the drive signal when the second residual vibration signal is input to the signal generator; a storage section that stores first correction information for the first inspection signal and second correction information for the second inspection signal; and a determining section that determines a state of the first ejection section using the first correction information, the first inspection signal, and the first reference signal without using the second correction information, and determines a state of the second ejection section using the second correction information, the second inspection signal, and the second reference signal without using the first correction information, wherein the first reference signal indicates whether the first residual vibration signal is at an electrical potential higher than or equal to a first electrical potential, the first inspection signal indicates whether the first residual vibration signal is at an electrical potential higher than or equal to a second electrical potential different from the first electrical potential, and the determining section determines the state of the first ejection section using the first inspection signal as a signal indicating whether the first residual vibration signal is at an electrical potential higher than or equal to a third electrical potential based on the first correction information.

According to Supplementary Note C11, it is possible to obtain an effect similar to that obtained in Supplementary Note C3 described above.

### Supplementary Note C12

A head unit control circuit according to Supplementary Note C12 is the head unit control circuit according to any one of Supplementary Notes C9 to C11, wherein the first reference signal indicates whether the first residual vibration signal is at an electrical potential higher than or equal to a first electrical potential, the first inspection signal indicates whether the first residual vibration signal at an electrical potential higher than or equal to a second electrical potential different from the first electrical potential, and the first inspection signal information is generated by using the first inspection signal as a signal indicating that the first residual vibration signal is at an electrical potential higher than or equal to the second electrical potential until a first timing corresponding to the first correction information, regardless of whether the first residual vibration signal has transitioned to an electrical potential lower than the second electrical potential.

According to Supplementary Note C12, it is possible to obtain an effect similar to that obtained in Supplementary Note C4 described above.

### Supplementary Note C13

A head unit control circuit according to Supplementary Note C13 is the head unit control circuit according to any one of Supplementary Notes C9 to C12, wherein a signal path for the first residual vibration signal from the first ejection section to the signal generator is blocked at a blocking timing based on a blocking signal, the determining section generates the first inspection signal information by using the first inspection signal as a signal reset at a first timing corresponding to the first correction information, and in a case where the blocking timing is earlier than the first timing, the first inspection signal information is generated by using the first inspection signal as a signal whose electrical potential at the blocking timing is held until the first timing.

According to Supplementary Note C13, it is possible to obtain an effect similar to that obtained in Supplementary Note C5 described above.

### Supplementary Note C14

A head unit control circuit according to Supplementary Note C14 is the head unit control circuit according to any one of Supplementary Notes C9 to C13, wherein the signal generator generates the first inspection signal and the first reference signal based on a signal that is included in the first residual vibration signal and that is in a first period of time shorter than or equal to one fourth of a period of the first residual vibration signal.

According to Supplementary Note C14, it is possible to obtain an effect similar to that obtained in Supplementary Note C6 described above.

### Supplementary Note C15

A head unit control circuit according to Supplementary Note C15 is the head unit control circuit according to Supplementary Note C13, wherein the signal generator is electrically decoupled from the first ejection section by the blocking signal.

According to Supplementary Note C15, it is possible to obtain an effect similar to that obtained in Supplementary Note C7 described above.

### Supplementary Note C16

A head unit control circuit according to Supplementary Note C16 is the head unit control circuit according to any one of Supplementary Notes C9 to C15, wherein the first inspection signal and the first reference signal are generated based on a signal that is included in the first residual vibration signal and that is in a first period of time shorter than or equal to one fourth of a period of the first residual vibration signal, the first period of time is started before a first time elapses after the first residual vibration signal is input to the signal generator, and the first time is shorter than a period of time corresponding to one fourth of the period of the first residual vibration signal.

According to Supplementary Note C16, it is possible to obtain an effect similar to that obtained in Supplementary Note C8 described above.

### Supplementary Note C17

A liquid ejection inspection method according to Supplementary Note C17 for a liquid ejecting apparatus including a first ejection section and a second ejection section that are capable of ejecting liquid in accordance with an input drive signal, the liquid ejection inspection method including: generating a first inspection signal and a first reference signal based on a first residual vibration signal corresponding to residual vibration generated in the first ejection section in response to input of the drive signal; generating a second inspection signal and a second reference signal based on a second residual vibration signal corresponding to residual vibration generated in the second ejection section in response to input of the drive signal; determining a state of the first ejection section using first inspection signal information generated based on first correction information and the first inspection signal without using second correction information out of the first correction information and the second correction information stored in a storage section, and first reference signal information generated based on the first reference signal without using the first correction information and the second correction information; and determining a state of the second ejection section using second inspection signal information generated based on the second correction information and the second inspection signal without using the first correction information, and second reference signal information generated based on the second reference signal without using the first correction information and the second correction information.

According to Supplementary Note C17, it is possible to obtain an effect similar to that obtained in Supplementary Note C1 described above.

### Supplementary Note C18

A liquid ejection inspection method according to Supplementary Note C18 is the liquid ejection inspection method according to Supplementary Note C17, wherein the first inspection signal information is generated based on information obtained by correcting the first inspection signal using the first correction information, the second inspection signal information is generated based on information obtained by correcting the second inspection signal using the second correction information, and in a case where an amount of liquid ejected by the second ejection section is less than an amount of liquid ejected by the first ejection section, an amount by which the second inspection signal is corrected using the second correction information is greater than an amount by which the first inspection signal is corrected using the first correction information.

According to Supplementary Note C18, it is possible to obtain an effect similar to that obtained in Supplementary Note C2 described above.

### Supplementary Note C19

A liquid ejection inspection method according to Supplementary Note C19 for a liquid ejecting apparatus including a first ejection section and a second ejection section that are capable of ejecting liquid in accordance with an input drive signal, the liquid ejection inspection method including: generating a first inspection signal and a first reference signal based on a first residual vibration signal corresponding to residual vibration generated in the first ejection section in response to input of the drive signal; generating a second inspection signal and a second reference signal based on a second residual vibration signal corresponding to residual vibration generated in the second ejection section in response to input of the drive signal; determining a state of the first ejection section using first correction information, the first inspection signal, and the first reference signal without using second correction information out of the first correction information and the second correction information stored in a storage section; and determining a state of the second ejection section using the second correction information, the second inspection signal, and the second reference signal without using the first correction information, wherein the first reference signal indicates whether the first residual vibration signal is at an electrical potential higher than or equal to a first electrical potential, the first inspection signal indicates whether the first residual vibration signal is at an electrical potential higher than or equal to a second electrical potential different from the first electrical potential, and in the determining the state of the first ejection section, the state of the first ejection section is determined using the first inspection signal as a signal indicating whether the first residual vibration signal is at an electrical potential higher than or equal to a third electrical potential based on the first correction information.

According to Supplementary Note C19, it is possible to obtain an effect similar to that obtained in Supplementary Note C3 described above.

### Supplementary Note C20

A liquid ejection inspection method according to Supplementary Note C20 is the liquid ejection inspection method according to any one of Supplementary Notes C17 to C19, wherein the first reference signal indicates whether the first residual vibration signal is at an electrical potential higher than or equal to a first electrical potential, the first inspection signal indicates whether the first residual vibration signal is at an electrical potential higher than or equal to a second electrical potential different from the first electrical potential, and the first inspection signal information is generated by using the first inspection signal as a signal indicating that the first residual vibration signal is at an electrical potential higher than or equal to the second electrical potential until a first timing corresponding to the first correction information, regardless of whether the first residual vibration signal has transitioned to an electrical potential lower than the second electrical potential.

According to Supplementary Note C20, it is possible to obtain an effect similar to that obtained in Supplementary Note C4 described above.

### Supplementary Note C21

A liquid ejection inspection method according to Supplementary Note C21 is the liquid ejection inspection method according to any one of Supplementary Notes C17 to C20, wherein a signal path for the first residual vibration signal output from the first ejection section is blocked at a blocking timing based on a blocking signal, the first inspection signal information is generated by using the first inspection signal as a signal reset at a first timing corresponding to the first correction information, and in a case where the blocking timing is earlier than the first timing, the first inspection signal information is generated by using the first inspection signal as a signal whose electrical potential at the blocking timing is held until the first timing.

According to Supplementary Note C21, it is possible to obtain an effect similar to that obtained in Supplementary Note C5 described above.

### Supplementary Note C22

A liquid ejection inspection method according to Supplementary Note C22 is the liquid ejection inspection method according to any one of Supplementary Notes C17 to C21, wherein the first inspection signal and the first reference signal are generated based on a signal that is included in the first residual vibration signal and that is in a first period of time shorter than or equal to one fourth of a period of the first residual vibration signal.

According to Supplementary Note C22, it is possible to obtain an effect similar to that obtained in Supplementary Note C6 described above.

### Supplementary Note C23

A liquid ejection inspection method according to Supplementary Note C23 is the liquid ejection inspection method according to Supplementary Note C21, wherein a signal path for the first residual vibration signal output from the first ejection section includes a first signal path and a second signal path, and the first signal path is electrically decoupled from the second signal path in accordance with the blocking signal.

According to Supplementary Note C23, it is possible to obtain an effect similar to that obtained in Supplementary Note C7 described above.

### Supplementary Note C24

A liquid ejection inspection method according to Supplementary Note C24 is the liquid ejection inspection method according to any one of Supplementary Notes C17 to C23, wherein the first inspection signal and the first reference signal are generated based on a signal that is included in the first residual vibration signal and that is in a first period of time shorter than or equal to one fourth of a period of the first residual vibration signal, the first period is started before a first time elapses after the input of the drive signal to the first ejection section is ended, and the first time is shorter than a period of time corresponding to one fourth of the period of the first residual vibration signal.

According to Supplementary Note C24, it is possible to obtain an effect similar to that obtained in Supplementary Note C8 described above.

What is claimed is:

1. A liquid ejecting apparatus comprising:
an ejection section capable of ejecting liquid in accordance with an input drive signal;
a signal generator to which a residual vibration signal corresponding to residual vibration generated in the ejection section in response to input of the drive signal is input, and that generates a plurality of inspection signals based on the residual vibration signal;
a determining section that determines a state of the ejection section, wherein
a signal path for the residual vibration signal from the ejection section to the signal generator is blocked at a blocking timing based on a blocking signal,
the determining section determines the state of the ejection unit based on a plurality of pieces of inspection signal information generated by using the plurality of inspection signals as signals reset at a reset timing based on a reset signal, and
in a case where the blocking timing is earlier than the reset timing, each of the plurality of pieces of inspection signal information is generated by using a corresponding one of the plurality of inspection signals as a signal whose electrical potential at the blocking timing is held until the reset timing.

2. The liquid ejecting apparatus according to claim 1, wherein
the signal generator holds an electrical potential of each of the plurality of inspection signals at the blocking timing.

3. The liquid ejecting apparatus according to claim 2, wherein
the signal generator resets an electrical potential of each of the plurality of inspection signals in response to input of the reset signal to the signal generator.

4. The liquid ejecting apparatus according to claim 2, wherein
the blocking signal and the reset signal are based on a timing signal input to the signal generator through a single signal line, and
one of the blocking timing and the reset timing is based on a rising edge of the timing signal, and the other of the blocking timing and the reset timing is based on a falling edge of the timing signal.

5. The liquid ejecting apparatus according to claim 1, wherein
the reset timing is adjusted such that a period of time from the blocking timing to the reset timing is shorter in a case where an inspection period for inspection of the state of the ejection section is set to be short than in a case where the inspection period is long.

6. The liquid ejecting apparatus according to claim 1, wherein
the reset timing is adjusted such that a period of time from the blocking timing to the reset timing is longer in a case where accuracy of inspection of the state of the ejection section is set to be high than in a case where the accuracy of the inspection is low.

7. The liquid ejecting apparatus according to claim 1, wherein
the signal generator generates the plurality of inspection signals based on a signal that is included in the residual vibration signal and that is in a first period of time shorter than or equal to one fourth of a period of the residual vibration signal.

8. The liquid ejecting apparatus according to claim 1, wherein
the signal generator is electrically disconnected from the ejection section by the blocking signal.

9. The liquid ejecting apparatus according to claim 1, wherein
the plurality of inspection signals are generated based on a signal that is included in the residual vibration signal and that is in a first period of time shorter than or equal to one fourth of a period of the residual vibration signal,
the first period is started before a first time elapses after the residual vibration signal is input to the signal generator, and
the first time is shorter than a time corresponding to one fourth of the period of the residual vibration signal.

10. A head unit control circuit that controls a head unit including an election section capable of ejecting liquid in accordance with an input drive signal, the head unit control circuit comprising:
a signal generator to which a residual vibration signal corresponding to residual vibration generated in the ejection section in response to input of the drive signal is input, and that generates a plurality of inspection signals based on the residual vibration signal; and
a determining section that determines a state of the ejection unit, wherein
a signal path for the residual vibration signal from the ejection section to the signal generator is blocked at a blocking timing based on a blocking signal,
the determining section determines the state of the ejection section based on a plurality of pieces of inspection signal information generated by using the plurality of inspection signals as signals reset at a reset timing based on a reset signal, and
in a case where the blocking timing is earlier than the reset timing, each of the plurality of pieces of inspection signal information is generated by using a corresponding one of the plurality of inspection signals as a signal whose electrical potential at the blocking timing is held until the reset timing.

11. The head unit control circuit according to claim 10, wherein
the signal generator holds an electrical potential of each of the plurality of inspection signals at the blocking timing.

12. The head unit control circuit according to claim 11, wherein
the signal generator resets an electrical potential of each of the plurality of inspection signals in response to input of the reset signal to the signal generator.

13. The head unit control circuit according to claim 11, wherein
the blocking signal and the reset signal are based on a timing signal input to the signal generator through a single signal line, and
one of the blocking timing and the reset timing is based on a rising edge of the timing signal, and the other of the blocking timing and the reset timing is based on a falling edge of the timing signal.

14. The head unit control circuit according to claim 10, wherein
the reset timing is adjusted such that a period of time from the blocking timing to the reset timing is shorter in a case where an inspection period for inspection of the state of the ejection section is set to be short than in a case where the inspection period is long.

15. The head unit control circuit according to claim 10, wherein
the reset timing is adjusted such that a period of time from the blocking timing to the reset timing is longer in a case where accuracy of inspection of the state of the ejection section is set to be high than in a case where the accuracy of the inspection is low.

16. The head unit control circuit according to claim 10, wherein
the signal generator generates the plurality of inspection signals based on a signal that is included in the residual vibration signal and that is in a first period of time shorter than or equal to one fourth of a period of the residual vibration signal.

17. The head unit control circuit according to claim 10, wherein
the signal generator is electrically decoupled from the ejection section by the blocking signal.

18. The head unit control circuit according to claim 10, wherein
the plurality of inspection signals are generated based on a signal that is included in the residual vibration signal and that is in a first period of time shorter than or equal to one fourth of a period of the residual vibration signal,
the first period of time is started before a first time elapses after the residual vibration signal is input to the signal generator, and
the first time is shorter than a time corresponding to one fourth of the period of the residual vibration signal.

19. A liquid ejection inspection method for a liquid ejecting apparatus including an ejection section capable of ejecting liquid in accordance with an input drive signal, the liquid ejection inspection method comprising:
inputting a residual vibration signal corresponding to residual vibration generated in the ejection section in response to input of the drive signal and generating a plurality of inspection signals based on the residual vibration signal; and
determining a state of the ejection section based on a plurality of pieces of inspection signal information generated by using the plurality of inspection signals as signals reset at a reset timing based on a reset signal, wherein
a signal path for the residual vibration signal output from the ejection section is blocked at a blocking timing based on a blocking signal, and
in a case where the blocking timing is earlier than the reset timing, each of the plurality of pieces of inspection signal information is generated by using a corresponding one of the plurality of inspection signals as a signal whose electrical potential at the blocking timing is held until the reset timing.

20. The liquid ejection inspection method according to claim 19, wherein
an electrical potential of each of the plurality of inspection signals at the blocking timing is held.

21. The liquid ejection inspection method according to claim 20, wherein
an electrical potential of each of the plurality of inspection signals is reset in response to input of the reset signal.

22. The liquid ejection inspection method according to claim 20, wherein
the blocking signal and the reset signal are based on a timing signal supplied through a single signal line,
one of the blocking timing and the reset timing is based on a rising edge of the timing signal, and the other of the blocking timing and the reset timing is based on a falling edge of the timing signal, and
the blocking timing is earlier than the reset timing.

23. The liquid ejection inspection method according to claim 19, wherein
the reset timing is adjusted such that a period of time from the blocking timing to the reset timing is shorter in a case where an inspection period for inspection of the state of the ejection section is set to be short than in a case where the inspection period is long.

24. The liquid ejection inspection method according to claim 19, wherein
the reset timing is adjusted such that a period of time from the blocking timing to the reset timing is longer in a case where accuracy of inspection of the state of the ejection section is set to be high than in a case where the accuracy of the inspection is low.

25. The liquid ejection inspection method according to claim 19, wherein
the plurality of inspection signals are generated based on a signal that is included in the residual vibration signal and that is in a first period of time shorter than or equal to one fourth of a period of the residual vibration signal.

26. The liquid ejection inspection method according to claim 19, wherein
the signal path includes a first signal path and a second signal path, and
the first signal path is electrically decoupled from the second signal path in accordance with the blocking signal.
